(19) United States
(12) Patent Application Publication
(10) Pub. No.: US 2026/0318491 A1
(43) Pub. Date: Oct. 15, 2026

(54) RECESSED DEVICE MOUNTING SYSTEM

(71) Applicant: SIGNIFY HOLDING B.V., EINDHOVEN (NL)

(72) Inventors: VOYA VIDAKOVIC, Marietta, GA (US); Prerak Parshad Josh, Suwanee, GA (US); Yi Jin Jiang, Dongguan (CN); Nam Chin Cho, Peachtree City, GA (US); John Edward Bowen, Sharpsburg, GA (US)

(21) Appl. No.: 19/363,777

(22) Filed: Oct. 21, 2025

Related U.S. Application Data
(63) Continuation-in-part of application No. PCT/EP2025/051756, filed on Jan. 24, 2025.
(60) Provisional application No. 63/627,162, filed on Jan. 31, 2024.
(60) Provisional application No. 63/635,004, filed on Apr. 17, 2024.

(51) Int. Cl. F21S 8/02; F21V 15/01; F21V 21/04

(52) U.S. Cl. CPC F21S 8/026; F21V 21/046; F21V 15/01

(57) ABSTRACT

A recessed lighting device mounting system includes a frame and a rotating member comprising a retention arm and a trigger arm. The rotating member is rotatably attached to the frame. The retention arm and the trigger arm extend out in different directions with respect to each other. The trigger arm includes a spring attachment tab. The recessed lighting device mounting system further includes an extension spring attached to the spring attachment tab and to a spring attachment structure such that the extension spring biases the rotating member to rotate in an unmounting direction or in a mounting direction depending on a rotational position of the rotating member. The rotating member is rotatable in the mounting direction to a mounting position such that the mounting arm is positioned on a ceiling.

### TECHNICAL FIELD

The present disclosure relates generally to lighting and related solutions, and in particular to mounting devices such as recessed luminaires, speakers, fans, and other devices to a structure such as a ceiling.

### BACKGROUND

Luminaires and other devices are often mounted to a structure such as a ceiling. For example, a recessed luminaire is typically mounted recessed behind a structure, such as a ceiling. Often, accessing the space behind a ceiling to install and uninstall a recessed luminaire can be difficult and/or time consuming. Installing a recessed luminaire in ceiling or other structures from the room side can be challenging and time consuming. Indeed, uninstalling a recessed luminaire from the room side can also be challenging. To illustrate, installing a recessed luminaire in a device opening of a ceiling from the room side can be difficult, for example, because of limited visibility of luminaire mounting components that are in space behind the ceiling. In addition, the limited space available to access luminaire mounting components through the device opening of a ceiling can make installation and uninstallation of a recessed luminaire challenging and time consuming. Thus, a solution that simplifies the installation and uninstallation of a luminaire may be desirable.

### SUMMARY

The present disclosure relates generally to lighting and related solutions, and in particular to mounting devices such as recessed luminaires, speakers, fans, and other devices to a structure such as a ceiling. In an example embodiment, a recessed lighting device mounting system includes a frame and a rotating member comprising a retention arm and a trigger arm. The rotating member is rotatably attached to the frame. The retention arm and the trigger arm extend out in different directions with respect to each other. The trigger arm includes a spring attachment tab. The recessed lighting device mounting system further includes an extension spring attached to the spring attachment tab and to a spring attachment structure such that the extension spring biases the rotating member to rotate in an unmounting direction or in a mounting direction depending on a rotational position of the rotating member. The rotating member is rotatable in the mounting direction to a mounting position such that the mounting arm is positioned on a ceiling.

In another example embodiment, a lighting device includes a housing, a first recessed device mounting system, and a second recessed device mounting system. The first recessed device mounting system and the second recessed device mounting system each include a frame extending from the housing and a rotating member that includes a retention arm and a trigger arm. The rotating member is rotatably attached to the frame. The retention arm and the trigger arm extend out in different directions with respect to each other. The trigger arm includes a spring attachment tab. The first recessed device mounting system and the second recessed device mounting system each include an extension spring attached to the spring attachment tab and to a spring attachment structure such that the extension spring biases the rotating member to rotate in an unmounting direction or in a mounting direction depending on a rotational position of the rotating member. The rotating member is rotatable in the mounting direction to a mounting position such that the mounting arm is positioned on a ceiling.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIGS. 1A-1E illustrate different views of a lighting device that includes luminaire mounting systems according to an example embodiment;

FIGS. 2 and 3 illustrate close-up views of the luminaire mounting systems of the lighting device shown in FIGS. 1A-1E according to an example embodiment;

FIG. 4 illustrates a mounting member of a luminaire mounting system shown in FIG. 2 including a spring attachment structure according to an example embodiment;

FIGS. 5A-5C illustrate different views of the mounting member of a luminaire mounting system shown in FIG. 2 according to an example embodiment;

FIG. 6 illustrates a top perspective view of the lighting device of FIGS. 1A-1E with some components of the luminaire mounting systems omitted according to an example embodiment;

FIGS. 7A-7D illustrate the lighting device of FIGS. 1A-1E with the luminaire mounting systems in different rotational positions according to an example embodiment;

FIGS. 8A-8D illustrate the lighting device of FIGS. 1A-1E at different stages of installation in a ceiling according to an example embodiment;

FIG. 9 illustrates the lighting device of FIGS. 1A-1E mounted to a ceiling according to an example embodiment;

FIGS. 10A and 10B illustrate the lighting device of FIGS. 1A-1E at different stages of uninstallation from a ceiling according to an example embodiment;

FIGS. 11A-11C illustrate different views of a luminaire mounting system for mounting a luminaire recessed in a ceiling according to an example embodiment;

FIG. 12 illustrates a frame of the luminaire mounting system of FIGS. 11A-11C according to an example embodiment;

FIGS. 13A and 13B illustrate different views of the luminaire mounting system of FIGS. 11A-11C in a mounting position according to an example embodiment;

FIGS. 14A and 14B illustrate different views of a lighting device that includes luminaire mounting systems according to another example embodiment;

FIGS. 15A-15C illustrate different views of a lighting device that includes luminaire mounting systems according to another example embodiment;

FIG. 16 illustrates the luminaire mounting systems of FIGS. 15A-15C in a mounting position according to an example embodiment;

FIGS. 17A and 17B illustrate a luminaire mounting system of the lighting device shown in FIGS. 15A-15C according to an example embodiment;

FIG. 18 illustrates a cross-sectional view of a luminaire mounting system of FIGS. 17A and 17B according to an example embodiment;

FIG. 19 illustrates the luminaire mounting system of FIGS. 17A and 17B in a mounting position according to an example embodiment;

FIG. 20 illustrates a cross-sectional view of the luminaire mounting system of FIG. 19 according to an example embodiment;

FIGS. 21A-21C illustrate a frame of the luminaire mounting system of FIGS. 17A and 17B according to an example embodiment;

FIG. 22 shows the housing of the lighting device of FIGS. 15A-15C without the luminaire mounting systems according to another example embodiment;

FIGS. 23A and 23B illustrate different views of a lighting device that includes luminaire mounting systems according to another example embodiment;

FIGS. 24A and 24B illustrate different views of a luminaire mounting system of the lighting device of FIGS. 23A and 23B without the extension spring according to an example embodiment;

FIGS. 25A and 25B illustrate different views of a luminaire mounting system of the lighting device of FIGS. 23A and 23B according to an example embodiment;

FIGS. 26A and 26B illustrate different views of a luminaire mounting system of the lighting device of FIGS. 23A and 23B in a mounting position according to an example embodiment;

FIGS. 27A and 27B illustrate the luminaire mounting system of the lighting device of FIGS. 23A and 23B with and without the extension spring according to an example embodiment;

FIG. 28 illustrates the luminaire mounting systems of FIGS. 23A and 23B in a mounting position according to an example embodiment;

FIGS. 29A and 29B illustrate a lighting device that includes luminaire mounting systems according to another example embodiment;

FIGS. 30A and 30B illustrate the luminaire mounting systems of the lighting device of FIG. 29A with a heat sink omitted according to an example embodiment;

FIGS. 31A and 31B illustrate different views of the luminaire mounting system shown in FIG. 30A according to an example embodiment;

FIGS. 32A and 32B illustrate cross-sectional views of a luminaire mounting system of FIGS. 31A and 31B in different rotational positions according to an example embodiment;

FIG. 33 illustrates a frame of the luminaire mounting system of FIGS. 31A and 31B according to an example embodiment;

FIG. 34 illustrates a cross-sectional view of the frame shown in FIG. 33 according to an example embodiment;

FIG. 35 illustrates the rotating member and the spring of the luminaire mounting system shown in FIGS. 31A and 31B according to an example embodiment;

FIGS. 36A-36C illustrate different views of the rotating member of the luminaire mounting system shown in FIGS. 31A and 31B according to an example embodiment;

FIG. 37 illustrates the luminaire mounting system of FIGS. 31A and 31B in a mounting position according to an example embodiment;

FIG. 38 illustrates the luminaire mounting system of FIGS. 31A and 31B in another mounting position according to an example embodiment;

FIGS. 39A-39D illustrate the lighting device of FIG. 29A at different stages of installation in a ceiling according to an example embodiment;

FIG. 40 illustrates the lighting device of FIG. 29A with the luminaire mounting systems in another mounting position according to an example embodiment;

FIG. 41 illustrates a block diagram of a generic lighting device according to an example embodiment;

FIG. 42 illustrates a lighting device that includes luminaire mounting systems according to an example embodiment;

FIGS. 43A and 43B illustrate the lighting device of FIG. 42 without the spring covers according to an example embodiment;

FIG. 44 illustrates the frames of the luminaire mounting systems and the housing of the lighting device of FIG. 42 according to an example embodiment;

FIGS. 45A and 45B illustrate the mounting member of a luminaire mounting system of FIG. 42 according to an example embodiment;

FIG. 46 illustrates the spring attached to the spring attachment tab of FIGS. 45 and 45B according to an example embodiment;

FIG. 47 illustrates the lighting device of FIG. 42 at an initial stage of installation in a ceiling according to an example embodiment;

FIG. 48 illustrates the lighting device of FIG. 47 partially inserted into a device opening of a ceiling during the installation of the lighting device in the ceiling according to an example embodiment;

FIG. 49 illustrates the lighting device of FIG. 47 further inserted into a device opening of a ceiling during the installation of the lighting device in the ceiling according to an example embodiment;

FIG. 50 illustrates the lighting device of FIG. 47 mounted recessed in a ceiling by luminaire mounting systems according to an example embodiment;

FIG. 51 illustrates a lighting device that includes luminaire mounting systems according to an example embodiment;

FIG. 52 illustrates the lighting device of FIG. 51 with the luminaire mounting systems separated from a housing of the lighting device according to an example embodiment;

FIGS. 53A and 53B illustrate a luminaire mounting system shown in FIG. 51 according to an example embodiment;

FIG. 54 illustrates unassembled components of the luminaire mounting system shown in FIGS. 53A and 53B according to an example embodiment;

FIG. 55 illustrates a luminaire mounting system shown in FIG. 51 according to an example embodiment;

FIG. 56 illustrates the lighting device of FIG. 51 partially inserted into a device opening of a ceiling during the installation of the lighting device in the ceiling according to an example embodiment; and

FIG. 57 illustrates the lighting device of FIG. 51 mounted recessed in a ceiling by the luminaire mounting systems according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the figures, the same reference numerals used in different figures may designate like or corresponding and not necessarily identical elements.

### DETAILED DESCRIPTION OF THE EXAMPLE EMBODIMENTS

In the following paragraphs, particular embodiments will be described in further detail by way of example with reference to the figures. In the description, well known components, methods, and/or processing techniques are omitted or briefly described. Furthermore, reference to various feature(s) of the embodiments is not to suggest that all embodiments must include the referenced feature(s).

Luminaire mounting system(s) described herein may be referred to as a device mounting system(s) or a recessed device mounting system(s). In general, the terms “luminaire mounting system” and “luminaire mounting systems” as used throughout this specification are not necessarily limited to lighting devices and may apply to non-lighting devices.

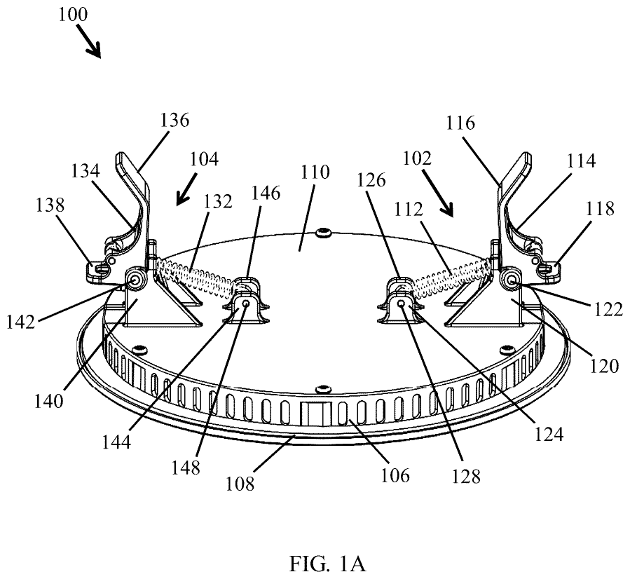

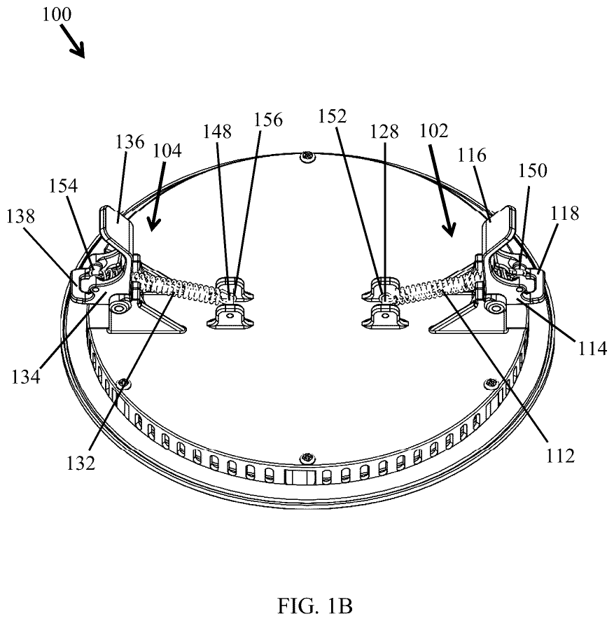

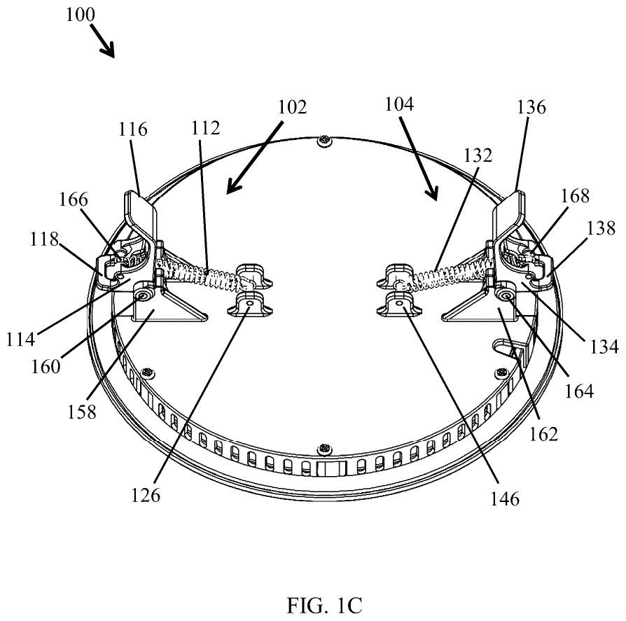

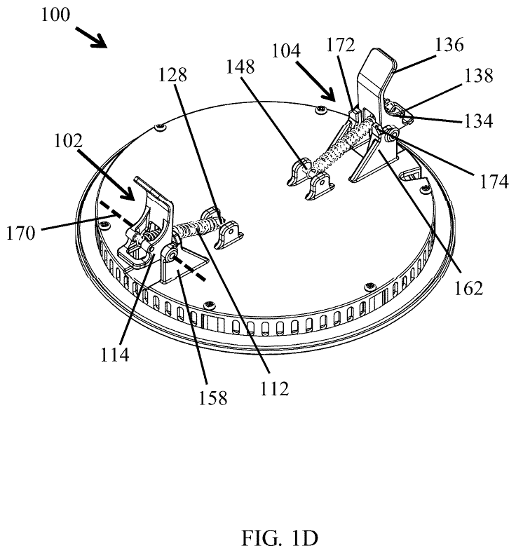

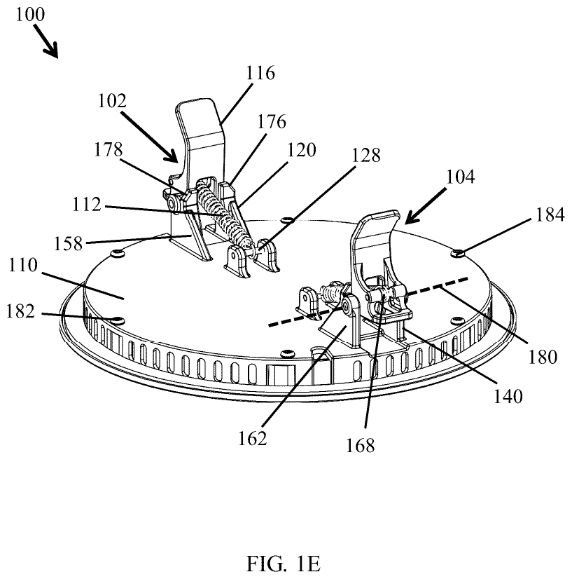

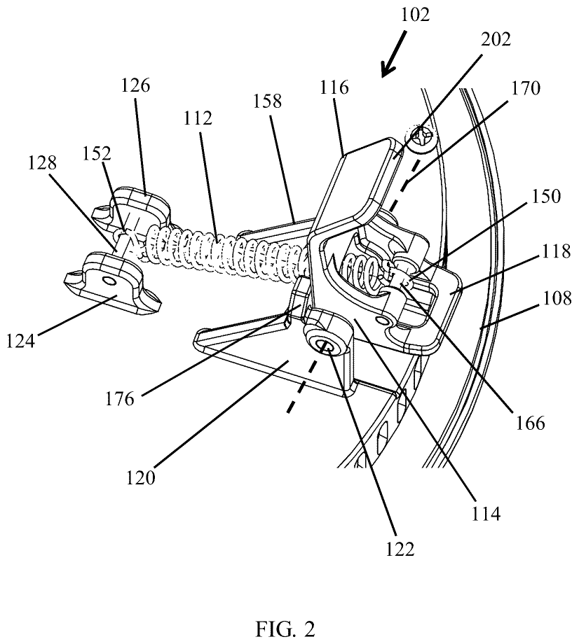

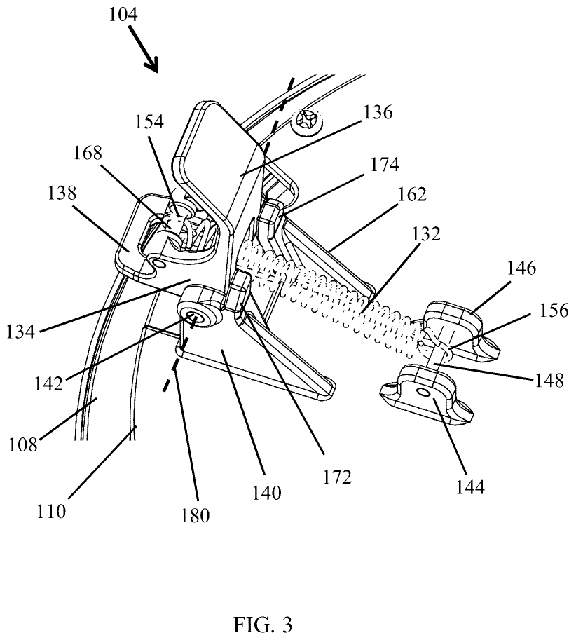

Turning now to the drawings, example embodiments are described. FIGS. 1A-1E illustrate different views of a lighting device 100 that includes luminaire mounting systems 102, 104 according to an example embodiment. FIGS. 2 and 3 illustrate close-up views of the luminaire mounting systems 102, 104 of the lighting device 100 shown in FIGS. 1A-1E according to an example embodiment. For example, the lighting device 100 may be a recessed luminaire, another type of lighting device, or a non-lighting device. Referring to FIGS. 1A-3, in some example embodiments, the lighting device 100 includes the luminaire mounting systems 102, 104 (also referred to as recessed device mounting systems) and a housing 106. The lighting device 100 may include a trim 108 that may be a standalone component attached to the housing 106 (e.g., a luminaire housing or a device housing) or that may be integrally formed with the housing 106. To illustrate, when the lighting device 100 is installed recessed in a ceiling, the trim 108 may abut against the ceiling on the room side. The lighting device 100 may include a housing cover 110 that may be integrally formed with the rest of the housing 106 or that may be attached to the housing 106, for example, using fasteners such as screws 182, 184.

In some example embodiments, the luminaire mounting systems 102, 104 may be used to mount the lighting device 100 recessed in a ceiling. The luminaire mounting systems 102, 104 may be located on the housing cover 110 across from each other to symmetrically mount the lighting device 100 recessed through a device opening of a ceiling.

In some example embodiments, the luminaire mounting system 102 includes a spring 112, a rotating member 114, rotating member attachment structures 120, 158, and a spring attachment structure that may include a rod 128. For example, the spring 112 may be an extension spring. The rotating member attachment structures 120, 158 may be attached to housing cover 110, for example, using one or more fasteners. Alternatively, the rotating member attachment structures 120, 158 may be integrally formed with the housing cover 110. The spring attachment structure that includes the rod 128 may also include posts 124, 126, where the rod 128 may be attached to the posts 124, 126. For example, the rod 128 may extend between the posts 124, 126. The posts 124, 126 may be attached to housing cover 110, for example, using one or more fasteners or may be integrally formed with the housing cover 110. In some alternative embodiments, the rod 128 may be integrally formed with the posts 124, 126 as a single unit, for example, using a method such as injection molding and/or other methods.

In some example embodiments, the rotating member 114 may be pivotably attached to the rotating member attachment structures 120, 158, for example, using pivot fasteners 122, 160. The rotating member 114 may be attached to the rotating member attachment structures 120, 158 such that the rotating member 114 is rotatable relative to the rotating member attachment structures 120, 158. To illustrate, the rotating member 114 may be attached to the rotating member attachment structures 120, 158 by the pivot fasteners 122, 160 to rotate about a pivot axis 170 extending through the pivot fasteners 122, 160. The rotation of the rotating member 114 may be limited in one or more rotational directions, for example, by stoppage structures 176, 178. For example, a portion of each one of the stoppage structures 176, 178 may protrude from the rotating member attachment structures 120, 158, respectively, and prevent further rotation. Another portion of each one of the stoppage structures 176, 178 may be located in the space between the rotating member attachment structures 120, 158, respectively and prevent further rotation. The stoppage structures 176, 178 may be located to come in contact with the rotating member 114 and prevent further rotation of the rotating member 114 in two rotational directions.

In some example embodiments, the rotating member 114 may include a retention arm 116 and a trigger arm 118. The retention arm 116 and the trigger arm 118 may be at fixed locations relative to each other as the rotating member 114 rotates about the pivot axis 170 extending through the pivot fasteners 122, 160. The rotating member 114 may also include a rod 166 that serves as a spring attachment structure of the rotating member 114. For example, the rod 166 may be integrally formed with the rotating member 114 as a single unit or may be a discrete component that is inserted into rod attachment holes of the rotating member 114.

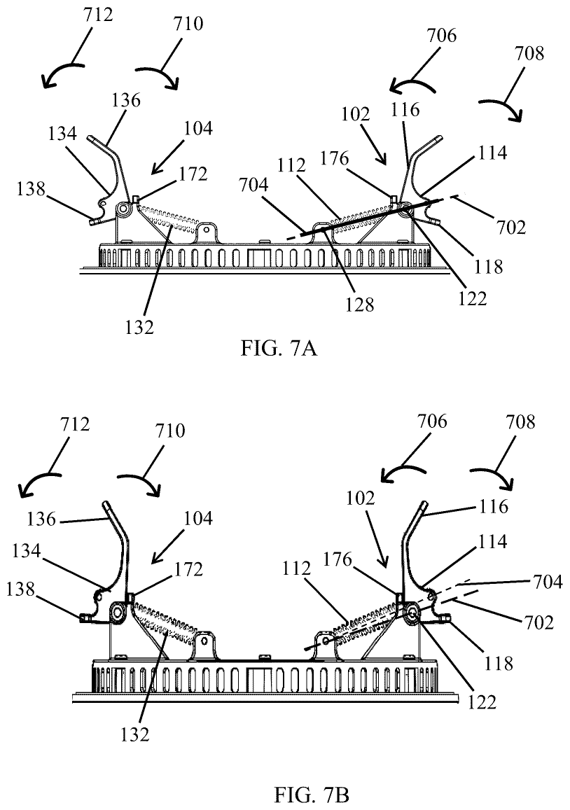

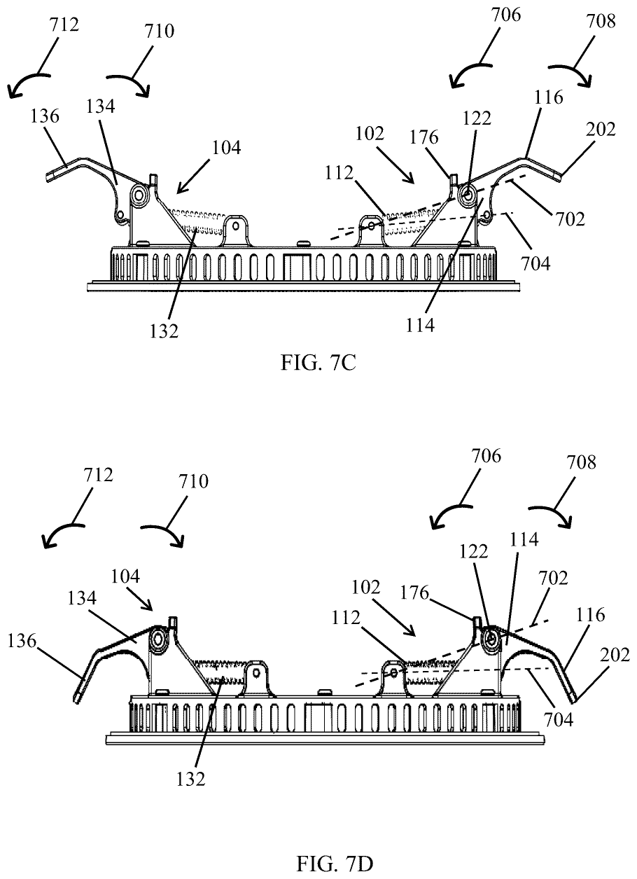

In some example embodiments, the spring 112 may be attached to the rotating member 114 and to a spring attachment structure that includes the rod 128. That is, the spring 112 may be attached to a fixed structure and to a pivoting structure. To illustrate, the spring 112 may be attached to the rod 166 of the rotating member 114 and to the rod 128. For example, the spring 112 may extend between the rod 128 and the rod 166. An end portion 152 of the spring 112 may be attached to the rod 128, and another end portion 150 of the spring 112 may be attached to the rod 166. In some cases, the rod 128 and the rod 166 may be located such that the spring 112 extends longitudinally past the pivot fasteners 122, 160. In general, the luminaire mounting system 102 may implement an over-center spring mechanism as described below in more detail with respect to FIGS. 7A-7D.

In some example embodiments, the luminaire mounting system 104 includes a spring 132, a rotating member 134, rotating member attachment structures 140, 162, and a spring attachment structure that may include a rod 148. For example, the spring 132 may be an extension spring. The rotating member attachment structures 140, 162 may be attached to housing cover 110, for example, using one or more fasteners. Alternatively, the rotating member attachment structures 140, 162 may be integrally formed with the housing cover 110. The spring attachment structure that includes the rod 148 may also include posts 144, 146, where the rod 148 may be attached to the posts 144, 146. For example, the rod 148 may extend between the posts 144, 146. The posts 144, 146 may be attached to housing cover 110, for example, using one or more fasteners or may be integrally formed with the housing cover 110. In some alternative embodiments, the rod 148 may be integrally formed with the posts 144, 146 as a single unit, for example, using a method such as injection molding and/or other methods.

In some example embodiments, the rotating member 134 may be pivotably attached to the rotating member attachment structures 140, 162, for example, using pivot fasteners 142, 164. The rotating member 134 may be attached to the rotating member attachment structures 140, 162 such that the rotating member 134 is rotatable relative to the rotating member attachment structures 140, 162. To illustrate, the rotating member 134 may be attached to the rotating member attachment structures 140, 162 by the pivot fasteners 142, 164 to rotate about a pivot axis 180 extending through the pivot fasteners 142, 164. The rotation of the rotating member 134 may be limited in one rotational direction, for example, by stoppage structures 172, 174. The stoppage structures 172, 174 may protrude from the rotating member attachment structures 140, 162, respectively. To illustrate, the stoppage structures 172, 174 may be located to come in contact with the rotating member 134 and prevent further rotation of the rotating member 134 in one rotational direction.

In some example embodiments, the rotating member 134 may include a retention arm 136 and a trigger arm 138. The retention arm 136 and the trigger arm 138 may be at fixed locations relative to each other as the rotating member 134 rotates about the pivot axis 180 extending through the pivot fasteners 142, 164. The rotating member 134 may also include a rod 168 that serves as a spring attachment structure of the rotating member 134. For example, the rod 168 may be integrally formed with the rotating member 134 as a single unit or may be a discrete component that is subsequently attached to the rest of the rotating member 134.

In some example embodiments, the spring 132 may be attached to a spring attachment structure that includes the rod 148 and to the rotating member 134. That is, the spring 132 may be attached to a fixed structure and to a pivoting structure. To illustrate, the spring 132 may be attached to the rod 168 of the rotating member 134 and to the rod 148. For example, the spring 132 may extend between the rod 148 and the rod 168. An end portion 156 of the spring 132 may be attached to the rod 148, and another end portion 154 of the spring 132 may be attached to the rod 168. In some cases, the rod 148 and the rod 168 may be located such that the spring 132 extends longitudinally past the pivot fasteners 142, 164. In general, the luminaire mounting system 104 may implement an over-center spring mechanism as described below in more detail with respect to FIGS. 7A-7D.

In general, the components of the luminaire mounting systems 102, 104 may be identical or substantially identical to each other. For example, the luminaire mounting system 104 may be another instance of the luminaire mounting system 102. In some alternative embodiments, some of the components of the luminaire mounting system 102 may be different from the corresponding components of the luminaire mounting system 104 without departing from the scope of this disclosure. For example, the springs 112, 132 may have one or more parameters that are different from each other without departing from the scope of this disclosure. In some alternative embodiments, one or more components of the luminaire mounting systems 102, 104 may have a different shape than shown without departing from the scope of this disclosure. For example, one or more of the posts 124, 126, 144, 146 may have a different shape than shown. As another example, the rods 128, 148 may each have a different shape than shown. As yet another example, the rotating members 114, 134 may each have a different shape than shown. To illustrate, the retention arm 116 and the trigger arm 118 may be at different locations than shown without departing from the scope of this disclosure, and the retention arm 136 and the trigger arm 138 may be at different locations than shown without departing from the scope of this disclosure. In some alternative embodiments, one or more components of the luminaire mounting systems 102, 104 may be omitted or replaced without departing from the scope of this disclosure. For example, the posts 124, 126, 144, 146 may be omitted, and the rods 128, 148 may be directly attached to the housing cover 110. To illustrate, the rods 128, 148 may be integrally formed with the housing cover 110 as a single unit, for example, using a method such as injection molding and/or other methods.

In some alternative embodiments, the pivot fasteners 122, 142, 160, 164 may be replaced with one or more other structures without departing from the scope of this disclosure. Although the springs 112, 132 are shown and described as extension springs, in some alternative embodiments, compression springs, leaf springs, or other types of springs may instead be used in luminaire mounting systems 102, 104 without departing from the scope of this disclosure. In some alternative embodiments, the luminaire mounting systems 102, 104 each may include two or more springs that together operate in the manner described with respect to the springs 112, 132 without departing from the scope of this disclosure. In some example embodiments, the lengths of the springs 112, 132 may be varied to accommodate different size (e.g., diameter) luminaires and corresponding sizes of device openings of a ceiling without departing from the scope of this disclosure. In some alternative embodiments, the springs 112, 132 may be attached to the rotating members 114, 134, respectively, at different locations than shown without departing from the scope of this disclosure. In some alternative embodiments, the springs 112, 132 may be attached to the rotating members 114, 134 in a different manner than shown without departing from the scope of this disclosure. In some alternative embodiments, the springs 112, 132 may be attached to other elements of the rotating members 114, 134, respectively, instead or in addition to those shown without departing from the scope of this disclosure.

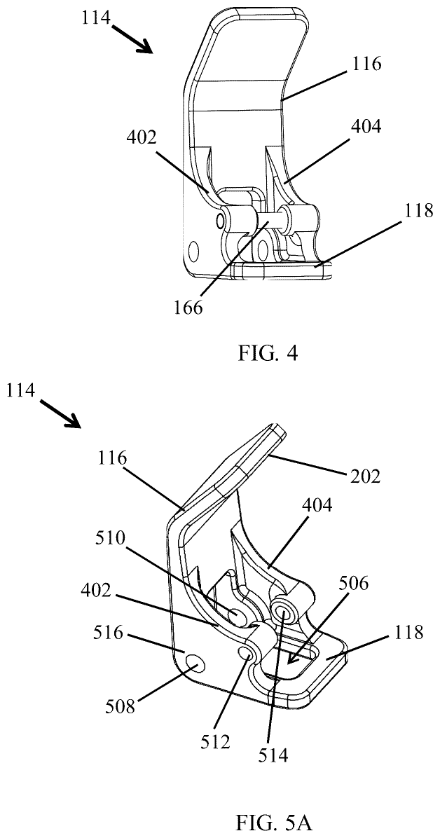

FIG. 4 illustrates the mounting member 114 of the luminaire mounting system 102 shown in FIG. 2 including a spring attachment structure according to an example embodiment. Referring to FIGS. 1A-2 and 4, in some example embodiments, the rotating member 114 includes the retention arm 116 and the trigger arm 118. The rotating member 114 may include branch sections 402, 404 that extend between the retention arm 116 and the trigger arm 118. The spring attachment structure of the rotating member 114 may include the rod 166 that extends between the branch sections 402, 404. The rod 166 may be integrally formed with the rest of the rotating member 114 as a single unit or may be a discrete component that is attached to the branch sections 402, 404. The spring 112 may be attached to the rod 166. For example, the end portion 150 of the spring 112 may be attached to the rod 166, where the spring 112 extends through a gap between the branch sections 402, 404 for attachment to the rod 166.

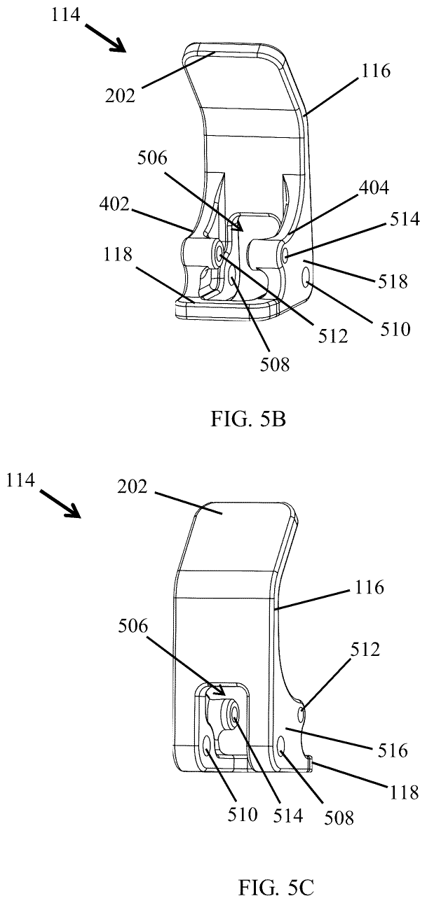

FIGS. 5A-5C illustrate different views of the mounting member 114 of the luminaire mounting system 102 shown in FIG. 2 according to an example embodiment. Referring to FIGS. 1A-2, 4, and 5, in some example embodiments, the rotating member 114 includes pivot holes 508, 510. The pivot hole 508 may be formed through the branch section 402, and the pivot hole 510 may be formed through the branch section 404. For example, the pivot hole 508 may be formed in an attachment area 516 of the branch section 402, and the pivot hole 510 may be formed in an attachment area 518 of the branch section 404. The pivot holes 508, 510 may be used to pivotably attach the rotating member 114 to the rotating member attachment structures 120, 158, respectively. To illustrate, the pivot fastener 122 may be inserted in the pivot hole 508 and a respective hole in the rotating member attachment structure 120, and the pivot fastener 160 may be inserted in the pivot hole 510 and a respective hole in the rotating member attachment structure 158.

In some example embodiments, the rotating member 114 includes rod attachment holes 512, 514. The rod attachment hole 512 may be formed in the branch section 402 of the rotating member 114, and the rod attachment hole 514 may be formed in the branch section 404 of the rotating member 114. The branch section 402 may include a boss that has the rod attachment hole 512, and the branch section 404 may include a boss that has the rod attachment hole 514. The rod 166 may be inserted into the rod attachment holes 512, 514 and may serve as part of the spring attachment structure of the rotating member 114. For example, the rod 166 may be sized to be pushed into the rod attachment holes 512, 514 and remain attached to the rod attachment holes 512, 514. As described above, in some alternative embodiments, the rod 166 may be integrally formed as part of the rotating member 114 instead of being a discrete component that is subsequently attached to the rotating member 114.

In some example embodiments, the rotating member 114 includes a gap 506 that is between the branch sections 402, 404. For example, the spring 112 that is attached to the rod 128 and to the rod 166 may extend through the gap 506. As the rotating member 114 is rotated about the axis 170 with the spring 112 attached to the rod 166, the position of the spring 112 in the gap 506 may change.

In some example embodiments, the rotating member 114, as part of the luminaire mounting system 102, may rotate about the axis 170, for example, when a force is applied to the trigger arm 118 and/or to the retention arm 116. To illustrate, a downward force on the retention arm 118 may cause the rotating member 114 to rotate, for example, in a clockwise direction in the orientation of the luminaire mounting system 102 shown, for example, in FIG. 2. As another example, a leftward force applied to the retention arm 118 may cause the rotating member 114 to rotate, for example, in a counterclockwise direction in the orientation of the luminaire mounting system 102 shown, for example, in FIG. 2. As yet another example, an upward force applied to some areas of the retention arm 118 may cause the rotating member 114 to rotate, for example, in a counterclockwise direction in the orientation of the luminaire mounting system 102 shown, for example, in FIG. 2.

In general, the retention arm 116 and the trigger arm 118 may be oriented with respect to each other such that the trigger arm 118 encounters (i.e., comes in contact with) a ceiling on a room side when the retention arm 116 is being inserted in a device opening of the ceiling such that further upward movement of the luminaire mounting system 102 into the device opening causes the rotating member 114 to rotate, which enables the trigger arm 118 to enter the ceiling opening and the retention arm 116 to clamp down on the ceiling at the back side of the ceiling. The retention arm 116 may include a clamping section 202 that may be at an end portion of the retention arm 116 and that may come in contact with the ceiling on the back side of the ceiling when the retention arm 116 clamped down on the ceiling.

In some example embodiments, the rotating member 134 is equivalent to the rotating member 114, and the description of the rotating member 114 herein is applicable to the rotating member 134. To illustrate, the rotating member 134 may include pivot holes corresponding to the pivot holes 508, 510 of the rotating member 114. For example, the pivot fasteners 142, 164 may be inserted in the pivot holes of the rotating member 134 and in respective holes of the rotating member attachment structures 140, 162 to pivotably attach the rotating member 134 to the rotating member attachment structures 140, 162. As another example, the rotating member 134 may include the branch sections and a gap corresponding to the branch sections 402, 404 and the gap 506, respectively, of the rotating member 114. The spring 132 may extend between the rod 148 and the rod 168 of the rotating member 134 through the gap between the branch sections of the rotating member 134.

In some example embodiments, the rotating members 114, 134 or one or more components of the rotating members 114, 134 may be made from plastic using methods such as injection molding, 3D printing, and/or other methods as can be readily understood by those of ordinary skill in the art with the benefit of this disclosure. Alternatively or in addition, the rotating members 114, 134 or one or more components of the rotating members 114, 134 may be made from another material such as one or more metals (e.g., aluminum) using methods such as casting, milling, and/or other methods as can be readily understood by those of ordinary skill in the art with the benefit of this disclosure.

In some alternative embodiments, the rotating members 114, 134 may have a different shape than shown without departing from the scope of this disclosure. For example, the trigger arms 118, 138 may be slanted differently than shown without departing from the scope of this disclosure. As another example, the retention arms 116, 136 may have different sections that are shaped differently from each other. As another example, the retention arm 116 of the rotating member 114 may include another section after the clamping section 202, and the retention arm 136 of the rotating member 134 may have corresponding sections. In some alternative embodiments, the rod 166 may be at a different location than shown without departing from the scope of this disclosure. In some example embodiments, the rod 166 may be integrally formed with the branch sections 402, 404 without departing from the scope of this disclosure. In general, alternative embodiments described herein with respect to the luminaire mounting system 102 are applicable to the luminaire mounting system 104 without departing from the scope of this disclosure.

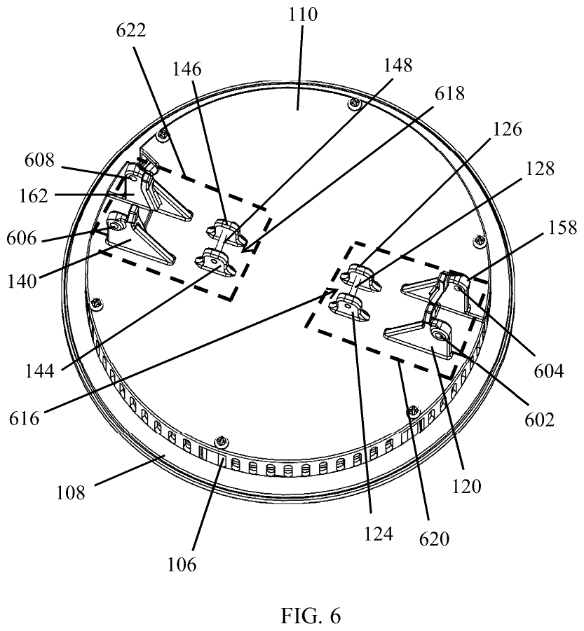

FIG. 6 illustrates a top perspective view of the lighting device 100 of FIGS. 1A-1E with some components of the luminaire mounting systems 102, 104 omitted according to an example embodiment. In FIG. 6, the components of the luminaire mounting systems 102, 104, such as the springs 112, 132 and the rotating members 114, 134, are omitted for clarity of illustration. Referring to FIGS. 1A-6, in some example embodiments, the luminaire mounting system 102 includes a spring attachment structure 616 that may include the posts 124, 126 and the rod 128 that is attached to the posts 124, 126. The spring attachment structure 616 including the rod 128 may serve a fixed spring attachment structure in that at least the posts 124, 126 are non-moving. The luminaire mounting system 102 may include the rotating member attachment structures 120, 158. The rotating member attachment structure 120 may include a pivot hole 602, and the rotating member attachment structure 158 may include a pivot hole 604. The pivot fasteners 122, 160, the pivot holes 602, 604, and the pivot holes 508, 510 of the rotating member 114 may be used to pivotably and rotatably attach the rotating member 114 to the rotating member attachment structures 120, 158.

To illustrate, the pivot fastener 122 may be inserted in the pivot hole 602 of the rotating member attachment structure 120 and in the pivot hole 508 of the rotating member 114. The pivot fastener 160 may be inserted in the pivot hole 604 of the rotating member attachment structure 158 and in the pivot hole 510 of the rotating member 114. To be clear, the rotational range of the rotating member 114 relative to the rotating member attachment structures 120, 158 and about the pivot axis 170 may be limited to less than 360 degrees, for example, by other components of the luminaire mounting system 102 and/or the lighting device 100.

In some alternative embodiments, the pivot holes 508, 510 of the rotating member 114 may be omitted, and the pivot fasteners 122, 160 may be integrally formed with the rotating member 114, where the pivot fasteners 122, 160 are inserted into the pivot hole 602, 604, respectively to pivotably and rotatably attach the rotating member 114 to the rotating member attachment structures 120, 158. To illustrate, the rotating member attachment structures 120, 158 may have enough elasticity to be pushed outwardly to insert the pivot fasteners 122, 160 that are integrally formed with rest of the rotating member 114 into the pivot hole 602, 604. In some alternative embodiments, the pivot hole 602, 604 may be omitted, and the pivot fasteners 122, 160 may be integrally formed with the rotating member attachment structures 120, 158, respectively, where the pivot fasteners 122, 160 are inserted into the pivot holes 508, 510, respectively to pivotably and rotatably attach the rotating member 114 to the rotating member attachment structures 120, 158.

In some example embodiments, the luminaire mounting system 104 includes a spring attachment structure 618 that may include the posts 144, 146 and/or the rod 148 that is attached to the posts 144, 146. The spring attachment structure 618 including the rod 148 may serve a fixed spring attachment structure in that at least the posts 144, 146 are non-moving. The luminaire mounting system 104 may include the rotating member attachment structures 140, 162. The rotating member attachment structure 140 may include a pivot hole 606, and the rotating member attachment structure 162 may include a pivot hole 608. The pivot fasteners 142, 164, the pivot holes 604, 606, and the pivot holes of the rotating member 134 that correspond to the pivot holes 508, 510 of the rotating member 114 may be used to pivotably and rotatably attach the rotating member 134 to the rotating member attachment structures 140, 162 in the manner described with respect to the rotating member 114. The pivot fastener 142 may be inserted into the pivot hole 606 of the rotating member attachment structure 140 and in the corresponding pivot hole of the rotating member 134. The pivot fastener 164 may be inserted in the pivot hole 608 of the rotating member attachment structure 162 and in the corresponding pivot hole of the rotating member 134. To be clear, the rotational range of the rotating member 134 relative to the rotating member attachment structures 140, 162 and about the pivot axis 180 may be limited to less than 360 degrees, for example, by other components of the luminaire mounting system 104 and/or the lighting device 100.

In some alternative embodiments, the pivot holes of the rotating member 134 may be omitted, and the pivot fasteners 142, 162 may be integrally formed with the rotating member 134, where the pivot fasteners 142, 162 are inserted into the pivot hole 606, 608, respectively to pivotably and rotatably attach the rotating member 134 to the rotating member attachment structures 140, 162. To illustrate, the rotating member attachment structures 140, 162 may have enough elasticity to be pushed outwardly to insert the pivot fasteners 142, 162 that are integrally formed with rest of the rotating member 134 into the pivot hole 606, 608. In some alternative embodiments, the pivot hole 606, 608 may be omitted, and the pivot fasteners 142, 162 may be integrally formed with the rotating member attachment structures 140, 162, respectively, where the pivot fasteners 142, 162 are inserted into the pivot holes of the rotating member 134 to pivotably and rotatably attach the rotating member 134 to the rotating member attachment structures 140, 162.

In some example embodiments, the posts 124, 126 and the rod 128 as well as the rotating member attachment structures 120, 158 may be integrally formed with the housing cover 110 of the housing 106. For example, the posts 124, 126 the rod 128, and the rotating member attachment structures 120, 158 may be made from plastic along with the housing cover 110 using methods such as injection molding, 3D printing, and/or other methods. Alternatively or in addition, the posts 124, 126 the rod 128, and the rotating member attachment structures 120, 158 may be made from one or more other materials such as, for example, one or more metals as can be readily understood by those of ordinary skill in the art with the benefit of this disclosure. The housing cover 110 may be integrally formed with the housing 106 or may be attached to the housing 106 using fasteners. In some alternative embodiments, the posts 124, 126 the rod 128, and the rotating member attachment structures 120, 158 may be formed on a base (shown as a dotted box 620 in FIG. 6) that is attached to the housing cover 110, for example, using fasteners as can be readily understood by those of ordinary skill in the art with the benefit of this disclosure.

In some example embodiments, the posts 144, 146 and the rod 148 as well as the rotating member attachment structures 140, 162 may be integrally formed with the housing cover 110 of the housing 106. For example, the posts 144, 146, the rod 148, and the rotating member attachment structures 140, 162 may be made from plastic along with the housing cover 110 using methods such as injection molding, 3D printing, and/or other methods. Alternatively or in addition, the posts 144, 146, the rod 148, and the rotating member attachment structures 140, 162 may be made from one or more other materials such as, for example, one or more metals as can be readily understood by those of ordinary skill in the art with the benefit of this disclosure. The housing cover 110 may be integrally formed with the housing 106 or may be attached to the housing 106 using fasteners. In some alternative embodiments, the posts the posts 144, 146, the rod 148, and the rotating member attachment structures 140, 162 may be formed on a base (shown as a dotted box 622 in FIG. 6) that is attached to the housing cover 110, for example, using fasteners as can be readily understood by those of ordinary skill in the art with the benefit of this disclosure.

In some alternative embodiments, instead of being integrally formed with the housing cover 110, the posts 124, 126 the rod 128, and/or the rotating member attachment structures 120, 158 may be attached to the housing cover 110 using fasteners or other attachment means without departing from the scope of this disclosure. In some alternative embodiments, the posts 124, 126 the rod 128, and/or the rotating member attachment structures 120, 158 may be at different locations than shown without departing from the scope of this disclosure. In some alternative embodiments, instead of being integrally formed with the housing cover 110, the posts 144, 146, the rod 148, and/or the rotating member attachment structures 140, 162 may be attached to the housing cover 110 using fasteners or other attachment means without departing from the scope of this disclosure. In some alternative embodiments, the posts 144, 146, the rod 148, and/or the rotating member attachment structures 140, 162 may be at different locations than shown without departing from the scope of this disclosure. In some alternative embodiments, the lighting device 100 may have a different shape than shown without departing from the scope of this disclosure. For example, the housing 106 and the housing cover 110 may have a rectangular shape. To illustrate, the lighting device 100 may be a round recessed luminaire, a troffer, a linear luminaire, or another type of lighting device.

FIGS. 7A-7D illustrate the lighting device 100 of FIGS. 1A-1E with the luminaire mounting systems 102, 104 in different rotational positions according to an example embodiment. In some example embodiments, the luminaire mounting systems 102, 104 implement an over-center spring mechanism to mount the lighting device 100 recessed in a ceiling. In FIGS. 7A-7D, an over-center axis 702 of the luminaire mounting system 102 and a center axis 704 of the spring 112 are shown. The spring 112 can bias the rotating member 114 to rotate in the rotational directions 706 and 708. In general, the rotational direction 708 is a mounting direction. The term “mounting direction” and “mounting directions” as used herein refer to a rotational direction(s) that can lead to a rotating member of a luminaire mounting system (e.g., the rotating member 114 of the luminaire mounting system 102) encountering a ceiling on the back side of the ceiling. In general, the rotational direction 706 is an unengaged direction. The term “unengaged direction” and “unengaged directions” as used herein refer to a rotational direction(s) that is/are an opposite rotational direction to the mounting direction. The spring 112 biases the rotating member 114 to rotate in a particular rotational direction depending on the rotational position of the rotating member 114. To illustrate, the positional relationship between the over-center axis 702 and the center axis 704 depends on the rotational position of the rotating member 114. When the rotating member 114 is rotationally positioned such that the over-center axis 702 and the center axis 704 overlap each other as shown in FIG. 7A, the rotating member 114 may be in a neutral position where the spring 112 does not apply a biasing force on the rotating member 114.

In some example embodiments, when the rotating member 114 is rotationally positioned such the center axis 704 is above the over-center axis 702 at a vertical plane through the pivot fastener 122 representing a pivot point, the spring 112 may bias the rotating member 114 to rotate in a rotational direction 706 (e.g., counterclockwise in the orientation of the lighting device shown in FIGS. 7A-7D). For example, in FIG. 7B, the spring 112 biases the rotating member 114 to rotate in the rotational direction 706 (i.e., an unengaged direction) against the stoppage structure 176 that prevents further rotation of the rotating member 114 in the rotational direction 706. To illustrate, starting from the rotational position of the rotating member 114 shown in FIG. 7A, an upward force applied on the trigger arm 118 such that the center axis 704 is above the over-center axis 702, where the spring 112 biases the rotating member 114 to rotate or to continue to rotate in the rotational direction 706. As another example, starting from the rotational position of the rotating member 114 shown in FIG. 7A, a leftward force applied on the retention arm 116 such that the center axis 704 is above the over-center axis 702 results in the spring 112 biasing the rotating member 114 to rotate or to continue to rotate in the rotational direction 706.

In some example embodiments, when the rotating member 114 is rotationally positioned such the center axis 704 is below the over-center axis 702 at a vertical plane through the pivot fastener 122 representing a pivot point, the spring 112 may bias the rotating member 114 to rotate in a rotational direction 708. The rotational direction 708 is a clockwise direction in the orientation of the lighting device 100 shown in FIGS. 7A-7D. To illustrate, starting from the rotational position of the rotating member 114 shown in FIG. 7A, a downward force applied on the trigger arm 118 may result in the center axis 704 being below the over-center axis 702, where the spring 112 biases the rotating member 114 to continue to rotate in the rotational direction 708 (i.e., the mounting direction), for example, to the rotational position of the rotating member 114 shown in FIG. 7C. In FIG. 7C, the center axis 704 is below the over-center axis 702, and the spring 112 continues to bias the rotating member 114 to rotate in the rotational direction 708 (i.e., the mounting direction). The rotation of the rotating member 114 in the rotational direction 708 may be stopped at the rotational position of the rotating member 114 shown in FIG. 7C by a structure such as a ceiling (not shown in FIGS. 7A-7D) encountered by the retention arm 116.

In some example embodiments, if the rotation of the rotating member 114 in the rotational direction 708 is not stopped at the rotational position of the rotating member 114 shown in FIG. 7C, for example, by a ceiling, the rotating member 114 may continue to rotate in the rotational direction 708 until the rotating member 114 (e.g., the retention arm 116 or the trigger arm 118) encounters a structure that prevents continued rotation. To illustrate, the biasing force of the spring 112 may cause the rotating member 114 to rotate, for example, to the rotational position shown in FIG. 7D. In contrast to the location of the clamping section 202 of the retention arm 116 in FIG. 7C, the clamping section 202 is at a lower level in FIG. 7D. Although the spring 112 may continue to apply a biasing force on the rotating member 114 to rotate in the rotational direction 708 in FIG. 7D, the rotating member 114 may be prevented from further rotation in the rotational direction 708 by a structure (e.g., the portion of the stoppage structures 176, 178 in the space between the rotating member attachment structures 120, 158 shown, for example, in FIG. 6) encountered, for example, by the trigger arm 118. Without a force that counteracts the biasing force of the spring 112, the rotating member 114 may continue to rotate in the rotational direction 708 resulting in the clamping section 202 being even at a lower level. For example, in the rotational positions of the rotating member 114 shown in FIGS. 7C and 7D, the spring 112 may result in a clamping force of the retention arm 116 that enables the luminaire mounting system 102 along with the luminaire mounting system 104 to mount the lighting device 100 recessed in a ceiling.

In some example embodiments, starting from the rotational position of the rotating member 114 shown, for example, in FIG. 7C or 7D, a force may be applied, directly or indirectly, to the rotating member 114 to overcome the biasing force of the spring 112 and return the rotating member 114 to the rotational position shown, for example, in FIG. 7A or 7B. In general, a force may be applied, for example, by a person to overcome the biasing force of the spring 112 and rotate the rotating member 114 to a different rotational position. For example, the amount of force required to overcome the biasing force of the spring 112 may depend on at least the spring rate of the spring 112 and the rotational position of the rotating member 114 that affects the relative position of the center axis 704 of the spring 112 and the over-center axis 702. The amount of force required to overcome the biasing force of the spring 112 may also depend on the length of the spring 112. In general, the springs 112, 132 may have a respective spring rate and a respective length that enable the luminaire mounting systems 102, 104 to support, for example, at four times the weight of a lighting device 100. Alternatively, the luminaire mounting systems 102, 104 may support more or less than four times the weight of a lighting device 100 without departing from the scope of this disclosure.

To illustrate, when the spring rate of the spring 112 is 9 pounds and the rotating member 114 is in the rotational position shown in FIG. 7D, the biasing force of the spring 112 at the retention arm 116 may be about 4 pounds. As another example, when the spring rate of the spring 112 is 9 pounds and the rotating member 114 is in the rotational position shown in FIG. 7B, the biasing force of the spring 112 may be about 0.2 pounds at the retention arm 116 and 0.5 pounds at trigger arm 118. When the rotating member 114 is in the rotational position shown in FIG. 7A, the biasing force of the spring 112 may be about 0 pounds. Because the weight of the lighting device 100 may be a counteracting force to the biasing force of the spring 112, the spring 112 may be selected to have a spring rate that can support the weight of the lighting device 100 when the rotating member 114 is in a mounting position such as the rotational positions shown in FIGS. 7C and 7D or other mounting positions where the center axis 704 of the spring 112 is below the over-center axis 702.

In some example embodiments, the luminaire mounting system 104 operates in the manner as the luminaire mounting system 102. Indeed, the luminaire mounting system 104 may be another instance of the luminaire mounting system 102. To illustrate, in FIG. 7A, the rotating member 134 of the luminaire mounting system 104 may be in a neutral position corresponding to the neural position of the rotating member 114 in FIG. 7A. For example, starting from the rotational position of the rotating member 134 shown in FIG. 7A, an upward force applied on the trigger arm 138 such that the center axis of the spring 132 is above the over-center axis of the luminaire mounting system 104 results in the spring 132 biasing the rotating member 134 to rotate or to continue to rotate in a rotational direction 710 (i.e., a unengaged direction). As another example, starting from the rotational position of the rotating member 134 shown in FIG. 7A, a rightward force applied on the retention arm 136 such that the center axis of the spring 132 is above the over-center axis of the luminaire mounting system 104 results in the spring 132 biasing the rotating member 134 to rotate or to continue to rotate in the rotational direction 710.

In some example embodiments, in FIG. 7B, the retention arm 136 of the rotating member 134 is positioned against the stoppage structure 172, and the spring 132 continues to bias the rotating member 134 to rotate in a rotational direction 710 against the stoppage structure 172 that prevents further rotation of the rotating member 134 in the rotational direction 710. In FIGS. 7C and 7D, the rotating member 134 may be biased by the spring 132 to rotate in the rotational direction 710 in the same manner that the rotating member 114 of the luminaire mounting system 102 is biased by the spring 112 to rotate in the rotational direction 706. In the rotational positions of the rotating members 114 and 134 shown, for example, in FIGS. 7C and 7D, the springs 112 and 132 may result in the retention arms 116 and 136, respectively, exerting downward clamping forces that enable the luminaire mounting systems 102, 104 to mount the lighting device 100 recessed in a ceiling. In general, the springs 112, 132 may have the same parameters such as spring rates, lengths, etc. The springs 112, 132 may be made from one or more metals such as steel and/or other one or more metals as can be readily understood by those of ordinary skill in the art with the benefit of this disclosure.

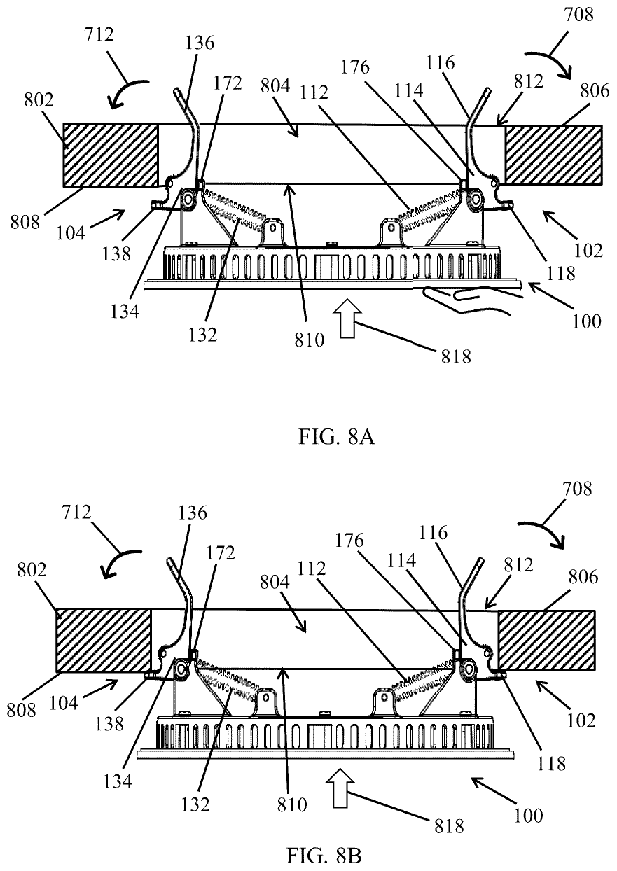

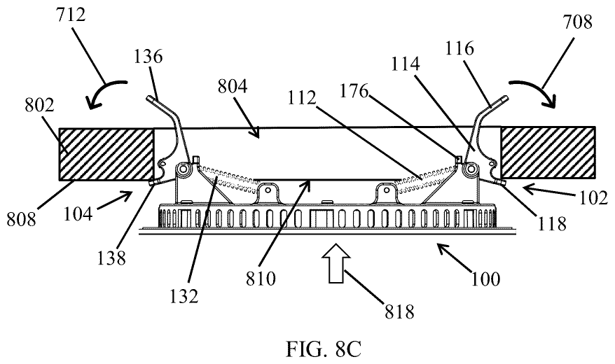

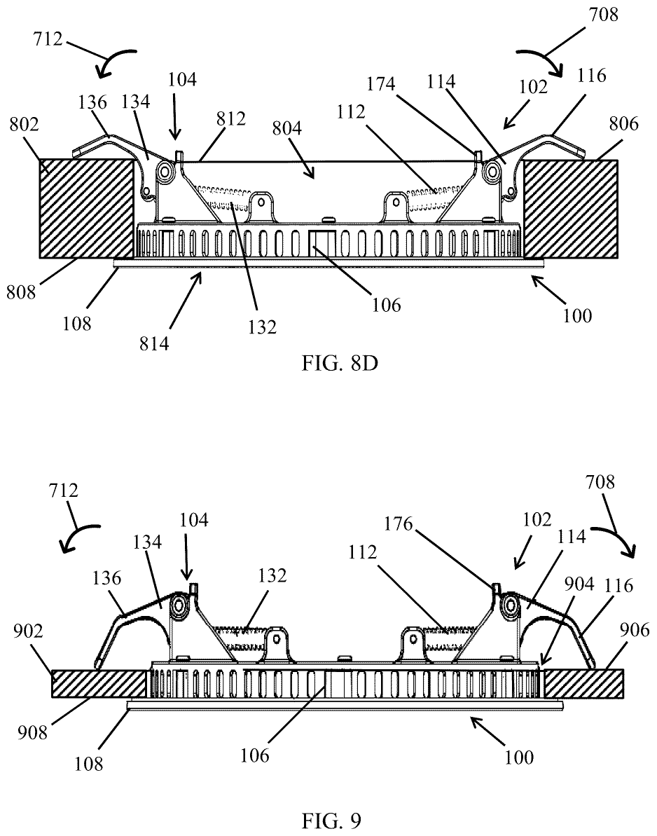

FIGS. 8A-8D illustrate the lighting device 100 of FIGS. 1A-1E at different stages of installation in a ceiling 802 according to an example embodiment. The ceiling 802 may include a device opening 804 that has a lower perimeter edge 810 and an upper perimeter edge 812. The ceiling 802 may have a back side surface 806 and a room side surface 808. The ceiling 802 may be, for example, 1.5 inch thick. Alternatively, the ceiling 802 may be thicker or thinner than 1.5 inch without departing from the scope of this disclosure. In general, the lighting device 100 is mountable recessed in the ceiling 802 by first positioning, by a person, the rotating member 114, 134 in insertion positions (e.g., shown in FIG. 8A), then releasing the rotating member 114, 134 (i.e., not manually applying a force to maintain the rotating member 114, 134 in the insertion positions), followed by moving/inserting the lighting device 100 into the device opening 804 of the ceiling 802 such that the rotating member 114, 134 enter/are inserted into the device opening 804.

Referring to FIGS. 7A-8D, the rotating members 114, 134 as shown in FIG. 8A may be in the same rotational positions shown in FIG. 7B, where the retention arm 116 is positioned against the stoppage structure 176 biased by the spring 112 and where the retention arm 136 is positioned against the stoppage structure 172 biased by the spring 132. To mount the lighting device 100 using the luminaire mounting systems 102, 104, the lighting device 100 may be moved in a direction 818 such that the rotating members 114, 134 extend through the device opening 804, for example, as shown in FIG. 8A. For example, the retention arms 116, 136 may extend through the device opening 804, and the trigger arms 118, 138 may be below the ceiling 802 as shown in FIG. 8A. The rotating members 114, 134 may be rotated to the positions shown in FIG. 8A by a person (e.g., an installer or a consumer) prior to the lighting device 100 being inserted into the device opening 804. That is, the retention arm 116 may be positioned against the stoppage structure 176 and the retention arm 136 may be positioned against the stoppage structure 172 before starting to insert the rotating members 114, 134 into the ceiling opening 804. Because of the biasing forces of the springs 112, 132 on the rotating members 114, 134 toward the stoppage structures 176, 172, respectively, a person does not need to apply an additional force on the rotating members 114, 134 to maintain the retention arms 116, 136 in the insertion positions shown in FIG. 8A while inserting the lighting device 100 into the device opening 804 as shown in FIG. 8A. In general, the retention arm 116 and the trigger arm 118 may be positioned such that the retention arm 116 can enter the device opening 804 while the trigger arm 118 remains below the ceiling 802, and the retention arm 136 and the trigger arm 138 may be positioned such that the retention arm 136 can enter the device opening 804 while the trigger arm 138 remains below the ceiling 802.

In some example embodiments, the lighting device 100 may be moved more to the back side of the ceiling 802 through the device opening 804 by a person such that the trigger arms 118, 138 encounter (i.e., come in contact with) the ceiling 802, for example, as shown in FIG. 8B. To illustrate, starting from the position of the lighting device 100 shown in FIG. 8A, as the lighting device 100 is moved (e.g., pushed) further into the device opening 804 by an installer, the trigger arms 118, 138 may come in contact with the room side surface 808 of the ceiling 802. At the initial contact of the trigger arms 118, 138 with the room side surface 808 of the ceiling 802, the rotating members 114, 134 may be in the same positions as in FIG. 8A where the rotating members 114, 134 are biased by the springs 112, 132 against the stoppage structure 176, 172, respectively. In general, the retention arm 116 and the trigger arm 118 may be oriented relative to each other such that the trigger arm 118 encounters (i.e., comes in contact with) the ceiling 802 from below the ceiling 802 after the retention arm 116 enters the device opening 804, and the retention arm 136 and the trigger arm 138 may be oriented relative to each other such that the trigger arm 138 encounters (i.e., comes in contact with) the ceiling 802 from below the ceiling 802 after the retention arm 136 enters the device opening 804. In FIGS. 8A and 8B, the rotating members 114, 134 and correspondingly the luminaire mounting systems 102, 104 are in an insertion position ready to be inserted into the device opening 804.

In some example embodiments, the lighting device 100 may be moved by an installer further into the device opening 804 in the direction 818 resulting in the rotating members 114, 134 being rotated to the positions shown in FIG. 8C. To illustrate, as the lighting device 100 is being moved (e.g., pushed) further into the device opening 804 after the trigger arms 118, 138 come in contact with the room side surface 808 of the ceiling 802, the rotating members 114, 134 rotate in the rotational directions 708, 712 (i.e., mounting directions), respectively, to the positions shown in FIG. 8C. For example, in FIG. 8C, the rotating members 114, 134 may be in such rotational positions where the springs 112, 132 are each applying a biasing force to rotate the rotating members 114, 134 further in the rotational directions 708, 712, respectively. That is, in FIG. 8C, the center axis 704 of the spring 112 may be below the over-center axis 702, for example, in reference to the pivot point at the pivot fastener 122 (or the pivot axis 170 shown in FIG. 2), and the center axis of the spring 132 may be below the over-center axis of the luminaire mounting system 104, for example, in reference to the pivot point at the pivot fastener 122 (or the pivot axis 180 shown in FIG. 2).

In some example embodiments, as the lighting device 100 is pushed further into the device opening 804 from the rotational positions shown in FIG. 8C, the springs 112, 132 continue to bias the rotating members 114, 134 such that the rotating members 114, 134 rotate in the rotational directions 708, 712 (i.e., mounting directions), respectively, to the rotational positions shown in FIG. 8D, where the retention arms 116, 136 are clamped down on the back side surface 806 of the ceiling 802. That is, in FIG. 8D, the rotating members 114, 134 and correspondingly the luminaire mounting systems 102, 104 are in a mounting position. In FIG. 8D, the lighting device 100 may be fully mounted recessed in the ceiling 802 and positioned to provide a light toward the area below the ceiling 802. For example, the lighting device 100 may be a luminaire that includes a light source (e.g., a light emitting diode (LED) light source) located in the housing 106.

In some example embodiments, in the positions of the rotating members 114, 134 shown in FIG. 8D, the springs 112, 132 each continue to bias the rotating members 114, 134, respectively, such that the lighting device 100 is mounted recessed in the ceiling 802 by the luminaire mounting systems 102, 104. To illustrate, the retention arms 116, 136 may each apply a downward force on the ceiling 802 that together may be at least, for example, four times the weight of the lighting device 100. Alternatively, the combined downward force may be more or less than four times the weight of the lighting device 100. As shown in FIG. 8D, the housing 106 may be positioned in the device opening 804, and the trim 108 may be positioned abutted against the room side surface 808 of the ceiling 802 when the lighting device 100 is fully mounted by the luminaire mounting systems 102, 104. The lighting device 100 may emit a light through an opening 814 of the housing 106.

FIG. 9 illustrates the lighting device of FIGS. 1A-1E mounted to a ceiling 902 according to an example embodiment. The ceiling 902 may include a device opening 904. The ceiling 902 may have a back side surface 906 and a room side surface 908. The ceiling 902 may be, for example, ⅜ inch thick. Alternatively, the ceiling 902 may be thicker or thinner without departing from the scope of this disclosure. In some example embodiments, the ceiling 902 may be thinner than the ceiling 802 of FIGS. 8A-8D. In contrast to the rotational positions of the rotating members 114, 134 in FIG. 8D, in FIG. 9, the rotating members 114, 134 are rotated more in the rotational directions 708, 712, respectively. In FIG. 9, the springs 112, 132 may continue to bias the rotating members 114, 132, respectively, such that the retention arm 116, 136 continue to clamp down on the ceiling 902 on the back side surface 906 and retain the lighting device 100 mounted to the ceiling 902. For example, the retention arms 116, 136 may apply a downward force on the ceiling 902 that may be at least, for example, four times the weight of the lighting device 100. Alternatively, the downward force may be more or less than four times the weight of the lighting device 100. The housing 106 of the lighting device 100 may be positioned in the device opening 904, and the trim 108 may be positioned abutted against the room side surface 908 of the ceiling 902. In general, the lighting device 100 may be mounted recessed in the ceiling 902 in the manner described with respect to FIGS. 8A-8D.

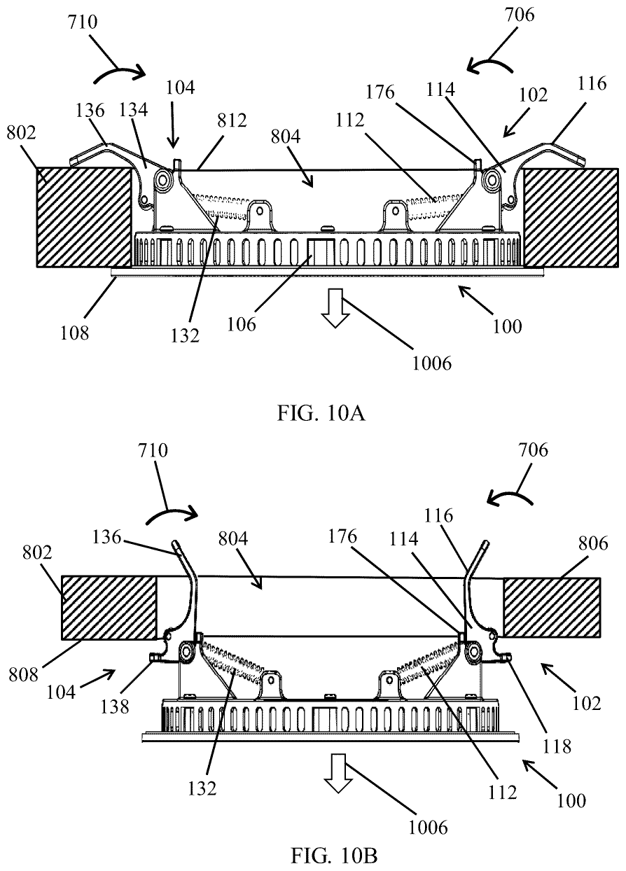

FIGS. 10A and 10B illustrate the lighting device 100 of FIGS. 1A-1E at different stages of uninstallation from the ceiling 802 according to an example embodiment. Referring to FIGS. 7A-10B, in some example embodiments, the lighting device 100 that is mounted in the ceiling 802 by the luminaire mounting systems 102, 104 may be removed from the ceiling 802. To illustrate, after the lighting device 100 is installed recessed in the ceiling 802 as shown in FIG. 10A, a person may apply a downward force in a direction 1006 (i.e., downward in the orientation shown in FIG. 10A) to remove the lighting device 100 from the ceiling 802. For example, a person may pull down, for example, on the trim 108. The downward force on the lighting device 100 may result in the rotating members 114, 134 rotating in the directions 706, 710, respectively. That is, a person may apply adequate force to overcome the biasing forces of the springs 112, 132 on the rotating members 114, 134 such that the lighting device 100 starts moving down through the device opening 804 and the rotating members 114, 134 start rotating in the directions 706, 710, respectively. For example, the weight of the lighting device 100 and a downward force applied by a person on the lighting device 100 in the direction 1006 may need to be adequate to overcome the clamping forces of the rotating members 114, 134 on the ceiling 802. For example, the downward force a person needs to apply on the lighting device 100 may be as little as a few pounds (e.g., 2 pounds, 4 pounds, 10 pounds, 20 pounds, or another value more or less than 20 pounds).

In some example embodiments, as the lighting device 100 is pulled down, the rotating members 114, 134 may rotate in the directions 706, 710, respectively, to the positions shown in FIG. 10B, where the retention arm 116 is positioned against the stoppage structure 176 and the retention arm 136 is positioned against the stoppage structure 172. For example, after the rotating members 114, 134 are rotated in the directions 706, 710, respectively, as result of the downward force by a person and contacts between the ceiling 802 (e.g., the upper perimeter edge 812) and the retention arms 116, 136, the rotations of the rotating members 114, 134 may continue until the rotations are stopped by the stoppage structures 176, 172 because of the biasing by the springs 112, 132, respectively. After the rotating members 114, 134 are in the positions shown in FIG. 10B, a person may pull the lighting device 100 down to completely move the lighting device 100 out of the device opening 804 of the ceiling 802.

The retention arm 116 and the trigger arm 118 of the luminaire mounting system 102 may be oriented relative to each other such that, during the uninstallation/removal of the lighting device 100 from the ceiling 802, the retention arm 116 passes through the device opening 804 of the ceiling 802 after the trigger arm 118 has already passed through. The retention arm 136 and the trigger arm 138 of the luminaire mounting system 104 may be oriented relative to each other such that, during the uninstallation/removal of the lighting device 100 from the ceiling 802, the retention arm 136 passes through the device opening 804 of the ceiling 802 after the trigger arm 138 has already passed through.

In some example embodiments, if the rotating members 114, 134 may rotate back in the rotational directions 708, 712 during or after the removal of the lighting device 100 from the device opening 804, the rotations of the rotating members 114, 134 in the rotational directions 708, 712 may be limited by the portions of the stoppage structures 176, 172 positioned to limit the rotations of the rotating members 114, 134, respectively. For example, limiting the rotations of the rotating members 114, 134 in the rotational directions 708, 712 while still enabling use of the luminaire mounting systems 102, 104 with relatively thin (e.g., ⅜ inch or less) ceilings may reduce risks, for example, of the hand or fingers being caught or pinched between the retention arms 116, 136 and, for example, the trim 108.

By implementing over-center spring mechanism, the luminaire mounting systems 102, 104 can be used to mount a lighting device 100 recessed in a ceiling such as the ceiling 802 and the ceiling 902 with minimal effort by an installer. For example, the luminaire mounting systems 102, 104 eliminate the need to access luminaire mounting structures behind the ceiling as may be required when using some other luminaire mounting systems. Because the luminaire mounting systems 102, 104 do not require accessing luminaire mounting components that are blocked from view, the installation of luminaires recessed in a ceiling is significantly simplified. In general, to install a luminaire that uses the luminaire mounting systems 102, 104 recessed in a ceiling, after an installer positions the rotating members 114, 134, for example, as shown in FIG. 8A, just pushing the lighting device 100 into a device opening (e.g., the device opening 804) can result in the complete mounting of the lighting device recessed in the ceiling. The uninstallation/remove of a luminaire that is mounted recessed by the luminaire mounting systems 102, 104 is also simplified as accessing, for example, using a hand, luminaire mounting components that are behind the luminaire or a ceiling is not required. In general, to uninstall a recessed luminaire that is mounted using the luminaire mounting systems 102, 104, a person can simply pull down on the recessed luminaire without the need to manually detach luminaire mounting components that may be required with some luminaire mounting systems.

In some alternative embodiments, one or more components of the lighting device 100 may have a different shape than shown without departing from the scope of this disclosure. In some alternative embodiments, the luminaire mounting systems 102, 104 may be at different locations than shown without departing from the scope of this disclosure. In some example embodiments, the luminaire mounting systems 102, 104 may be used to mount other types of lighting devices than shown, such as troffers, linear luminaires, etc., without departing from the scope of this disclosure. In some alternative embodiments, the luminaire mounting systems 102, 104 may each be a recessed device mounting system that is used to mount a non-lighting device. In some alternative embodiments, the luminaire mounting systems 102, 104 may be used to mount non-lighting devices, such as speakers and fans (e.g., bathroom fans), recessed in a ceiling or another structure without departing from the scope of this disclosure. For example, the lighting device 100 may be a non-lighting recessed device. In some alternative embodiments, the luminaire mounting systems 102, 104 may be used to mount lighting devices that include other components, such as speakers and fans, without departing from the scope of this disclosure.

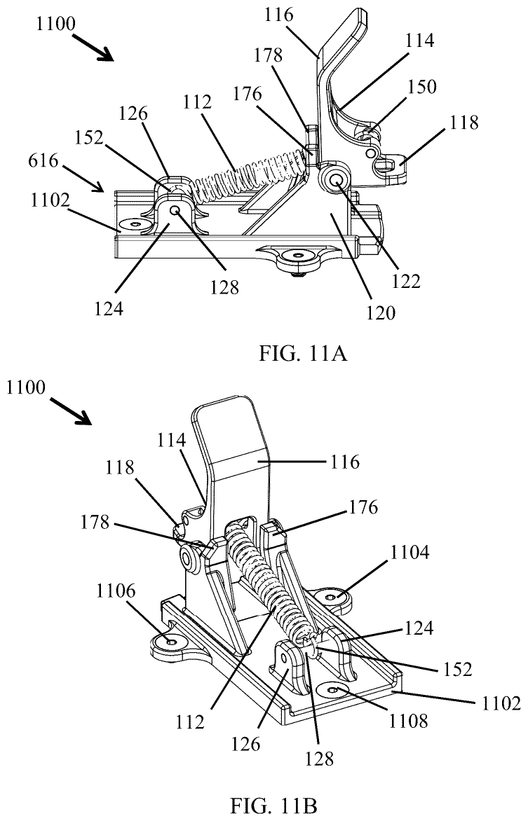

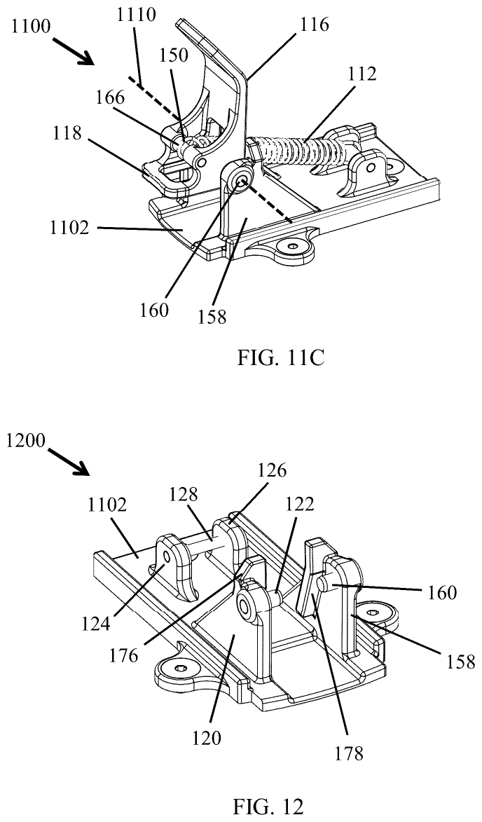

FIGS. 11A-11C illustrate different views of a luminaire mounting system 1100 for mounting a luminaire recessed in a ceiling according to an example embodiment, and FIG. 12 illustrates a frame 1200 of the luminaire mounting system 1100 of FIGS. 11A-11C according to an example embodiment. Referring to illustrate, FIGS. 11A-12, in some example embodiments, the luminaire mounting system 1100 (also referred to as a recessed device mounting system) may correspond to each one of the luminaire mounting systems 102 and 104 of FIGS. 1A-3 with the exception that the luminaire mounting system 1100 includes a frame 1200 including a base 1102 that can be attached to the housing cover 110 of the lighting device 100 of FIGS. 1A-1E. For example, the frame 1200 may be attached to the housing cover 110 of the lighting device 100 of FIGS. 1A-1E using fasteners 1104, 1106, 1108 (e.g., screws) instead of, for example, being integrally formed with the housing cover 110. For example, fastener holes corresponding to the fasteners 1104, 1106, 1108 may be formed in the housing cover 110. In general, the luminaire mounting system 1100 may operate and may be used in the same manner as each one of the luminaire mounting systems 102, 104. For example, two instances of the luminaire mounting system 1100 may be used in place of the luminaire mounting systems 102, 104 to mount a lighting device, such as the lighting device 100 of FIGS. 1A-1E, recessed in a structure such as the ceiling 802 of FIGS. 8A-8D and the ceiling 902 of FIG. 9.

To illustrate, referring to FIGS. 11A-11C, in some example embodiments, the luminaire mounting system 1100 may include the spring 112, the rotating member 114, and the frame 1200. The frame 1200 may include the base 1102, the rotating member attachment structures 120, 158, and the spring attachment structure 616. The spring attachment structure 616 may include the posts 124, 126 and/or the rod 128. The rod 128 may be attached to the posts 124, 126 in the manner described with respect to the luminaire mounting system 102. In contrast to the luminaire mounting system 102, the rotating member attachment structures 120, 158 and the posts 124, 126 may be integrally formed with the base 1102 instead of with the housing cover 110. In some alternative embodiments, the rotating member attachment structures 120, 158 and/or the posts 124, 126 may be attached to base 1102, for example, using one or more fasteners.

In some example embodiments, the rotating member 114 of the luminaire mounting system 1100 may be pivotably attached to the rotating member attachment structures 120, 158, for example, using pivot fasteners 122, 160. In general, the rotating member 114 in the luminaire mounting system 1100 is another instance of or otherwise corresponds to the rotating member 114 of the luminaire mounting system 102 shown in FIGS. 1A-2. The rotating member 114 may be attached to the rotating member attachment structures 120, 158 such that the rotating member 114 is rotatable relative to the rotating member attachment structures 120, 158 (i.e., the rotating member attachment structures 120, 158 staying fixed). The pivot fasteners 122, 160 may be discrete components that are attached to the rotating member attachment structures 120, 158, respectively, or may be integrally formed with the rotating member attachment structures 120, 158, respectively. For example, the rotating member attachment structures 120, 158 may be individually pushed outward to insert the pivot fasteners 122, 160 into the pivot holes 508, 510, respectively. To illustrate, the rotating member 114 may be attached to the rotating member attachment structures 120, 158 by the pivot fasteners 122, 160 to rotate about a pivot axis 1110 extending through the pivot fasteners 122, 160, where the pivot axis corresponds to the pivot axis 170 shown, for example, in FIG. 1D. Alternatively, the pivot fasteners 122, 160 may be discrete components that are attached to the rotating member 114 or may be integrally formed with the rotating member 114, where the rotating member attachment structures 120, 158 may be individually pushed outward to insert the pivot fasteners 122, 160 into the pivot holes of the rotating member attachment structures 120, 158. The rotation of the rotating member 114 may be limited in one or more rotational directions, for example, by stoppage structures 176, 178. For example, the stoppage structures 176, 178 may be located to come in contact with different sections of the rotating member 114 and prevent further rotation of the rotating member 114 in two rotational directions.

As described above with respect to the luminaire mounting system 102 and FIGS. 1A-2, in some example embodiments, the rotating member 114 of the luminaire mounting system 1100 may include the retention arm 116 and a trigger arm 118. The retention arm 116 and the trigger arm 118 may be at fixed locations relative to each other as the rotating member 114 rotates about the pivot axis 1110 extending through the pivot fasteners 122, 160. The rotating member 114 may also include the rod 166 that serves as a spring attachment structure of the rotating member 114. In general, the retention arm 116 and the trigger arm 118 may be oriented relative to each other such that the trigger arm 118 encounters (i.e., comes in contact with) a ceiling from below the ceiling after the retention arm 116 enters the device opening of the ceiling in the manner described with respect to the luminaire mounting systems 102, 104.

In some example embodiments, the spring 112 may be attached to the rotating member 114 and to the rod 128. That is, the spring 112 may be attached to a fixed structure (i.e., the rod 128) and to a pivoting structure (i.e., the rotating member 114). In general, the spring 112 in the luminaire mounting system 1100 corresponds to the spring 112 of the luminaire mounting system 102 shown in FIGS. 1A-2 and operates in the same manner. To illustrate, the spring 112 may be attached to the rod 166 of the rotating member 114 and to the rod 128. An end portion 152 of the spring 112 may be attached to the rod 128, and another end portion 150 of the spring 112 may be attached to the rod 166. In some cases, the rod 128 and the rod 166 may be located such that the spring 112 extends longitudinally past the pivot fasteners 122, 160. In general, the luminaire mounting system 1100 may implement an over-center spring mechanism that functions in the manner described above with respect to the luminaire mounting systems 102, 104 and, for example, FIGS. 7A-7D.

In some example embodiments, the spring 112 of the luminaire mounting system 1100 may bias the rotating member 114 to rotate in the rotational direction 708 (i.e., mounting direction) or in the rotational direction 706 (i.e., unengaged/disengaged direction) shown in FIGS. 7A-7D depending on the rotational position of the rotating member 114 in the manner as described above with respect to the luminaire mounting system 102. To illustrate, the spring 112 may bias the rotating member 114 to rotate in the rotational direction 706 (i.e., the unengaged direction) shown in FIGS. 7A-7D to different rotational positions including those corresponding to the rotational positions shown in FIGS. 7B, 8A, and 8B. For example, the rotational position of rotating member 114 of the luminaire mounting system 1100 in FIGS. 11A-11C may be an insertion position and may correspond to the insertion position of the rotating member 114 of the luminaire mounting system 102 shown in FIGS. 7B, 8A, and 8B, where the spring 112 is biasing the retention arm 116 to remain positioned against the stoppage structures 176, 178. To be clear, the luminaire mounting system 1100 may also be used in place of the luminaire mounting system 104, and the spring 112 may bias the rotating member 114 to rotate in the rotational direction 710 or the rotational direction 712 depending on the rotational position of the rotating member 114.

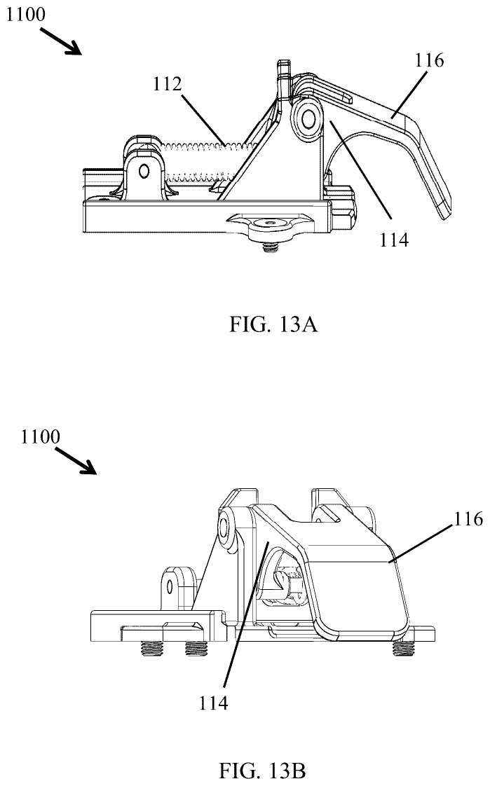

FIGS. 13A and 13B illustrate different views of the luminaire mounting system 1100 of FIGS. 11A-11C in a mounting position according to an example embodiment. In some example embodiments, the spring 112 may bias the rotating member 114 to rotate in the rotational direction 708 (i.e., mounting direction) shown in FIGS. 7A-7D to different rotational positions including those corresponding to the rotational positions of the rotating member 114 of the luminaire mounting system 102 shown in FIGS. 7C, 7D, 8C, 8D, and 9. For example, the rotational position of the rotating member 114 in FIGS. 13A and 13B may correspond to the rotational position of the rotating member 114 of the luminaire mounting system 102 shown in FIG. 7D and FIG. 9. To illustrate, in the mounting position of the luminaire mounting system 1100 shown in FIGS. 13A and 13B or in another mounting position, the retention arm 116 may exert a clamping force against the back side of a ceiling, such the ceiling 802 of FIGS. 8A-8D and the ceiling 902 of FIG. 9, to mount the lighting device 100 recessed in the ceiling.

Referring to FIGS. 11A-13B, in some example embodiments, the luminaire mounting system 1100 may be used in place of both of the luminaire mounting systems 102, 104 to mount the lighting device 100 or another lighting device or luminaire recessed in a ceiling in the manner described above with respect to the luminaire mounting systems 102, 104 and FIGS. 1A-10B. The luminaire mounting system 1100 may provide the same advantages as each one of the luminaire mounting systems 102, 104. For example, a luminaire that includes two of the luminaire mounting system 1100 in place of the luminaire mounting systems 102, 104 may be mounted recessed in the ceiling 802 of FIGS. 8A-8D or the ceiling 902 of FIG. 9 in the manner as described with respect to the lighting device 100 and FIGS. 8A-9. A luminaire that includes two of the luminaire mounting system 1100 in place of the luminaire mounting systems 102, 104 and that is mounted in the ceiling 802 of FIGS. 8A-8D or the ceiling 902 of FIG. 9 may be removed in the manner as described with respect to the lighting device 100 and FIGS. 10A and 10B.

As shown in FIGS. 11A-13B, the luminaire mounting system 1100 may be a standalone device that gets attached to a lighting device such as the lighting device 100. In general, the luminaire mounting system 1100 may be used to mount different types of lighting devices including troffers, linear luminaires, etc. In some example embodiments, a luminaire may include more than two (e.g., three or four) of the luminaire mounting system 1100 to mount the luminaire recessed in a ceiling.

In some example embodiments, the frame 1200 may be made from plastic using one or more methods such as injection molding, 3D printing, and/or other methods as can be readily understood by those of ordinary skill in the art with the benefit of this disclosure. In some alternative embodiments, the frame 1200 may be made from one or more other materials (e.g., a metal) without departing from the scope of this disclosure. The other components of the luminaire mounting system 1100 may be made using the same material(s) and/or methods described above with respect to the luminaire mounting systems 102, 104.

In general, the alternative embodiments described above with respect to the luminaire mounting systems 102, 104 are applicable to the luminaire mounting system 1100. In some alternative embodiments, the fasteners 1104, 1106, 1108 may be at different locations than shown without departing from the scope of this disclosure. In some alternative embodiments, the fasteners 1104, 1106, 1108 may be a different type of fasteners than shown without departing from the scope of this disclosure. In some alternative embodiments, the base 1102 may have a different shape than shown without departing from the scope of this disclosure. In some alternative embodiments, some of the components of the luminaire mounting system 1100 may be at different locations on the base 1102 than shown without departing from the scope of this disclosure. In some alternative embodiments, the luminaire mounting system 100 may be a recessed device mounting system that is used to mount a non-lighting device. In some alternative embodiments, the luminaire mounting system 1100 may be used to mount non-lighting devices, such as speakers and fans (e.g., bathroom fans), recessed in a ceiling or another structure without departing from the scope of this disclosure. In some alternative embodiments, the luminaire mounting system 100 may be used to mount lighting devices that include other components, such as speakers and fans, without departing from the scope of this disclosure.

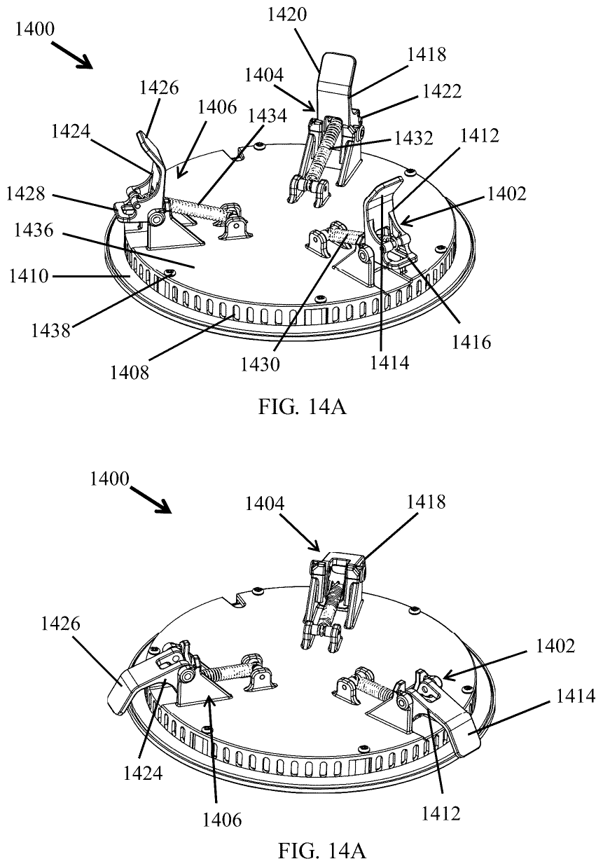

FIGS. 14A and 14B illustrate different views of a lighting device 1400 that includes luminaire mounting systems 1402, 1404, 1406 according to another example embodiment. In some example embodiments, the lighting device 1400 may correspond to the lighting device 100 of FIGS. 1A-1E with one more luminaire mounting system. For example, the lighting device 1400 may be a heavier luminaire that needs to be mounted in a ceiling, such as the ceiling 802 of FIGS. 8A-8D and the ceiling 902 of FIG. 9, by more than two luminaire mounting systems to support the weight of the lighting device 1400. The luminaire mounting systems 1402, 1404, 1406 (also referred to as recessed device mounting systems) may each implement an over-center spring mechanism that functions in the manner described with respect to the luminaire mounting systems 102, 104 and FIGS. 1A-10B.

In some example embodiments, the lighting device 1400 includes a housing 1408 and a trim 1410 that may be integrally formed with the housing 1408 or that may be a separate component that is attached to the housing 1408. The lighting device 1400 may include a housing cover 1436 that may be integrally formed with the housing 1408 or that may be attached to the housing 1408 by one or more fasteners such as a fastener 1438.

In some example embodiments, the luminaire mounting systems 1402, 1404, 1406 may each correspond to and operate in the manner described above with respect to the luminaire mounting systems 102, 104. Some components of the luminaire mounting systems 1402, 1404, 1406, such as posts and other structures corresponding to the posts 124, 126 and structures 120, 158 of the lighting device 100 shown in FIGS. 1A-1E, may be integrally formed with the housing cover 1436.

In some example embodiments, the luminaire mounting system 1402 may include a spring 1430 and a rotating member 1412 that are attached and that operate in the manner described with respect to, for example, the spring 112 and the rotating member 114 of the luminaire mounting system 102 of the lighting device 100 of FIGS. 1A-1E. The rotating member 1412 of the luminaire mounting system 1402 may include a retention arm 1414 and a trigger arm 1416 that correspond to the retention arm 116 and the trigger arm 118, respectively, of the rotating member 114 of the luminaire mounting system 102 of FIGS. 1A-1E. The spring 1430 may bias the rotating member 1412 in the manner described above with respect to the luminaire mounting systems 102, 104.

In some example embodiments, the spring 1430 may bias the rotating member 1412 to rotate to different rotational positions including those corresponding to the rotational positions of the rotating member 114 of the luminaire mounting system 102 shown in FIGS. 7B-9. For example, the rotational position of the rotating member 1412 in FIG. 14A, where the luminaire mounting system 1402 is in an insertion position, may correspond to the rotational position of the rotating member 114 of the luminaire mounting system 102 shown in FIGS. 7B, 8A, and 8B. The rotational position of the rotating member 1412 in FIG. 14B may correspond to the rotational position of the rotating member 114 of the luminaire mounting system 102 shown in FIG. 7D and FIG. 9. To illustrate, in the mounting position of the luminaire mounting system 1402 shown in FIG. 14B or in another mounting position, the retention arm 1414 may exert a clamping force against the back side of a ceiling, such the ceiling 802 of FIGS. 8A-8D and the ceiling 902 of FIG. 9, to mount the lighting device 1400 recessed in the ceiling. In general, the retention arm 1414 and the trigger arm 1416 may be oriented relative to each other such that the trigger arm 1416 encounters (i.e., comes in contact with) a ceiling from below the ceiling after the retention arm 1414 enters the device opening of the ceiling in the manner described with respect to the luminaire mounting systems 102, 104 and FIGS. 8A-9.

In some example embodiments, the luminaire mounting system 1404 may include a spring 1432 and a rotating member 1418 that are attached and that operate in the manner described with respect to, for example, the spring 112 and the rotating member 114 of the luminaire mounting system 102 of the lighting device 100 of FIGS. 1A-1E. The rotating member 1418 of the luminaire mounting system 1404 may include a retention arm 1420 and a trigger arm 1422 that correspond to the retention arm 116 and the trigger arm 118, respectively, of the rotating member 114 of the luminaire mounting system 102 of FIGS. 1A-1E. The spring 1432 may bias the rotating member 1418 in the manner described above with respect to the luminaire mounting systems 102, 104.

In some example embodiments, the spring 1432 may bias the rotating member 1418 to rotate to different rotational positions including those corresponding to the rotational positions of the rotating member 114 of the luminaire mounting system 102 shown in FIGS. 7B-9. For example, the rotational position of the rotating member 1418 in FIG. 14A, where the luminaire mounting system 1404 is in an insertion position, may correspond to the rotational position of the rotating member 114 of the luminaire mounting system 102 shown in FIGS. 7B, 8A, and 8B. The rotational position of the rotating member 1418 in FIG. 14B may correspond to the rotational position of the rotating member 114 of the luminaire mounting system 102 shown in FIG. 7D and FIG. 9. To illustrate, in the mounting position of the luminaire mounting system 1404 shown in FIG. 14B or in another mounting position, the retention arm 1420 may exert a clamping force against the back side of a ceiling, such the ceiling 802 of FIGS. 8A-8D and the ceiling 902 of FIG. 9, to mount the lighting device 1400 recessed in the ceiling. In general, the retention arm 1420 and the trigger arm 1422 may be oriented relative to each other such that the trigger arm 1422 encounters (i.e., comes in contact with) a ceiling from below the ceiling after the retention arm 1420 enters the device opening of the ceiling in the manner described with respect to the luminaire mounting systems 102, 104 and FIGS. 8A-9.

In some example embodiments, the luminaire mounting system 1406 may include a spring 1434 and a rotating member 1424 that are attached and that operate in the manner described with respect to, for example, the spring 112 and the rotating member 114 of the luminaire mounting system 102 of the lighting device 100 of FIGS. 1A-1E. The rotating member 1424 of the luminaire mounting system 1406 may include a retention arm 1426 and a trigger arm 1428 that correspond to the retention arm 116 and the trigger arm 118, respectively, of the rotating member 114 of the luminaire mounting system 102 of FIGS. 1A-1E. The spring 1434 may bias the rotating member 1424 in the manner described above with respect to the luminaire mounting systems 102, 104.

In some example embodiments, the spring 1434 may bias the rotating member 1424 to rotate to different rotational positions including those corresponding to the rotational positions of the rotating member 114 of the luminaire mounting system 102 shown in FIGS. 7B-9. For example, the rotational position of the rotating member 1424 in FIG. 14A, where the luminaire mounting system 1406 is in an insertion position, may correspond to the rotational position of the rotating member 114 of the luminaire mounting system 102 shown in FIGS. 7B, 8A, and 8B. The rotational position of the rotating member 1424 in FIG. 14B may correspond to the rotational position of the rotating member 114 of the luminaire mounting system 102 shown in FIG. 7D and FIG. 9. To illustrate, in the mounting position of the luminaire mounting system 1404 shown in FIG. 14B or in another mounting position, the retention arm 1426 may exert a clamping force against the back side of a ceiling, such the ceiling 802 of FIGS. 8A-8D and the ceiling 902 of FIG. 9, to mount the lighting device 1400 recessed in the ceiling. In general, the retention arm 1426 and the trigger arm 1428 may be oriented relative to each other such that the trigger arm 1428 encounters (i.e., comes in contact with) a ceiling from below the ceiling after the retention arm 1426 enters the device opening of the ceiling in the manner described with respect to the luminaire mounting systems 102, 104 and FIGS. 8A-9.

In some example embodiments, adjacent ones of the luminaire mounting systems 1402, 1404, 1406 may be equally spaced from each other to provide a balanced support to the lighting device 1400. The lighting device 1400 may be mounted recessed in a ceiling, such as the ceiling 802 of FIGS. 8A-8D and the ceiling 902 of FIG. 9, by the luminaire mounting systems 1402, 1404, 1406 in the manner described about with respect to the lighting device 100, the luminaire mounting systems 102, 104, and FIGS. 8A-9. The lighting device 1400 that is already recessed in a ceiling may be removed in the manner described with respect to the lighting device 100, the luminaire mounting systems 102, 104, and FIGS. 10A and 10B.

In general, the different components of the lighting device 1400 may be made from one or more materials and in the same manner as described with respect to corresponding components of the lighting device 100 of FIGS. 1A-1E. In general, alternative embodiments described above with respect to the luminaire mounting systems 102, 104 and the lighting device 100 of FIGS. 1A-10B are applicable to the luminaire mounting systems 1402, 1404, 1406 and the lighting device 1400. In some alternative embodiments, the lighting device 1400 may include more luminaire mounting systems than shown without departing from the scope of this disclosure. In some alternative embodiments, the luminaire mounting systems 1402, 1404, 1406 may be at different locations than shown without departing from the scope of this disclosure. In some alternative embodiments, the luminaire mounting systems 1402, 1404, 1406 may each be a recessed device mounting system that is used to mount a non-lighting device.

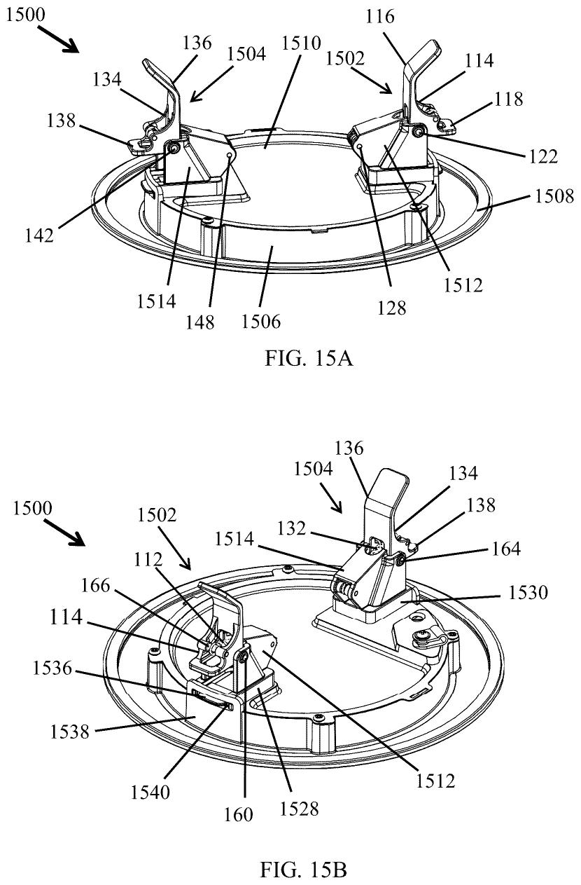

FIGS. 15A-15C illustrate different views of a lighting device 1500 that includes luminaire mounting systems 1502, 1504 according to another example embodiment, and FIG. 16 illustrates the luminaire mounting systems 1502, 1504 of FIGS. 15A-15C in a mounting position according to an example embodiment. In some example embodiments, the luminaire mounting systems 1502, 1504 are shown in FIGS. 15A-15C in an insertion position. Referring to FIGS. 15A-16, the luminaire mounting systems 1502, 1504 (also referred to as recessed device mounting systems) may be used together to mount the lighting device 1500 or another lighting device recessed in a structure such as a ceiling in a manner described above with respect to the luminaire mounting systems 102, 104 and FIGS. 1A-10B. For example, the luminaire mounting system 1502 may correspond to the luminaire mounting system 102, and the luminaire mounting system 1504 may correspond to the luminaire mounting system 104. In general, the luminaire mounting systems 1502, 1504 may each implement an over-center spring mechanism that functions in a manner described with respect to the luminaire mounting systems 102, 104 and FIGS. 8A-8D to mount the lighting device 1500 or another lighting device recessed in a structure, such as the ceiling 802 of FIGS. 8A-8D and the ceiling 902 of FIG. 9.

In some example embodiments, the lighting device 1500 includes the luminaire mounting systems 1502, 1504 and a housing 1506. The housing 1506 may be made from plastic using one or more methods such as injection molding, 3D printing, and/or other methods as can be readily understood by those of ordinary skill in the art with the benefit of this disclosure. Alternatively, the frame 1512 may be made from one or more other materials such metals using one or more methods such casting, milling, etc.

In some example embodiments, the lighting device 1500 may include a trim 1508 that may be a standalone component attached to the housing 1506 or that may be integrally formed with the housing 1506. To illustrate, when the lighting device 1500 is installed recessed in a ceiling, the trim 1508 may abut against the ceiling on the room side. The lighting device 1500 may include a housing cover 1510 that may be integrally formed with the rest of the housing 1506 or that may be attached to the housing 1506, for example, using fasteners such as a screw 1548. The luminaire mounting systems 1502, 1504 may be located on the housing cover 1510 across from each other to symmetrically mount the lighting device 1500 recessed in a device opening of a ceiling. In contrast to the luminaire mounting systems 102, 104 of FIGS. 1A-3 that may be integrally formed, for example, with housing cover 110, the luminaire mounting systems 1502, 1504 may each be a standalone device that is attached to the housing 1506 and/or the housing cover 1510 of the lighting device 1500 as described below in more detail.

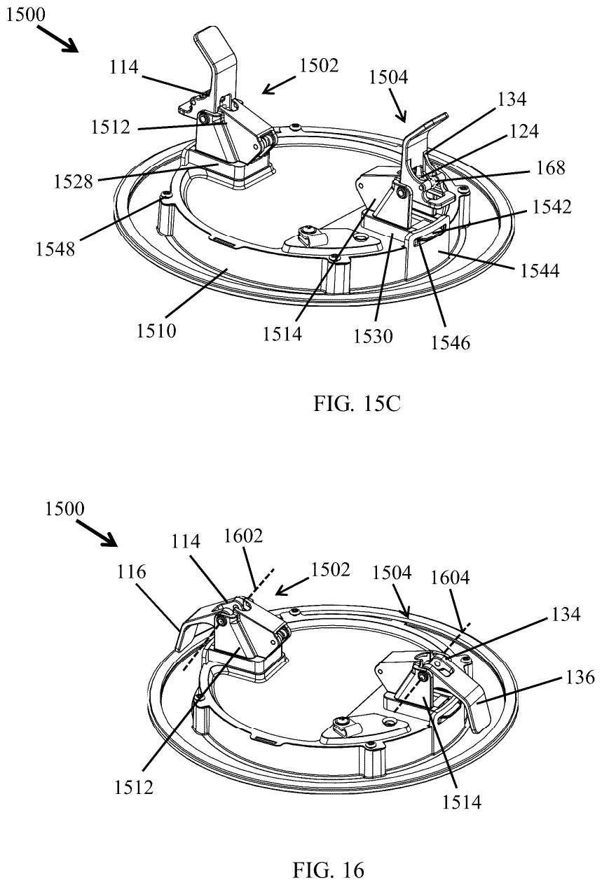

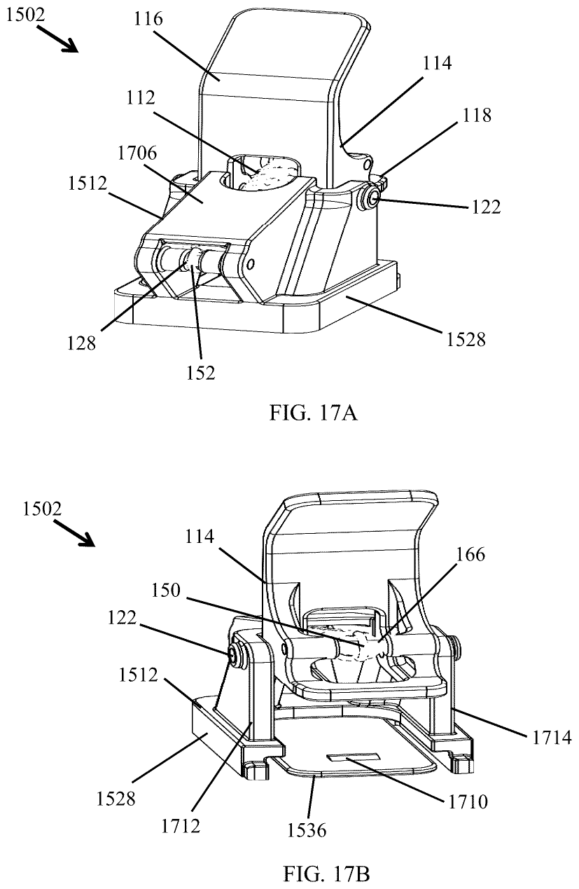

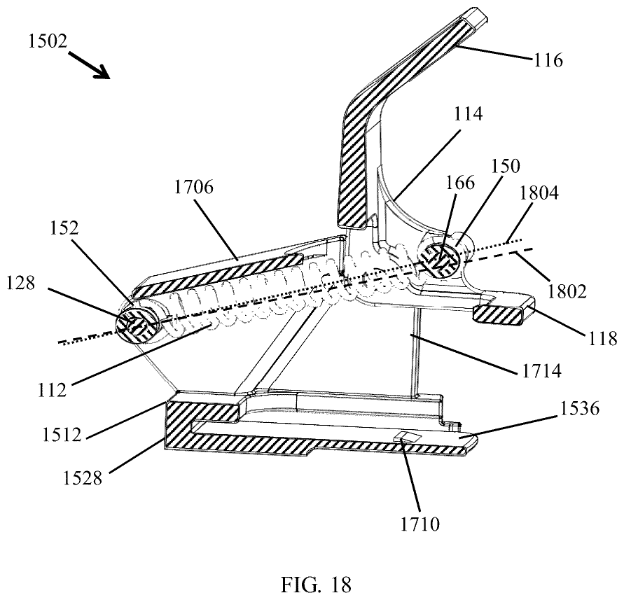

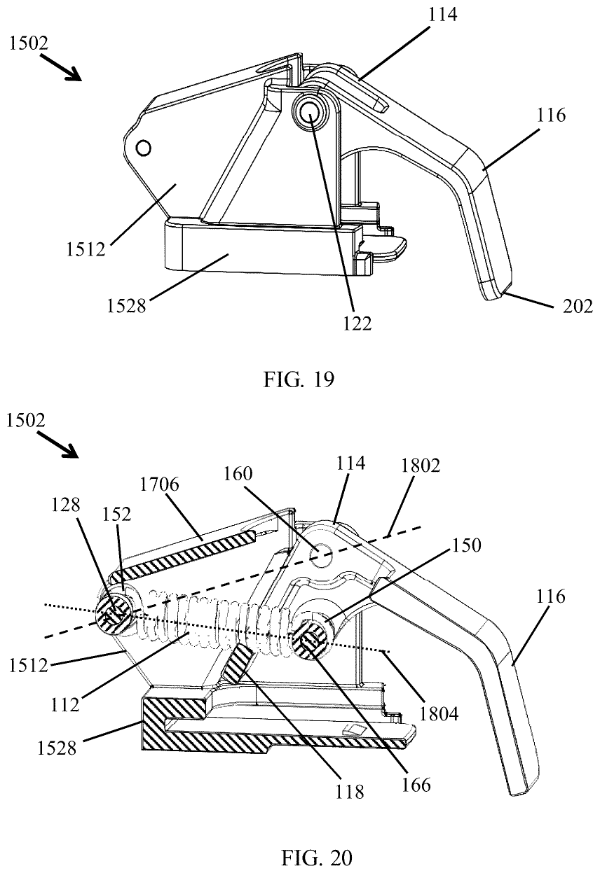

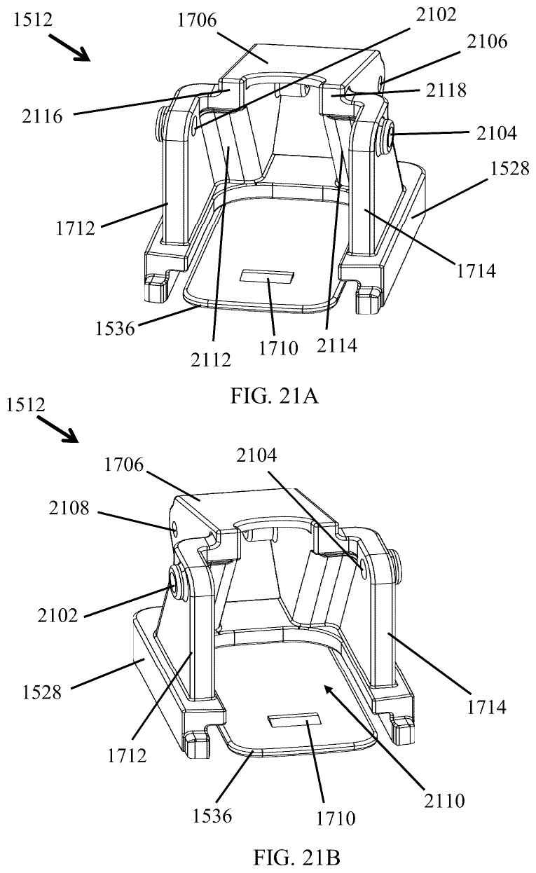

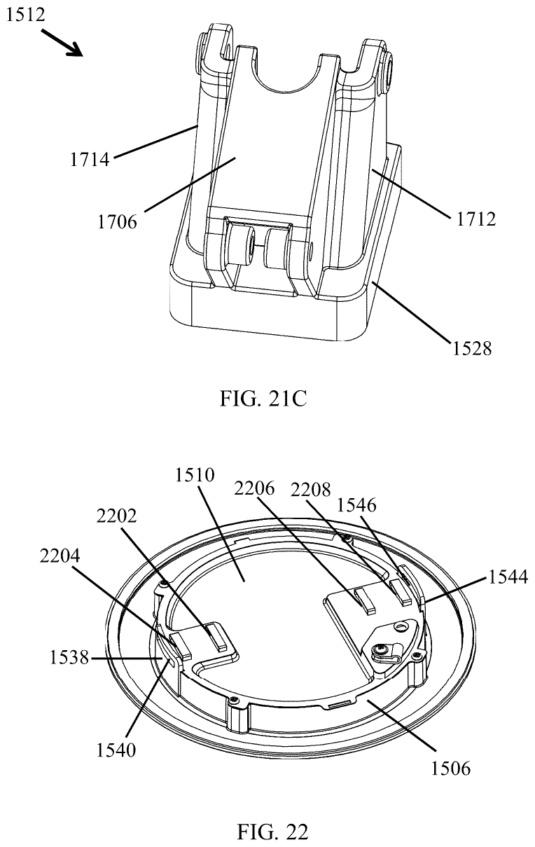

In some example embodiments, in contrast to the luminaire mounting systems 102, 104 of the lighting device 100 of FIGS. 1A-3, the luminaire mounting systems 1502, 1504 of the lighting device 1500 may each be a standalone device that is attached to housing cover 1510 of the lighting device 1500. To illustrate with respect to the luminaire mounting system 1502, FIGS. 17A and 17B illustrate the luminaire mounting system 1502 of the lighting device shown in FIGS. 15A-15C according to an example embodiment, FIG. 18 illustrates a cross-sectional view of the luminaire mounting system 1502 of FIGS. 17A and 17B according to an example embodiment, FIG. 19 illustrates the luminaire mounting system 1502 of FIGS. 17A and 17B in a mounting position according to an example embodiment, FIG. 20 illustrates a cross-sectional view of the luminaire mounting system 1502 of FIG. 19 according to an example embodiment, and FIGS. 21A-21C illustrate a frame of the luminaire mounting system 1502 of FIGS. 17A and 17B according to an example embodiment.

Referring to FIGS. 15A-21C, in some example embodiments, the luminaire mounting system 1502 includes the spring 112, the rotating member 114, and a frame 1512. The frame 1512 may include a top wall 1706, sidewalls 1712, 1714, a base 1528, and a housing attachment structure 1536. The sidewalls 1712, 1714 may extend up from the base 1528. The housing attachment structure 1536 may extend out from the base 1528 such that the housing attachment structure 1536 may be used to attach the frame 1512 to the housing cover 1510. For example, the base 1528 of the luminaire mounting system 1502 may be positioned on the housing cover 1510 of the lighting device 1500, where the housing attachment structure 1536 is inserted into retention slots of the housing cover 1510 to securely attach the luminaire mounting system 1502 to the lighting device 1500. The housing attachment structure 1536 may also be inserted into a slot 1540 of a post 1538 that may be part of the housing 1506 of the lighting device 1500.

In general, the frame 1512 may be used in place of the posts 124, 126 and the rotating member attachment structures 120, 158 of the luminaire mounting system 102 of FIGS. 1A-1E, where, for example, the posts 124, 126 and the rotating member attachment structures 120, 158 are integrated in the frame 1512. To illustrate, the frame 1512 may serve as the rotating member attachment structure for the rotating member 114. The connectivity of the sidewalls 1712, 1714, the top wall 1706, and the base 1528 may provide structural rigidity to the frame 1512. The frame 1512 may be made from plastic using one or more methods such as injection molding, 3D printing, and/or other methods as can be readily understood by those of ordinary skill in the art with the benefit of this disclosure. Alternatively, the frame 1512 may be made from one or more other materials such metals using one or more methods such casting, milling, etc.

In some example embodiments, the luminaire mounting system 1502 may include a rod 128 that is used as a spring attachment structure. The rod 128 may be attached to the frame 1512. For example, the frame 1512 may include holes 2106, 2108, where the rod 128 is attached to the frame 1512 inserted in the holes 2106, 2108. The rod 128 may extend between the holes 2106, 2108 and may be positioned in a cavity 2110 of the frame 1512. In some alternative embodiments, the rod 128 may be integrally formed with the frame 1512 as a single unit, for example, using one or more methods such as injection molding and/or other methods.

In some example embodiments, the rotating member 114 of the luminaire mounting system 1502 may be pivotably attached to the frame 1512, for example, using pivot fasteners 122, 160. The rotating member 114 may be attached to the frame 1512 such that the rotating member 114 is rotatable relative to frame 1512. To illustrate, the rotating member 114 may be attached to the frame 1512 by the pivot fasteners 122, 160 to rotate about a pivot axis 1602 extending through the pivot fasteners 122, 160 and corresponding to the pivot axis 170 shown, for example, in FIG. 1D. The pivot fastener 122 may be inserted in pivot hole 2102 of the frame 1512 and the pivot fastener 160 may be inserted in the pivot hole 2104 of the frame 1512 to pivotably attach the rotating member 114 to the frame 1512.

In some example embodiments, the rotation of the rotating member 114 about the pivot axis 1602 may be limited, for example, by sections 2112, 2114, 2116, 2118 of the frame 1512 that serve as stoppage structures in a manner described above with respect to the stoppage structures 176, 178 of the luminaire mounting system 102 and, for example, FIGS. 1A-1E. The sections 2112, 2114, 2116, 2118 of the frame 1512 may be located to come in contact with the rotating member 114 and prevent further rotation of the rotating member 114 in two rotational directions.

In some example embodiments, the rotating member 114 of the luminaire mounting system 1502 may include the retention arm 116 and the trigger arm 118 as described with respect to the luminaire mounting system 102 of FIGS. 1A-2. The retention arm 116 and the trigger arm 118 may be at fixed locations relative to each other as the rotating member 114 rotates about the pivot axis 1602 extending through the pivot fasteners 122, 160. The rotating member 114 may also include the rod 166 that serves as a spring attachment structure of the rotating member 114. For example, the rod 166 may be integrally formed with the rotating member 114 or may be a discrete component that is subsequently attached to the rotating member 114.

In some example embodiments, the spring 112 of the luminaire mounting system 1502 may be attached to the rotating member 114 and to the rod 128. That is, the spring 112 may be attached to a fixed structure (i.e., the rod 128 at least by virtue of attachment to the frame 1512) and to a pivoting structure (i.e., the rod 166 attached to the rotating member 114). For example, the spring 112 may extend between the rod 128 and the rod 166. An end portion 152 of the spring 112 may be attached to the rod 128, and another end portion 150 of the spring 112 may be attached to the rod 166. In some cases, the rod 128 and the rod 166 may be located such that the spring 112 extends longitudinally past the pivot fasteners 122, 160. In general, the luminaire mounting system 1502 may implement an over-center spring mechanism that functions in the manner described with respect to the luminaire mounting system 102 and FIGS. 7A-8D. To illustrate, the spring 112 may bias the rotating member 114 to rotate in the rotational direction 708 (i.e., mounting direction) or in the rotational direction 706 (i.e., unengaged/disengaged direction) shown in FIGS. 7A-7D depending on the rotational position of the rotating member 114.

To illustrate, an over-center axis 1802 of the luminaire mounting system 1502 and a center axis 1804 of the spring 112 (i.e., an axis extending through the center of the spring 112) are shown in FIG. 18. For example, the over-center axis 1802 and the center axis 1804 may correspond to the over-center axis 702 of the luminaire mounting system 102 and the center axis 704, respectively, shown in FIGS. 7A-7D. When the rotating member 114 is in a rotational position where the center axis 1804 is above the over-center axis 1802 at the pivot axis 1602 (shown in FIG. 16), for example, as shown in FIG. 18, the spring 112 may bias the rotating member 114 to rotate in a unengaged direction corresponding to the rotational direction 706 shown, for example, in FIGS. 7A-7D with respect to the luminaire mounting system 102. In general, the spring 112 may bias the rotating member 114 to rotate to different rotational positions including those corresponding to the rotational positions shown in FIGS. 7B, 8A, and 8B. For example, the rotational position of the rotating member 114 of the luminaire mounting system 1502 in FIGS. 15A-15C and 17A-18 may be an insertion position and may correspond to the insertion position of the rotating member 114 of the luminaire mounting system 102 shown in FIGS. 7B, 8A, and 8B.

In some example embodiments, the rotating member 114 of the luminaire mounting system 1502 may be in a rotational position, where, at the pivot axis 1602 (shown in FIG. 16), the center axis 1804 of the spring 112 is below the over-center axis 1802 of the luminaire mounting system 1502, for example, as shown in FIG. 20. In general, when the center axis 1804 is below the over-center axis 1802, the spring 112 may bias the rotating member 114 to rotate in the rotational direction 708 (i.e., the mounting direction) shown in FIGS. 7A-7D to different rotational positions including those corresponding to the rotational positions of the rotating member 114 of the luminaire mounting system 102 shown in FIGS. 7C, 7D, 8C, 8D, and 9. For example, the rotational position of the rotating member 114 in FIGS. 16, 19, and 20 may correspond to the rotational position of the rotating member 114 of the luminaire mounting system 102 shown in FIG. 7D and FIG. 9. To illustrate, in the mounting position of the luminaire mounting system 1502 shown in FIGS. 16, 19, and 20 or in another mounting position, the spring 112 may bias the rotating member 114 such that the retention arm 116 exerts a clamping force against the back side of a ceiling, such the ceiling 802 of FIGS. 8A-8D and the ceiling 902 of FIG. 9, to mount the lighting device 1500 recessed in the ceiling. In general, the retention arm 116 and the trigger arm 118 of the rotating member 114 may be oriented relative to each other such that, during the installation of the lighting device 1500, the trigger arm 118 encounters (i.e., comes in contact with) a ceiling from below the ceiling after the retention arm 116 enters the device opening of the ceiling in the manner described with respect to the luminaire mounting systems 102, 104 and FIGS. 8A-9.

Referring to FIGS. 15A-22, in general, the luminaire mounting systems 1502, 1504 may be identical or substantially identical to each other. For example, the luminaire mounting system 1504 may be another instance of the luminaire mounting system 1502 and may be used, along with the luminaire mounting system 1502, to mount the lighting device 1500 recessed in a ceiling. To illustrate, in some example embodiments, the luminaire mounting system 1504 includes the spring 132, the rotating member 134, and a frame 1514. The frame 1514 of the luminaire mounting system 1504 may correspond to the frame 1512 of the luminaire mounting system 1502 and may include features described with respect to the frame 1512. To illustrate, the frame 1514 may include sidewalls and a top wall corresponding to the sidewalls 1712, 1714 and the top wall 1706, respectively, of the frame 1512. The frame 1514 may include a base 1530 that is positioned on the housing cover 1510 of the lighting device 1500 when the frame 1514 is attached to the housing cover 1510. The frame 1514 may include a housing attachment structure 1542 corresponding to the housing attachment structure 1536 of the frame 1512, where the housing attachment structure 1542 is inserted into retention slots of the housing cover 1510 to securely attach the luminaire mounting system 1504 to the housing cover 1510 of the lighting device 1500. The housing attachment structure 1542 may also be inserted into a slot 1546 of a post 1544 that may be part of the housing 1506 of the lighting device 1500.

In general, the frame 1514 may be used in place of the posts 144, 146 and the rotating member attachment structures 140, 162 of the luminaire mounting system 104 of FIGS. 1A-1E. To illustrate, the frame 1514 may serve as the rotating member attachment structure for the rotating member 134. The frame 1514 may be made and used in the same manner as the frame 1512. For example, the frame 1514 may be made from plastic using one or more methods such as injection molding, 3D printing, and/or other methods as can be readily understood by those of ordinary skill in the art with the benefit of this disclosure. Alternatively, the frame 1514 may be made from one or more other materials such metals using one or more methods such casting, milling, etc.

In some example embodiments, the spring 132 may be attached, at one end portion, to a rod 148 that is attached to the frame 1514 in the manner described with respect to the rod 128 and the frame 1512 of the luminaire mounting system 1502. To illustrate, the rod 148 may be a discrete component that gets attached to the frame 1514 or may be integrally formed with the frame 1514 as a single unit, for example, using a method such as injection molding and/or other methods. The spring 132 of the luminaire mounting system 1504 may be attached to the rotating member 134 in the manner described, for example, with respect to the luminaire mounting system 104 and FIGS. 1A-1E and 3.

In some example embodiments, the rotating member 134 of the luminaire mounting system 1504 may be pivotably attached to the frame 1514, for example, using pivot fasteners 142, 164. To illustrate, the rotating member 134 may be attached to the frame 1514 by the pivot fasteners 142, 164 to rotate about a pivot axis 1604 extending through the pivot fasteners 142, 164 and corresponding to the pivot axis 180 shown, for example, in FIG. 1E. The rotation of the rotating member 134 may be limited in one rotational direction, for example, by sections of the frame 1514 in the manner described with respect to the luminaire mounting system 1502. The stoppage structures 172, 174 may protrude from the rotating member attachment structures 140, 162, respectively.

In some example embodiments, the rotating member 134 of the luminaire mounting system 1504 may include the retention arm 136 and the trigger arm 138. As described above with respect to the luminaire mounting system 104 in FIGS. 1A-1E, the retention arm 136 and a trigger arm 138 may be at fixed locations relative to each other as the rotating member 134 rotates. The rotating member 134 may also include the rod 168 that serves as the spring attachment structure of the rotating member 134. The spring 132 may be attached to and extend between the rod 148 and the rod 168, where the rod 168 moves along with the rotation of the rotating member 134. For example, the rod 168 may be integrally formed with the rotating member 134 as a single unit or may be a discrete component that is subsequently attached to the rest of the rotating member 134.

As described above, the luminaire mounting system 1504 implements an over-center spring mechanism that functions in the manner described with respect to the luminaire mounting system 102 and FIGS. 7A-8D to mount the lighting device 1500 or another lighting device in a ceiling, such as the ceiling 802 of FIGS. 8A-8D and the ceiling 902 of FIG. 9. To illustrate, the spring 132 of the luminaire mounting system 1504 may bias the rotating member 134 to rotate in a mounting direction or in an unengaged direction depending on the rotational position of the rotating member 134 in the manner described above with respect to, for example, the luminaire mounting system 104 and FIGS. 7A-7D. In general, the spring 132 may bias the rotating member 134 to rotate to different rotational positions including those corresponding to the rotational positions shown in FIGS. 8A-9.

In some example embodiments, the spring 132 may bias the rotating member 134 to the insertion position shown in FIGS. 15A-15C. The spring 132 may also bias the rotating member 134 to remain in the insertion position shown in FIGS. 15A-15C unless an adequate force, for example, by a person is applied to rotate the rotating member 134 in an opposite direction. The spring 132 may also bias the rotating member 134 to the mounting position shown in FIG. 16 or to other mounting positions corresponding to, for example, the positions shown in FIGS. 8D and 9. In the mounting position of the luminaire mounting system 1504 shown in FIGS. 16, 19, and 20 or in another mounting position, the spring 132 may bias the rotating member 134 such that the retention arm 136 of the rotating member 134 exerts a clamping force against the back side of a ceiling, such the ceiling 802 of FIGS. 8A-8D and the ceiling 902 of FIG. 9, to mount the lighting device 1500 recessed in the ceiling. In general, the retention arm 136 and the trigger arm 138 of the rotating member 134 may be oriented relative to each other such that, during the installation of the lighting device 1500, the trigger arm 138 encounters (i.e., comes in contact with) a ceiling from below the ceiling after the retention arm 136 enters the device opening of the ceiling in the manner described with respect to the luminaire mounting systems 102, 104 and FIGS. 8A-9.

In some example embodiments, the lighting device 1500, if already mounted recessed in a ceiling, may be removed from the ceiling in the manner described about with respect to the lighting device 100, the luminaire mounting systems 102, 104, and FIGS. 10A and 10B. In general, a person may pull down on the lighting device 1500 to remove the lighting device 1500 from a ceiling without the need to manually access and/or disconnect luminaire mounting components that are typically hidden behind the ceiling. The retention arm 116 and the trigger arm 118 of the rotating member 114 may be oriented relative to each other such that, during the uninstallation of the lighting device 1500 from a ceiling, the retention arm 116 passes through the device opening of the ceiling after the trigger arm 118 in the manner described with respect to the luminaire mounting systems 102, 104 and FIGS. 10A and 10B. The retention arm 136 and the trigger arm 138 of the rotating member 134 may be oriented relative to each other such that, during the uninstallation of the lighting device 1500, the retention arm 136 passes through the device opening of the ceiling after the trigger arm 138 in the manner described with respect to the luminaire mounting systems 102, 104 and FIGS. 10A and 10B.

FIG. 22 shows the housing of the lighting device of FIGS. 15A-15C without the luminaire mounting systems according to another example embodiment. In FIG. 22, the luminaire mounting systems 1502, 1504 are omitted for clarity of illustration. As described above, in some example embodiments, the frame 1512 includes the housing attachment structure 1536 as shown, for example, in FIGS. 15A, 18, 21A, and 21B. The housing attachment structure 1536 may be used to securely attach the luminaire mounting system 1502 to the luminaire cover 1510.

To illustrate, in some example embodiments, the housing cover 1510 may include retention slots 2202, 2204 that may be used to attach the luminaire mounting system 1502 of FIGS. 15A-15C to the housing cover 1510. The housing attachment structure 1536 may be inserted into the retention slots 2202, 2204 to securely attach the luminaire mounting system 1502 to the lighting device 1500. For example, the housing attachment structure 1536 may be inserted into the retention slot 2202 followed by the retention slot 2204. The retention slots 2202, 2204 may be formed in the housing cover 1510 using one or more methods such as cutting, molding, welding, and/or another method as can be readily understood by those of ordinary skill in the art with the benefit of this disclosure.

In some example embodiments, the housing 1506 may include the post 1538 that includes the slot 1540. In addition to the retention slots 2202, 2204, the housing attachment structure 1536 may be inserted and held in the slot 1540 after being inserted into and held in the retention slots 2202, 2204.

In some example embodiments, the housing attachment structure 1536 may include a retention arm 1710 that is positioned and shaped to retain the housing attachment structure 1536 inserted in the retention slots 2202, 2204 until the housing attachment structure 1536 is intentionally removed by a person. For example, to remove the housing attachment structure 1536 from the retention slots 2202, 2204, the housing attachment structure 1536 may be pulled out of the retention slots 2202, 2204 after slightly pressing down on the housing attachment structure 1536.

As described above, in some example embodiments, the frame 1514 includes the housing attachment structure 1542 as shown, for example, in FIG. 15C. In general, the housing attachment structure 1542 may correspond to the housing attachment structure 1536 of the frame 1512. To securely attach the luminaire mounting system 1504 to the luminaire cover 1510, the housing attachment structure 1542 of the frame 1514 is inserted into retention slots 2206, 2208 of the housing cover 1510. The retention slots 2206, 2208 may be formed in the housing cover 1510 using one or more methods such as cutting, molding, welding, and/or another method as can be readily understood by those of ordinary skill in the art with the benefit of this disclosure. The housing attachment structure 1542 may also be inserted into the slot 1546 of the post 1544 that may be part of the housing 1506 of the lighting device 1500.

As described above, the luminaire mounting systems 1502, 1504 may each implement an over-center spring mechanism to mount the lighting device 1500 or another lighting device recessed in a ceiling. In general, the luminaire mounting systems 1502, 1504 can provide the same advantages described above with respect to the luminaire mounting systems 102, 104 of FIGS. 1A-10B.

In some alternative embodiments, the lighting device 1500 may be another type of lighting device than shown without departing from the scope of this disclosure. For example, the luminaire mounting systems 1502, 1504 may be used to mount lighting devices such as troffers, linear luminaires, etc. In some alternative embodiments, the lighting device 1500 may have a different shape than shown without departing from the scope of this disclosure. In some alternative embodiments, the lighting device 1500 may include one or more luminaire mounting systems in addition to the luminaire mounting systems 1502, 1504 without departing from the scope of this disclosure. In some alternative embodiments, the luminaire mounting systems 1502, 1504 may be at different locations than shown without departing from the scope of this disclosure. In some alternative embodiments, attachment mechanisms other than those described herein with respect to the lighting device 1500 may be used to attach the luminaire mounting systems 1502, 1504 to the housing 1506 and/or the housing cover 1510. In some alternative embodiments, one or more components of the luminaire mounting systems 1502, 1504 may have a different shape than shown without departing from the scope of this disclosure. For example, the frame 1512 and/or the frame 1514 may have a different shape.

In some alternative embodiments, the pivot holes 508, 510 of the rotating member 114 may be omitted, and the pivot fasteners 122, 160 may be integrally formed with the rotating member 114, where the pivot fasteners 122, 160 are inserted into the pivot hole 2102, 2104, respectively to pivotably and rotatably attach the rotating member 114 to the frame 1512. To illustrate, the frame 1512 may have enough elasticity to be pushed outwardly to insert the pivot fasteners 122, 160 that are integrally formed with rest of the rotating member 114 into the pivot hole 2102, 2104. In some alternative embodiments, the pivot hole 2102, 2104 may be omitted, and the pivot fasteners 122, 160 may be integrally formed with the frame 1512, where the pivot fasteners 122, 160 are inserted into the pivot holes 508, 510, respectively to pivotably and rotatably attach the rotating member 114 to the frame 1512. In some alternative embodiments, the pivot holes 508, 510 and/or the pivot holes 2102, 2104 of the frame 1512 may have different shapes than shown without departing from the scope of this disclosure.

In some alternative embodiments, the pivot holes of the rotating member 134 may be omitted, and the pivot fasteners 142, 164 may be integrally formed with the rotating member 134, where the pivot fasteners 142, 164 are inserted into the respective pivot hole of the rotating member 134 to pivotably and rotatably attach the rotating member 134 to the frame 1514. In some alternative embodiments, the pivot hole of the frame 1514 may be omitted, and the pivot fasteners 142, 164 may be integrally formed with the frame 1514, where the pivot fasteners 142, 164 are inserted into the respective pivot holes of the rotating member 134 to pivotably and rotatably attach the rotating member 134 to the frame 1514. In some alternative embodiments, the pivot holes of the rotating member 134 and/or the pivot holes of the frame 1514 may have different shapes than shown without departing from the scope of this disclosure.

In some alternative embodiments, the luminaire mounting systems 1502, 1504 may each be a recessed device mounting system that is used to mount a non-lighting device. In some alternative embodiments, the luminaire mounting systems 1502, 1504 may be used to mount non-lighting devices, such as speakers and fans (e.g., bathroom fans), recessed in a ceiling or another structure without departing from the scope of this disclosure. For example, the lighting device 1500 may be a non-lighting recessed device. In some alternative embodiments, the luminaire mounting systems 1502, 1504 may be used to mount lighting devices that include other components, such as speakers and fans, without departing from the scope of this disclosure.

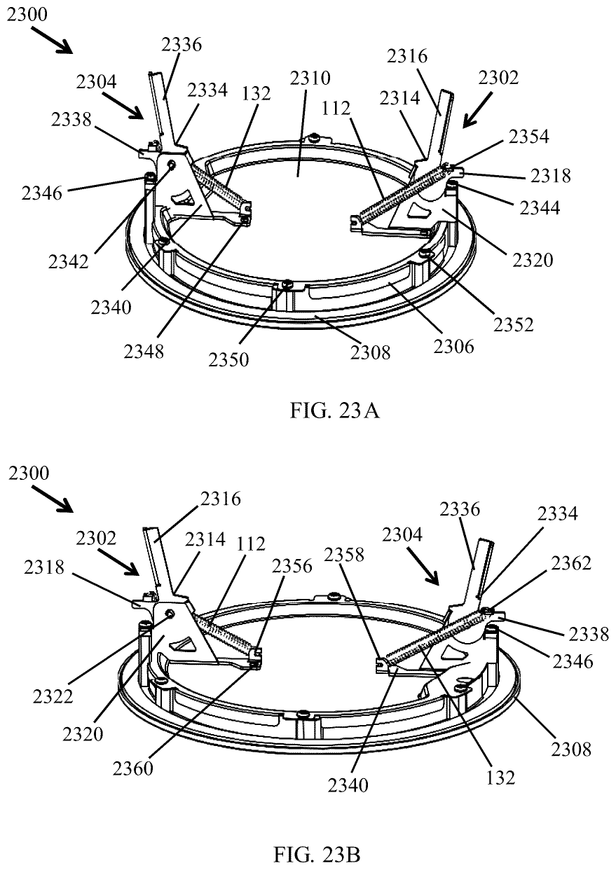

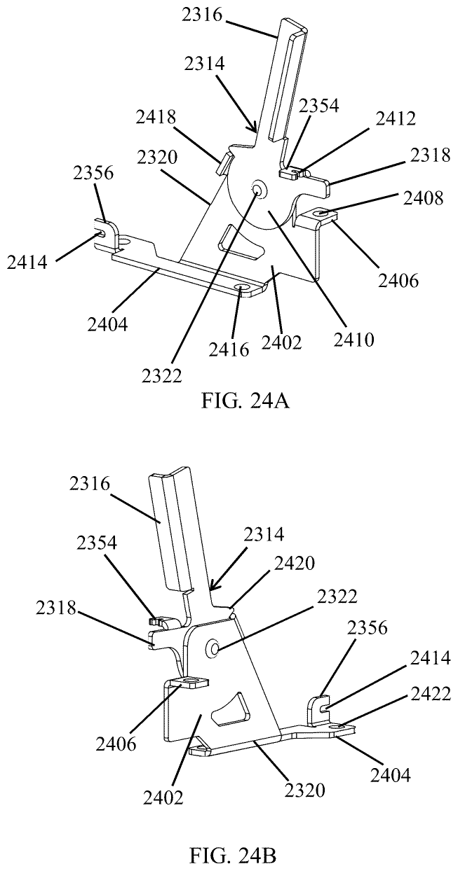

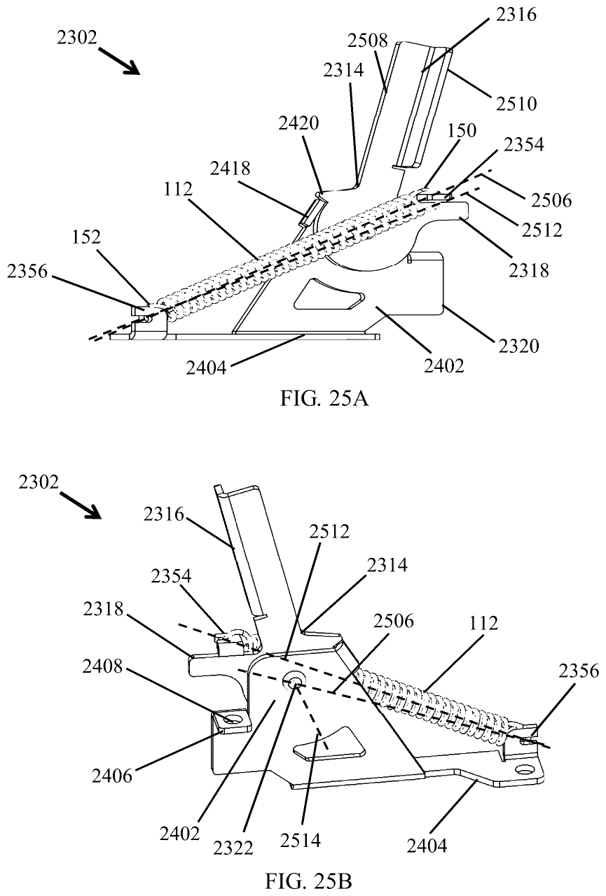

FIGS. 23A and 23B illustrate different views of a lighting device 2300 that includes luminaire mounting systems 2302, 2304 according to another example embodiment. FIGS. 24A and 24B illustrate different views of the luminaire mounting system 2302 of the lighting device 2300 of FIGS. 23A and 23B without the extension spring for clarity of illustration according to an example embodiment. FIGS. 25A and 25B illustrate different views of the luminaire mounting system 2302 of the lighting device 2300 of FIGS. 23A and 23B according to an example embodiment. Referring to FIGS. 23A-25B, in some example embodiments, the lighting device 2300 includes the luminaire mounting systems 2302, 2304 (also referred to as recessed device mounting systems) and a housing 2306. The lighting device 2300 may include a trim 2308 that may be a standalone component attached to the housing 2306 or that may be integrally formed with the housing 2306. To illustrate, when the lighting device 2300 is installed recessed in a ceiling, the trim 2308 may abut against the ceiling on the room side. The lighting device 2300 may include the housing cover 2310 that may be integrally formed with the rest of the housing 2306 or that may be attached to the housing 2302, for example, using fasteners such as screws 2350, 2352.

In some example embodiments, the luminaire mounting systems 2302, 2304 may each be a standalone device that is attached to the housing 2306 and/or the housing cover 2310 of the lighting device 2300, for example, using fasteners. In general, the luminaire mounting systems 2302, 2304 may be used to mount the lighting device 2300 or another lighting device, such as different types of luminaires, recessed in a ceiling. For example, the lighting device 2300 may be a recessed luminaire as shown in FIGS. 23A and 23B or another type of recessed luminaire. In general, the luminaire mounting systems 2302, 2304 may each implement an over-center spring mechanism that functions in a manner described with respect to the luminaire mounting systems 102, 104 and FIGS. 8A-8D to mount the lighting device 2300 or another lighting device recessed in a structure, such as the ceiling 802 of FIGS. 8A-8D and the ceiling 902 of FIG. 9.

In some example embodiments, the luminaire mounting system 2302 may include the spring 112, a rotating member 2314, and a frame 2320, and the luminaire mounting system 2304 may include the spring 132, a rotating member 2334, and a frame 2340. The rotating member 2314 may be pivotably attached to the frame 2320 using a pivot fastener 2322, and the rotating member 2334 may be pivotably attached to the frame 2340 using a pivot fastener 2342. The luminaire mounting system 2302 may be attached to the housing cover 2310 using one or more fasteners such as a screw 2360, and the luminaire mounting system 2304 may be attached to the housing cover 2310 using one or more fasteners such as a screw 2348. The luminaire mounting systems 2302, 2304 may be located on the housing cover 2310 across from each other to symmetrically mount the lighting device 2300 recessed through a device opening of a ceiling. The luminaire mounting systems 2302, 2304, as shown in FIGS. 23A-25B, are in an insertion position ready for insertion into a device opening, such as the device opening 804 of the ceiling 802 shown in FIGS. 8A-8D, during the mounting of the lighting device 2300 recessed in the ceiling.

Referring to FIGS. 23A-25B, in some example embodiments, the frame 2320 of the luminaire mounting system 2302 may include a tab 2406 that includes a fastener hole 2408, and a base section 2404 of the frame 2320 may include fastener holes 2416, 2422. A fastener 2344 (shown more clearly in FIG. 23A) may be inserted into the fastener hole 2408 and into a corresponding fastener hole in the housing 2306 to securely attach the luminaire mounting system 2302 to the housing 2306. The luminaire mounting system 2302 may be securely attached to the housing cover 2310 using fasteners that extend through the fastener holes 2416, 2422 and corresponding fastener holes in the housing cover 2310. For example, a fastener (e.g., the screw 2360) may be inserted into the fastener hole 2422 and a corresponding fastener hole in the housing cover 2310.

In some example embodiments, the frame 2320 of the luminaire mounting system 2302 may include a wall section 2402 and the base section 2404. The wall section 2402 may serve as a rotating member attachment structure for the rotating member 2314. To illustrate, the rotating member 2314 may be pivotably attached to the wall section 2402 of the frame 2320 using the pivot fastener 2322, where the rotating member 2314 is rotatable about a pivot point at the pivot fastener 2322. That is, the rotating member 2314 may be rotatable about a pivot axis 2514 extending through the pivot fastener 2322.

In some example embodiments, the rotating member 2314 may include a retention arm 2316 and a trigger arm 2318. For example, the retention arm 2316 and the trigger arm 2318 may extend out from an attachment section 2410 of the rotating member 2314 in different radial directions. The retention arm 2316 and the trigger arm 2318 may be at fixed locations relative to each other as the rotating member 2314 rotates about the pivot axis 2514.

In some example embodiments, the retention arm 2316 may include a main arm section 2508 and a clamping section 2510. For example, the main arm section 2508 may extend out from the attachment section 2410 of the rotating member 2314. The clamping section 2510 may extend from a portion of the main arm section 2508 such that a relatively larger area of the clamping section 2510, in contrast to a tipped edge, can be positioned on a ceiling when the retention arm 2316 is clamped down on the ceiling.

In some example embodiments, the rotating member 2314 may include a tab 2354 that serves as a spring attachment structure of the rotating member 2314 and that moves along with the rotating member 2314. To illustrate, the spring 112 may be attached to the tab 2354 that may include a notch 2412 that receives the end portion 150 of the spring 112. The tab 2354 may extend out from the trigger arm 2318 and/or from the attachment section 2410 of the rotating member 2314. Alternatively, the tab 2354 may extend out from another section of the rotating member 2314 without departing from the scope of this disclosure.

In some example embodiments, the rotating member 2314 may include a protrusion 2420. The protrusion 2420 along with a stoppage tab 2418 of the frame 2320 may serve to limit the rotation of the rotating member 2314 in one rotational direction that, for example, corresponds to the unengaged direction (e.g., the rotational direction 706) described above with respect to, for example, FIGS. 7A-7D. For example, the stoppage tab 2418 may extend out from the wall section 2402 of the frame 2320 such that the protrusion 2420 of the rotating member 2314 encounters the stoppage tab 2418 during a rotation in at least in one direction. To illustrate, the stoppage tab 2418 and the protrusion 2420 may help maintain the rotating member 2314 in the insertion position shown in FIGS. 23A-25B, for example, during the installation of the lighting device 2300 in a ceiling.

In some example embodiments, the frame 2320 may include a tab 2356 that extends up from the base section 2404 of the frame 2320. For example, the end portion 152 of the spring 112 may be attached to the tab 2356. The tab 2356 may include a notch 2414 to receive the end portion 152 of the spring 112. The tab 2356 may serve as a fixed spring attachment structure and may functionally correspond to, for example, the rod 128 of the luminaire mounting system 102 shown in FIGS. 1A-2.

In general, the luminaire mounting system 2302 may implement an over-center spring mechanism that functions in a manner described, for example, with respect to the luminaire mounting systems 102, 104 and FIGS. 7A-8D. As described above, the spring 112 may be attached to and between the tab 2354 and the tab 2356, where the tab 2356 serves as a fixed spring attachment structure and where the tab 2354 serves as a movable spring attachment structure. In some cases, the tab 2354 and the tab 2356 may be located such that the spring 112 extends longitudinally past the pivot fastener 2322.

To illustrate, an over-center axis 2506 of the luminaire mounting system 2302 and a center axis 2512 of the spring 112 (i.e., an axis extending through the center of the spring 112) are shown in FIGS. 25A and 25B. For example, the over-center axis 2506 and the center axis 2512 may correspond to the over-center axis 702 of the luminaire mounting system 102 and the center axis 704, respectively, shown in FIGS. 7A-7D. When the rotating member 2314 is in a rotational position where the center axis 2512 is above the over-center axis 2506 at the pivot fastener 2322 (and corresponding at the pivot axis 2514), for example, as shown in FIGS. 25A and 25B, the spring 112 may bias the rotating member 2314 to rotate in the unengaged direction corresponding to the rotational direction 706 shown, for example, in FIGS. 7A-7D with respect to the luminaire mounting system 102. In general, the spring 112 may bias the rotating member 2314 to rotate to different rotational positions including those corresponding to the rotational positions shown in FIGS. 7B, 8A, and 8B. For example, the rotational position of the rotating member 2314 of the luminaire mounting system 2302 in FIGS. 23A-25C may be an insertion position and may correspond to the insertion position of the rotating member 114 of the luminaire mounting system 102 shown in FIGS. 7B, 8A, and 8B.

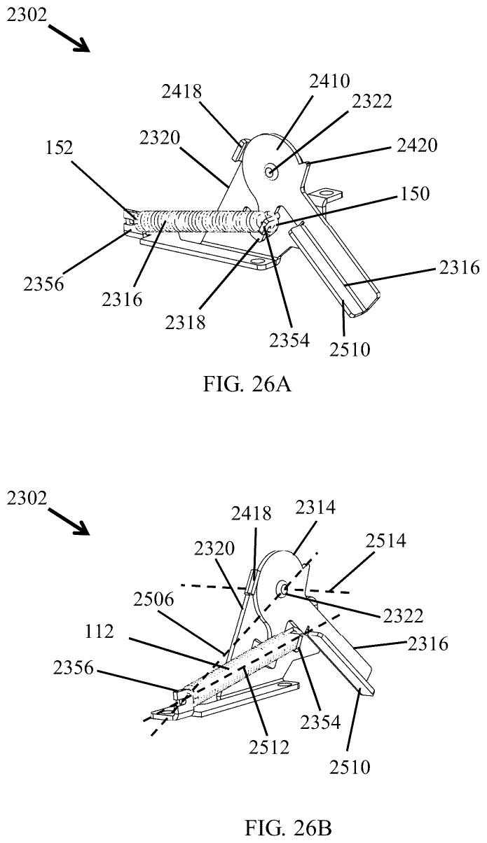

In some example embodiments, the rotating member 2314 of the luminaire mounting system 2302 may be in a rotational position, where the center axis 2512 of the spring 112 is below the over-center axis 2506 of the luminaire mounting system 2302 at the pivot fastener 2322 (equivalently, at the pivot axis 2514). For example, FIGS. 26A and 26B illustrate different views of the luminaire mounting system 2302 of the lighting device of FIGS. 23A and 23B in a mounting position according to an example embodiment. In general, when the rotating member 2314 is in a rotational position such that the center axis 2512 is below the over-center axis 2506, for example, as shown in FIGS. 26A and 26B, the spring 112 may bias the rotating member 2314 to rotate in the mounting direction corresponding to the rotational direction 708 shown in FIGS. 7A-7D.

To illustrate, the spring 112 may bias the rotating member 2314 to rotate in the mounting direction to different rotational positions including those corresponding to the rotational positions of the rotating member 114 of the luminaire mounting system 102 shown in FIGS. 7C, 7D, 8C, 8D, and 9. For example, the rotational position of the rotating member 2314 in FIGS. 26A and 26B may correspond to the rotational position of the rotating member 114 of the luminaire mounting system 102 shown in FIG. 7D and FIG. 9. To illustrate, in the mounting position of the luminaire mounting system 2302 shown in FIGS. 26A and 26B or in another mounting position, the spring 112 may bias the rotating member 2314 such that the retention arm 2316 exerts a clamping force against the back side of a ceiling, such the ceiling 802 of FIGS. 8A-8D and the ceiling 902 of FIG. 9, to mount the lighting device 2300 recessed in the ceiling.

In general, the retention arm 2316 and the trigger arm 2318 of the rotating member 2314 may be oriented relative to each other such that, during the installation of the lighting device 2300, the trigger arm 2318 encounters (i.e., comes in contact with) a ceiling from below the ceiling after the retention arm 2316 enters the device opening of the ceiling in the manner described with respect to the luminaire mounting systems 102, 104 and FIGS. 8A-9. The retention arm 2316 and the trigger arm 2318 of the rotating member 2314 may be oriented relative to each other such that, during the uninstallation of the lighting device 2300 from a ceiling, the retention arm 2316 passes through the device opening of the ceiling after the trigger arm 2318 in the manner described with respect to the luminaire mounting systems 102, 104 and FIGS. 10A and 10B.

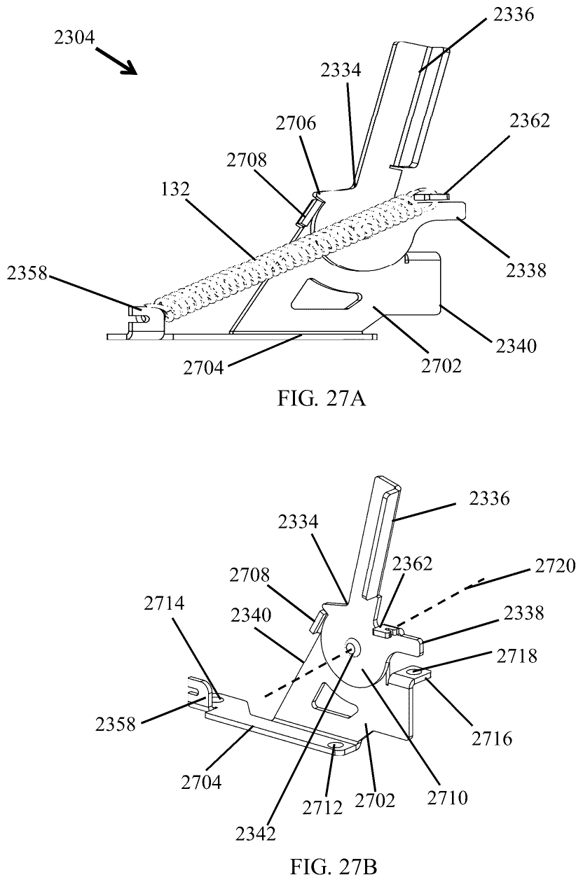

FIGS. 27A and 27B illustrate the luminaire mounting system 2304 of the lighting device of FIGS. 23A and 23B with and without the extension spring 132 according to an example embodiment. The luminaire mounting system 2304 is shown without the spring in FIG. 27B for clarity of illustration. Referring to FIGS. 23A, 23B, 27A, and 27B, in some example embodiments, the luminaire mounting systems 2302, 2304 may be identical or substantially identical to each other and may operate in the same or substantially the same manner. For example, the luminaire mounting system 2304 may be another instance of the luminaire mounting system 2302. To illustrate, the luminaire mounting system 2304 may include the spring 132, the rotating member 2334, and the frame 2340, and the spring 132, the rotating member 2334, and the frame 23 may correspond to the spring 112, the rotating member 2314, and the frame 2320, respectively, of the luminaire mounting system 2302.

In some example embodiments, the frame 2340 of the luminaire mounting system 2304 may include a tab 2716 that includes a fastener hole 2718, and a base section 2704 of the frame 2340 may include fastener holes 2712, 2714. A fastener 2346 (shown more clearly in FIG. 23A) may be inserted into the fastener hole 2718 and into a corresponding fastener hole in the housing 2306 to securely attach the luminaire mounting system 2304 to the housing 2306. The luminaire mounting system 2304 may be securely attached to the housing cover 2310 using fasteners that extend through the fastener holes 2712, 2714 and corresponding fastener holes in the housing cover 2310. For example, a fastener (e.g., the screw 2348) may be inserted into the fastener hole 2714 and a corresponding fastener hole in the housing cover 2310.

In some example embodiments, the frame 2340 of the luminaire mounting system 2304 may include a wall section 2702 and the base section 2704. The wall section 2702 may serve as a rotating member attachment structure for the rotating member 2334 of the luminaire mounting system 2304. To illustrate, the rotating member 2334 may be pivotably attached to the wall section 2702 of the frame 2340 using the pivot fastener 2342, where the rotating member 2334 is rotatable about a pivot point at the pivot fastener 2342. That is, the rotating member 2334 may be rotatable about a pivot axis 2720 extending through the pivot fastener 2342.

In some example embodiments, the rotating member 2334 may include a retention arm 2336 and a trigger arm 2338. For example, the retention arm 2336 and the trigger arm 2338 may extend out from an attachment section 2710 of the rotating member 2334 in different radial directions. The retention arm 2336 and the trigger arm 2338 may be at fixed locations relative to each other as the rotating member 2334 rotates about the pivot axis 2720.

In some example embodiments, the rotating member 2334 may include a tab 2362 that serves as a spring attachment structure of the rotating member 2334 and that moves along with the rotating member 2334. The tab 2362 may extend out from the trigger arm 2338 and/or from the attachment section 2710 of the rotating member 2334. Alternatively, the tab 2362 may extend out from another section of the rotating member 2334 without departing from the scope of this disclosure.

In some example embodiments, the rotating member 2334 may include a protrusion 2706. The protrusion 2706 along with a stoppage tab 2708 of the frame 2340 may serve to limit the rotation of the rotating member 2334 in one rotational direction that, for example, corresponds to the unengaged direction (e.g., the rotational direction 710) described above with respect to, for example, FIGS. 7A-7D. For example, the stoppage tab 2708 may extend out from the wall section 2702 of the frame 2340 such that the protrusion 2706 of the rotating member 2334 encounters the stoppage tab 2708 during a rotation in at least in one direction. To illustrate, the stoppage tab 2708 and the protrusion 2706 may help maintain the rotating member 2334 in the insertion position shown in FIGS. 23A-25B, for example, during the installation of the lighting device 2300 in a ceiling.

In some example embodiments, the frame 2320 may include a tab 2358 that extends up from the base section 2704 of the frame 2340. For example, an end portion of the spring 132 may be attached to the tab 2358. The tab 2358 may serve as a fixed spring attachment structure and may functionally correspond to, for example, the rod 128 of the luminaire mounting system 102 shown in FIGS. 1A-2.

In general, the luminaire mounting system 2304 may implement an over-center spring mechanism that functions in a manner described, for example, with respect to the luminaire mounting systems 102, 104 and FIGS. 7A-8D. The spring 132 may be attached to and between the tab 2362 and the tab 2358, where the tab 2358 serves as a fixed spring attachment structure and where the tab 2362 serves as a moveable spring attachment structure. In some cases, the tab 2362 and the tab 2358 may be located such that the spring 132 extends longitudinally past the pivot fastener 2342.

In some example embodiments, the spring 132 of the luminaire mounting system 2304 may bias the rotating member 2334 to rotate in a mounting direction or in an unengaged direction depending on the rotational position of the rotating member 2334 in the manner described above with respect to, for example, the luminaire mounting system 104 and FIGS. 7A-7D. In general, the spring 132 may bias the rotating member 2334 to rotate to different rotational positions including those corresponding to the rotational positions shown in FIGS. 8A-9.

In some example embodiments, the spring 132 may bias the rotating member 134 to the insertion position shown in FIGS. 23A and 23B. The spring 132 may also bias the rotating member 134 to remain in the insertion position shown in 23A and 23B unless an adequate force, for example, by a person is applied to rotate the rotating member 2334 in an opposite direction (i.e., the mounting direction).

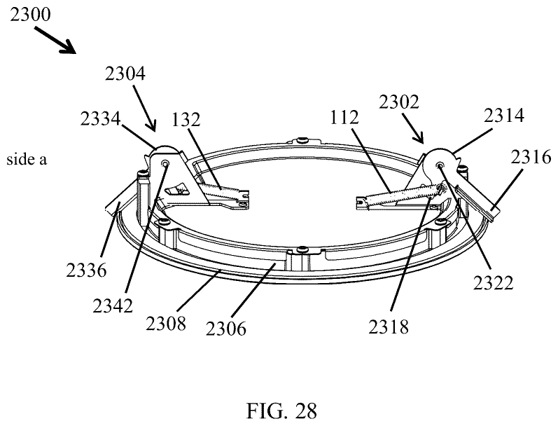

FIG. 28 illustrates the luminaire mounting systems 2302, 2304 of FIGS. 23A and 23B in a mounting position according to an example embodiment. Referring to FIGS. 23A, 23B, and 28, in some example embodiments, in the mounting position of the luminaire mounting system 2302 shown in FIG. 28 or in another mounting position, the spring 112 of the luminaire mounting system 2302 may bias the rotating member 2314 such that the retention arm 2316 exerts a clamping force against the back side of a ceiling, such the ceiling 802 of FIGS. 8A-8D and the ceiling 902 of FIG. 9, to mount the lighting device 2300 recessed in the ceiling.

In some example embodiments, in the mounting position of the luminaire mounting system 2304 shown in FIG. 28 or in another mounting position, the spring 132 of the luminaire mounting system 2304 may bias the rotating member 2334 to the mounting position shown in FIG. 28 or to other mounting positions corresponding to, for example, the positions shown in FIGS. 8D and 9. In the mounting position of the luminaire mounting system 2304 shown in FIG. 28 or in another mounting position, the spring 132 may bias the rotating member 2334 such that the retention arm 2336 of the rotating member 2334 exerts a clamping force against the back side of a ceiling, such the ceiling 802 of FIGS. 8A-8D and the ceiling 902 of FIG. 9, to mount the lighting device 2300 recessed in the ceiling.

In general, the retention arm 2336 and the trigger arm 2338 may be oriented relative to each other such that, during the installation of the lighting device 2300, the trigger arm 2338 encounters (i.e., comes in contact with) a ceiling from below the ceiling after the retention arm 2336 enters the device opening of the ceiling in the manner described with respect to the luminaire mounting systems 102, 104 and FIGS. 8A-9.

In some example embodiments, the lighting device 2300, if already mounted recessed in a ceiling, may be removed from the ceiling in the manner described about with respect to the lighting device 100, the luminaire mounting systems 102, 104, and FIGS. 10A and 10B. In general, a person may pull down on the lighting device 2300 to remove the lighting device 2300 from a ceiling without the need to manually access and/or disconnect luminaire mounting components that are typically hidden behind the ceiling.

In some example embodiments, the retention arm 2316 and the trigger arm 2318 of the rotating member 2314 may be oriented relative to each other such that, during the uninstallation of the lighting device 2300 from a ceiling, the retention arm 2316 passes through the device opening of the ceiling after the trigger arm 2318 in the manner described with respect to the luminaire mounting systems 102, 104 and FIGS. 10A and 10B.

In some example embodiments, the retention arm 2336 and the trigger arm 2338 may be oriented relative to each other such that, during the uninstallation of the lighting device 2300 from a ceiling, the retention arm 2336 passes through the device opening of the ceiling after the trigger arm 2338 in the manner described with respect to the luminaire mounting systems 102, 104 and FIGS. 10A and 10B.

Referring to FIGS. 23A-28, the housing 2306 may be made from sheet metal (e.g., aluminum) using methods such as stamping, bending, cutting, milling, and/or other methods. Alternatively, the housing 2306 may be made from plastic using methods such as injection molding, 3D printing, and/or other methods as can be readily understood by those of ordinary skill in the art with the benefit of this disclosure. The housing cover 2310 may be made from sheet metal (e.g., aluminum) using methods such as stamping, bending, cutting, milling, and/or other methods. Alternatively, the housing cover 2310 may be made from plastic using methods such as injection molding, 3D printing, and/or other methods as can be readily understood by those of ordinary skill in the art with the benefit of this disclosure.

In some example embodiments, the rotating members 2314, 2334 and the frames 2320, 2340 may be made from sheet metal using methods such as stamping, bending, cutting, milling, and/or other methods. Alternatively, the rotating members 2314, 2334 and the frames 2320, 2340 may be made from plastic using methods such as injection molding, 3D printing, and/or other methods as can be readily understood by those of ordinary skill in the art with the benefit of this disclosure. The springs 112, 132 may be made, for example, from one or more types of steel such as spring steel.

In general, the luminaire mounting systems 2302, 2304 may be used to mount different lighting devices including different types of recessed luminaires, troffers, linear luminaires, etc. The luminaire mounting systems 2302, 2304 may be used to mount the lighting device 2300 or other lighting devices in ceilings of various thickness including ⅜-inch ceilings, 1.5-inch ceilings, and other ceilings that may be thinner than ⅜ inch or thicker than 1.5 inch.

In general, the luminaire mounting systems 2302, 2304 can provide the same advantages described above with respect to the luminaire mounting systems 102, 104 of FIGS. 1A-10B. In some example embodiments, the luminaire mounting systems 2302, 2304 may each be used instead of the luminaire mounting system 1100. In some example embodiments, the luminaire mounting systems 2302, 2304 may be used instead of the luminaire mounting systems 1502, 1504, respectively.

In some alternative embodiments, some of the components of the luminaire mounting system 2302 may be different from the corresponding components of the luminaire mounting system 2304 without departing from the scope of this disclosure. For example, the springs 112, 132 may have one or more parameters that are different from each other without departing from the scope of this disclosure. In some alternative embodiments, one or more components of the luminaire mounting systems 2302, 2304 may have a different shape than shown without departing from the scope of this disclosure. For example, the rotating members 2314, 2334 may each have a different shape than shown. To illustrate, the retention arm 2316 and the trigger arm 2318 may be at different locations than shown without departing from the scope of this disclosure, and the retention arm 2336 and the trigger arm 2338 may be at different locations than shown without departing from the scope of this disclosure. In some alternative embodiments, one or more components of the luminaire mounting systems 2302, 2304 may be omitted or replaced without departing from the scope of this disclosure.

Although the springs 112, 132 are shown and described as extension springs, in some alternative embodiments, compression springs, leaf springs, or other types of springs may instead be used in luminaire mounting systems 2302, 2304 without departing from the scope of this disclosure. In some alternative embodiments, the luminaire mounting systems 2302, 2304 each may include two or more springs that together operate in the manner described with respect to the springs 112, 132 without departing from the scope of this disclosure. In some example embodiments, the lengths of the springs 112, 132 may be varied to accommodate different size (e.g., diameter) luminaires and corresponding sizes of device openings of a ceiling without departing from the scope of this disclosure. In some alternative embodiments, the springs 112, 132 may be attached to the rotating members 2314, 2334, respectively, at different locations and/or different manner than shown without departing from the scope of this disclosure. In some alternative embodiments, some of the components and features elements of the luminaire mounting systems 2302, 2304 may be at different locations than shown without departing from the scope of this disclosure. In some alternative embodiments, the springs 112, 132 may be attached to other parts of the rotating members 2314, 2334, respectively, instead of or in addition to those shown without departing from the scope of this disclosure. In some alternative embodiments, the luminaire mounting systems 2302, 2304 may each be a recessed device mounting system that is used to mount a non-lighting device. In some alternative embodiments, the luminaire mounting systems 2302, 2304 may be used to mount non-lighting devices, such as speakers and fans (e.g., bathroom fans), recessed in a ceiling or another structure without departing from the scope of this disclosure. For example, the lighting device 2300 may be a non-lighting recessed device. In some alternative embodiments, the luminaire mounting systems 2302, 2304 may be used to mount lighting devices that include other components, such as speakers and fans, without departing from the scope of this disclosure.

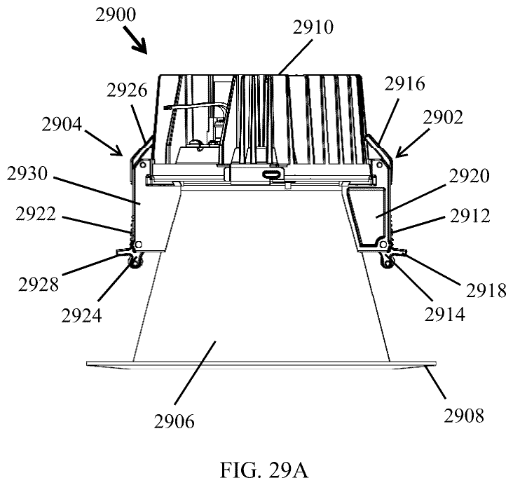

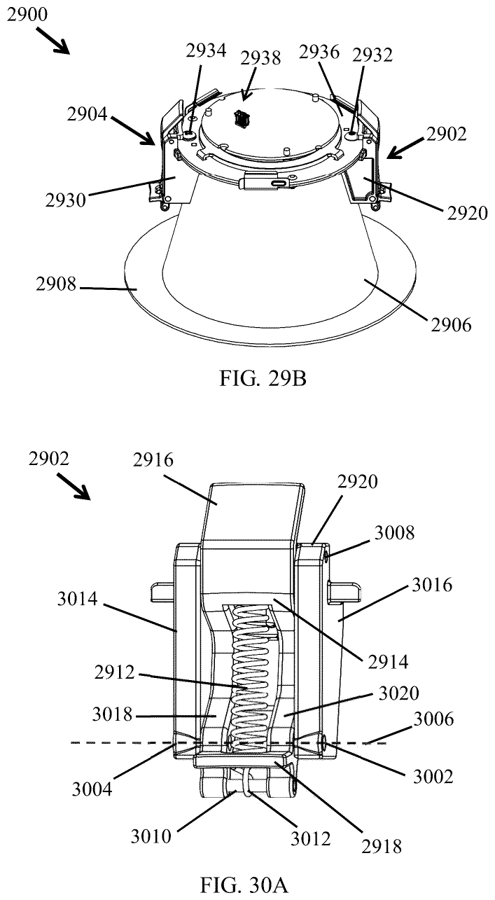

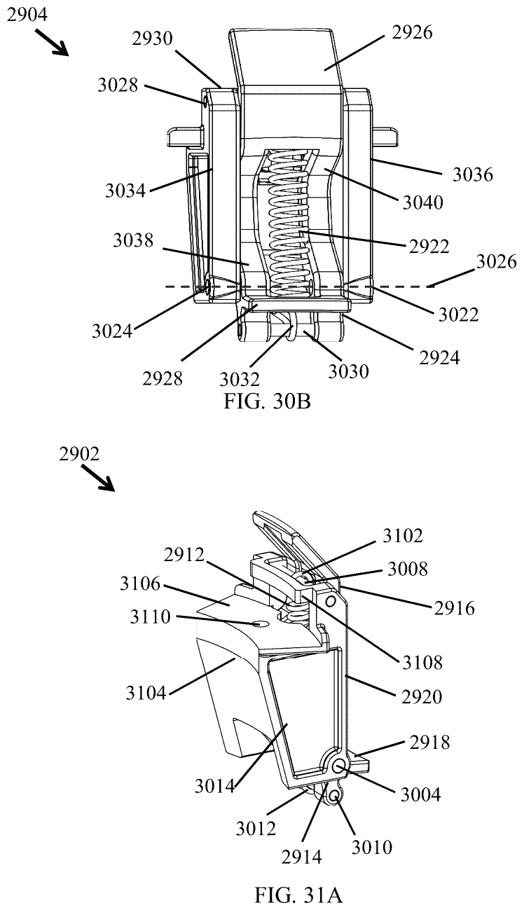

FIGS. 29A and 29B illustrate a lighting device 2900 that includes luminaire mounting systems 2902, 2904 according to another example embodiment, and FIGS. 30A and 30B illustrate the luminaire mounting systems 2902, 2904 of the lighting device 2900 of FIG. 29A without with the heat sink omitted for clarity of illustration according to an example embodiment. Referring to FIGS. 29A-30B, in some example embodiments, the lighting device 2900 includes the luminaire mounting systems 2902, 2904 (also referred to as recessed device mounting systems) and a housing 2906 that may be generally cone-shaped. The lighting device 2900 may include a trim 2908 that may be a standalone component attached to the housing 2906 or that may be integrally formed with the housing 2906. To illustrate, when the lighting device 2900 is installed recessed in a ceiling, the trim 2908 may abut against the ceiling on the room side. The lighting device 2900 may include a heat sink 2910 that may be attached to the housing 2906. For example, the heat sink 2910 may be attached to a top flange 2936 of the housing 2906. To illustrate, the top flange 2936 may extend outwardly from the rest of the housing 2906 at a top end of the housing 2906. The top flange 2936 may be integrally formed with the rest of the housing 2906 or that may be attached to the housing 2906, for example, using fasteners. The lighting device 2900 may include a light engine 2938 (e.g., LED light engine) that may provide the light provided by the lighting device 2900. In FIGS. 29A-30B, the luminaire mounting systems 2902, 2904 are shown in an insertion position ready for insertion into a device opening of a ceiling, such as the device opening 804 of the ceiling 802 shown in FIGS. 8A-8D, during the mounting of the lighting device 2900 recessed in the ceiling.

In some example embodiments, the luminaire mounting systems 2902, 2904 may each be a standalone device that is attached to the housing 2906, for example, using fasteners. For example, the luminaire mounting system 2902 may be securely attached to the top flange 2936 by a fastener 2932, and the luminaire mounting system 2904 may be securely attached to the top flange 2936 by a fastener 2934. The luminaire mounting systems 2902, 2904 may be located diametrically across the housing 2906 from each other to symmetrically mount the lighting device 2900 recessed through a device opening of a ceiling. The luminaire mounting systems 2902, 2904 may be primarily located on lateral sides of the housing 2906.

In general, the luminaire mounting systems 2902, 2904 may be used to mount the lighting device 2900 or another lighting device, such as different types of luminaires, recessed in a ceiling. For example, the lighting device 2900 may be a recessed luminaire as shown in FIG. 29A or another type of recessed luminaire. The luminaire mounting systems 2902, 2904 may each implement an over-center spring mechanism that functions, for example, in a manner described with respect to the luminaire mounting systems 102, 104 and FIGS. 8A-8D to mount the lighting device 2900 or another lighting device recessed in a structure, such as the ceiling 802 of FIGS. 8A-8D and the ceiling 902 of FIG. 9.

In some example embodiments, the luminaire mounting system 2902 may include a spring 2912, a rotating member 2914, and a frame 2920. For example, the spring 2912 may be an extension spring. For example, the spring 112 may be an extension spring. The frame 2920 may include sidewalls 3014, 3016. The rotating member 2914 may be pivotably attached to the frame 2920, for example, using pivot fasteners 3002, 3004. The rotating member 2914 may be attached to the frame 2920 such that the rotating member 2914 is rotatable relative to the frame 2920. For example, the rotating member 2914 may be pivotably attached to the sidewalls 3014, 3016 using the pivot fasteners 3002, 3004, respectively, for example, proximal to an end (e.g., bottom end) area of the frame 2920. To illustrate, the rotating member 2914 may be attached to the frame 2920 to rotate about a pivot axis 3006 extending through the pivot fasteners 3002, 3004. In some cases, the rotation of the rotating member 2914 may be limited in one or two rotational directions, for example, by a structure such as a section of the frame 2920 and/or by the housing 2906.

In some example embodiments, the rotating member 2914 may include a retention arm 2916 and a trigger arm 2918. The rotating member 2914 may include branch sections 3018, 3020, where the retention arm 2916 may include a portion of each one of the branch sections 3018, 3020 and where the trigger arm 2918 may extend across the branch sections 3018, 3020. A rod 3010 that serves as a spring attachment structure of the rotating member 2914 may be attached to the rotating member 2914. The rod 3010 may be attached to and extend between the branch sections 3018, 3020. The rod 3010 may be attached to the rotating member 2914 such that the rod 3010 is moveable along with the rotation of the rotating member 2914. The rod 3010 may be integrally formed with the branch sections 3018, 3020 or may be a discrete component that is attached to the branch sections 3018, 3020.

In some example embodiments, the spring 2912 may be attached to and extend between a rod 3008 and the rod 3010. That is, the spring 2912 may be attached to a fixed structure and to a pivoting structure. To illustrate, the rod 3008 may be attached to the frame 2920 and may serve as a fixed spring attachment structure for the spring 2912. The rod 3010 may move along with the rotation of the rotating member 2914 and may serve as a moveable spring attachment structure for the spring 2912. For example, an end portion 3012 of the spring 2912 may be attached to the rod 3010, and another end portion of the spring 2912 may be attached to the rod 3008. In general, the spring 2912 is attached to the rod 3008 and to the rod 3010 such that luminaire mounting system 2902 implements an over-center spring mechanism described, for example, with respect to FIGS. 7A-7D. In some cases, the rod 3008 and the rod 3010 may be located such that the spring 2912 extends longitudinally past the pivot fasteners 3002, 3004 or equivalently, past the pivot axis 3006.

In some example embodiments, the luminaire mounting system 2904 may include a spring 2922. For example, the spring 2922 may be an extension spring. The spring 2922 may have the same parameters as the spring 2912. To illustrate, the spring 2912 of the luminaire mounting system 2902 and the spring 2922 of the luminaire mounting system 2904 may each have a spring rate, a length, and/or other parameter values that are adequate for the luminaire mounting systems 2902, 2904 to mount the lighting device 2900 recessed in the ceiling 802 or in another ceiling. For example, the springs 112, 132 may have a respective spring rate and a respective length that enable the luminaire mounting systems 2902, 2904 to support, for example, at four times the weight of a lighting device 2900. Alternatively, the luminaire mounting systems 2902, 2904 may support more or less than four times the weight of a lighting device 2900 without departing from the scope of this disclosure. In some example embodiments, the springs 2912, 2922 may be equivalent to the springs 112, 132 of the luminaire mounting systems 102, 104, respectively, of FIGS. 1A-1E.

Referring to FIGS. 29A-30B, in some example embodiments, the luminaire mounting system 2904 may include a rotating member 2924 and a frame 2930. In some example embodiments, the frame 2930 of the luminaire mounting system 2904 may include sidewalls 3034, 3036. The rotating member 2924 may be pivotably attached to the frame 2930, for example, using pivot fasteners 3022, 3024. The rotating member 2924 may be attached to the frame 2930 such that the rotating member 2924 is rotatable relative to the frame 2930. For example, the rotating member 2924 may be pivotably attached to the sidewalls 3034, 3036 using the pivot fasteners 3022, 3024, respectively, for example, proximal to an end (e.g., bottom end) area of the frame 2930. To illustrate, the rotating member 2924 may be attached to the frame 2930 to rotate about a pivot axis 3026 extending through the pivot fasteners 3022, 3024. In some cases, the rotation of the rotating member 2924 may be limited in one or two rotational directions, for example, by a structure such as a section of the frame 2930 and/or by the housing 2906.

In some example embodiments, the rotating member 2924 may include a retention arm 2926 and a trigger arm 2928. The rotating member 2924 may include branch sections 3038, 3040, where the retention arm 2926 may include a portion of each one of the branch sections 3038, 3040 and where the trigger arm 2918 may extend across the branch sections 3038, 3040. A rod 3030 that serves as a spring attachment structure of the rotating member 2924 may be attached to the rotating member 2924. The rod 3030 may be attached to and extend between the branch sections 3038, 3040. The rod 3030 may be attached to the rotating member 2924 such that the rod 3030 is moveable along with the rotation of the rotating member 2924. The rod 3030 may be integrally formed with the branch sections 3038, 3040 or may be a discrete component that is attached to the branch sections 3038, 3040.

In some example embodiments, the spring 2922 may be attached to and extend between a rod 3028 and the rod 3030. That is, the spring 2922 may be attached to a fixed structure and to a pivoting structure. To illustrate, the rod 3028 may be attached to the frame 2930 and may serve as a fixed spring attachment structure for the spring 2922. The rod 3030 may move along with the rotation of the rotating member 2924 and may serve as a moveable spring attachment structure for the spring 2922. For example, an end portion 3032 of the spring 2922 may be attached to the rod 3030, and another end portion of the spring 2922 may be attached to the rod 3028. In general, the spring 2922 is attached to the rod 3028 and to the rod 3030 such that luminaire mounting system 2904 implements an over-center spring mechanism described, for example, with respect to FIGS. 7A-7D. In some cases, the rod 3028 and the rod 3030 may be located such that the spring 2922 extends longitudinally past the pivot fasteners 3022, 3024 or equivalently, past the pivot axis 3006.

In some example embodiments, the housing 2906 may be made from metal (e.g., aluminum) using methods such as stamping, bending, cutting, milling, and/or other methods. Alternatively, the housing 2906 may be made from plastic using methods such as injection molding, 3D printing, and/or other methods as can be readily understood by those of ordinary skill in the art with the benefit of this disclosure.

In some example embodiments, the rotating members 2914, 2924, the frames 2920, 2930, and the rods 3008, 3010, 3028, 3030 may be made from metal using methods such as casting, stamping, bending, cutting, milling, and/or other methods. Alternatively, the rotating members 2914, 2924, the frames 2920, 2930, and the rods 3008, 3010, 3028, 3030 may be made from plastic using methods such as injection molding, 3D printing, and/or other methods as can be readily understood by those of ordinary skill in the art with the benefit of this disclosure. The springs 2912, 2922 may be made, for example, from one or more types of steel such as spring steel. In some example embodiments, the rod 3008 may be made as discrete component and subsequently attached or may be integrally formed with the frame 2920. In some example embodiments, the rod 3028 may be made as a discrete component and subsequently attached or may be integrally formed with the frame 2930. In some example embodiments, the rod 3010 may be made as discrete component and subsequently attached or may be integrally formed with the rotating member 2914. In some example embodiments, the rod 3030 may be made as a discrete component and subsequently attached or may be integrally formed with the rotating member 2924. In some example embodiments, the pivot fasteners 3002, 3004 may each be made as a discrete component or may be integrally formed with the rotating member 2914 or with the frame 2920. In some example embodiments, the pivot fasteners 3022, 3024 may each be made as a discrete component or may be integrally formed with the rotating member 2924 or with the frame 2930.

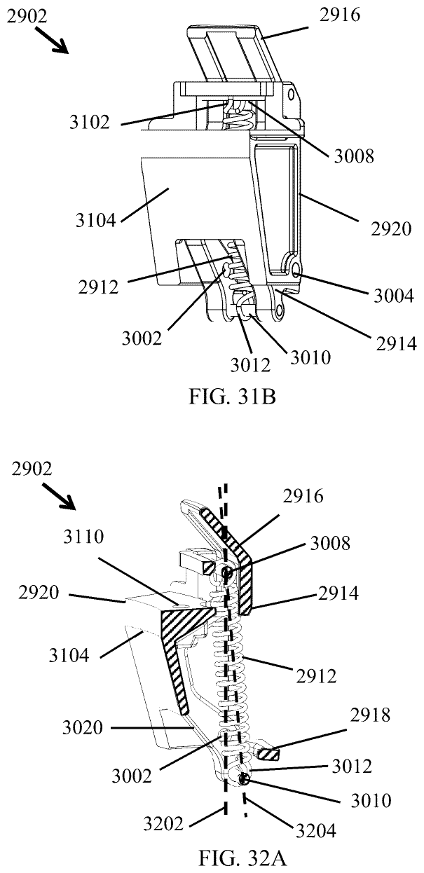

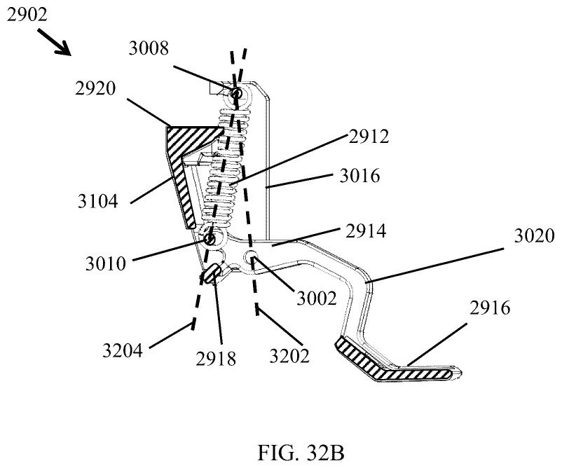

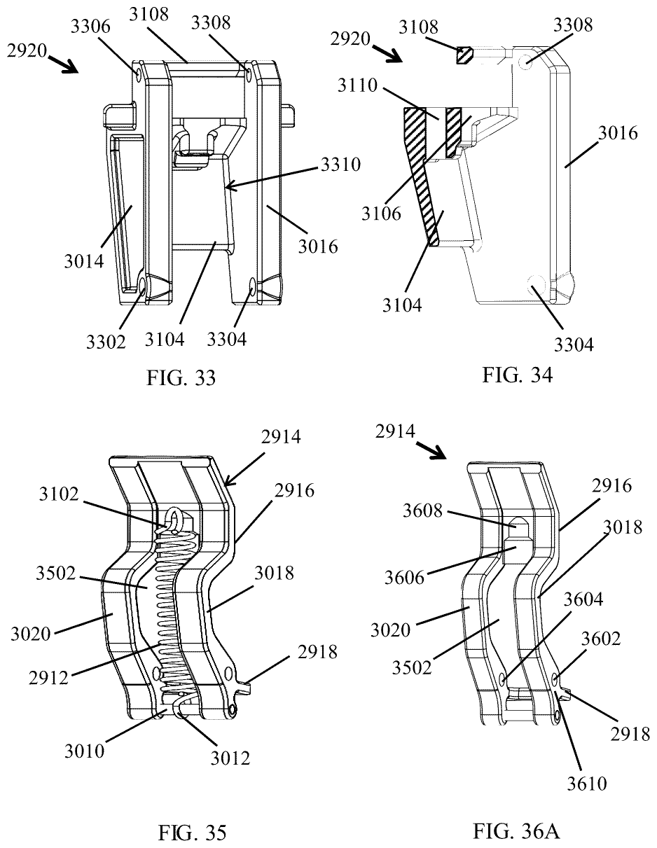

FIGS. 31A and 31B illustrate different views of the luminaire mounting system 2902 shown in FIG. 30A according to an example embodiment, FIGS. 32A and 32B illustrate cross-sectional views of a luminaire mounting system 2902 of FIGS. 31A and 31B in different rotational positions according to an example embodiment, FIG. 33 illustrates the frame 2920 of the luminaire mounting system 2902 of FIGS. 31A and 31B according to an example embodiment, and FIG. 34 illustrates a cross-sectional view of the frame 2920 shown in FIG. 33 according to an example embodiment. Referring to FIGS. 29A-30A and 31A-34, in some example embodiments, the frame 2920 includes the sidewalls 3014, 3016, a back wall 3104, and a top wall 3106. As described above, the rotating member 2914 may be pivotably attached to the sidewalls 3014, 3016 using the pivot fasteners 3002, 3004, respectively, proximal to an end (e.g., bottom end) area of the frame 2920. For example, the frame 2920 may include a pivot hole 3302 in the sidewall 3014 and a pivot hole 3304 in the sidewall 3016. The pivot holes 3302, 3304 may be located proximal to bottom end of the frame 2920. The pivot fastener 3002 may be inserted into the pivot hole 3304 and a respective hole in the rotating member 2914, and the pivot fastener 3004 may be inserted into the pivot hole 3302 and a respective hole in the rotating member 2914. The rotation of the rotating member 2914 may be limited in an unengaged direction, for example, by the spring 2912 that is positioned in a cavity 3310 of the frame 2920 defined by the sidewalls 3014, 3016, the back wall, 3104, and the top wall 3106. The rotation of the rotating member 2914 may also be limited in a mounting direction, for example, by a section of the frame 2920. Alternatively, the rotation of the rotating member 2914 may not be limited by the frame 2920 in the mounting direction.

In some example embodiments, the back wall 3104 may be shaped to conform to the shape of the relevant section of the housing 2906. For example, the back wall 3104 may be curved to conform to the curvature of the housing 2906. The back wall 3104 may also be slanted to conform to the slanted shape of the housing 2906. The frame bar 3108 may be positioned to protect the spring 2912 from damage, for example, during the attachment of the luminaire mounting system 2902 to the housing 2906.

In some example embodiments, the top wall 3106 may include a fastener hole 3110 that may be used to attach the luminaire mounting system 2902 to the housing 2906. For example, the fastener 2932 (e.g., a screw) may be extended into the fastener hole 3110 and a respective fastener hole in the top flange 2936 to securely attach the luminaire mounting system 2902 to the housing 2906. Alternatively or in addition, the luminaire mounting system 2902 may be attached to the housing 2906.

In some example embodiments, an end portion 3102 of the spring 2912 may be attached to the rod 3008, and the end portion 3012 of the spring 2912 may be attached to the rod 3010. For example, the rod 3008 may be inserted into holes 3306, 3308 of the frame 2920, where the spring 2912 extends between the rod 3008 and the rod 3010. The hole 3306 may be formed in the sidewall 3014, and the hole 3308 may be formed in the sidewall 3016. The holes 3306, 3308 may be located proximal to a top end of the frame 2920.

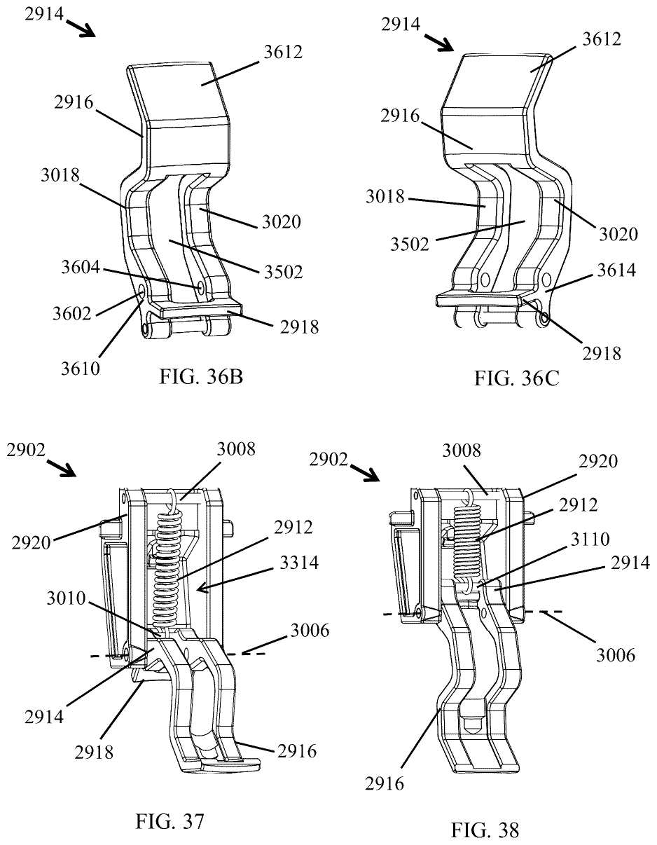

As described above, the rotating member 2914 may include the retention arm 2916 and the trigger arm 2918. FIG. 35 illustrates the rotating member 2914 and the spring 2912 of the luminaire mounting system 2902 shown in FIGS. 31A and 31B according to an example embodiment, and FIGS. 36A-36C illustrate different views of the rotating member 2914 of the luminaire mounting system 2902 shown in FIGS. 31A and 31B according to an example embodiment. Referring to FIGS. 29A-30A and 31A-36C, in some example embodiments, when the rotating member 2914 is positioned in the insertion position shown, for example, in FIG. 29A, the spring 2912 may be positioned in the cavity 3310 of the frame 2920 and at least partially in a gap 3502 between the branch sections 3018, 3020 of the rotating member 2914 as more clearly shown in FIG. 35. To illustrate, the end portion 3012 of the spring 2912 may be attached to the rod 3010 that is attached to the rotating member 2914, and a portion of the spring 2912 proximal to the end portion 3102 of the spring 2912 and the end portion 3102 may be positioned in spring positioning areas 3606 and 3608, respectively. The spring positioning areas 3606 and 3608 may be shaped to minimize damaging the spring 2912 when the retention arm 2916 is positioned against the spring 2912. As described above, the spring 2912 may serve to limit the rotation of the rotating member 2914 in the unengaged direction.

In some example embodiments, the rotating member 2914 includes an attachment hole 3602 in the branch section 3018 of the rotating member 2914. The rotating member 2914 may also include an attachment hole 3604 in the branch section 3020 of the rotating member 2914. As described above, the rotating member 2914 may be pivotably attached to the frame 2920 using the pivot fasteners 3002, 3004, respectively. The pivot fastener 3002 may be inserted into the pivot hole 3304 of the frame 2912 and into the attachment hole 3604 of the rotating member 2914, and the pivot fastener 3004 may be inserted into the pivot hole 3302 of the frame 2920 and the attachment hole 3602 of the rotating member 2914.

In some example embodiments, the branch section 3018 of the rotating member 2914 may include an attachment section 3610, and the branch section 3020 of the rotating member 2914 may include an attachment section 3614. For example, the retention arm 2916 and the trigger arm 2918 may extend out from the attachment sections 3610 and 3614, respectively, in different directions from each other. The retention arm 2916 and the trigger arm 2918 may be at fixed locations relative to each other as the rotating member 2914 rotates about the pivot axis 3006.

In some example embodiments, the retention arm 2916 may include a clamping section 3612, for example, proximal to an end portion of the retention arm 2916. In general, the rotating member 2914 is shaped such that a relatively larger surface area of the clamping section 3612, in contrast to a sharp edge, comes in contact with a back side of a ceiling, which can reduce the risk of damage to the ceiling. The rotating member 2914 is also shaped to reduce interference during the insertion of the lighting device 2900 into the device opening of the ceiling.

FIG. 37 illustrates the luminaire mounting system 2902 of FIGS. 31A and 31B in a mounting position according to an example embodiment, and FIG. 38 illustrates the luminaire mounting system 2902 of FIGS. 31A and 31B in another mounting position according to an example embodiment. Referring to FIGS. 32A, 32B, 37, and 28, the spring 2912 is attached to the rod 3008 and to the rod 3010, where the luminaire mounting system 2902 implements an over-center spring mechanism. In general, the spring 2912 may bias the rotating member 2914 to rotate to different rotational positions including the rotational positions shown in FIGS. 32A, 32B, 37, and 38 depending on the rotational position of the rotating member 2914. To be clear, the rotational position of the rotating member 2914 in FIG. 32B may correspond to the rotational position of the rotating member 2914 in FIG. 37. Indeed, FIG. 32B may be a cross-sectional view of the luminaire mounting system 2902 at left-of-center of the luminaire mounting system 2902 shown in FIG. 37.

In some example embodiments, the spring 2912 biases the rotating member 2914 to rotate in a particular rotational direction depending on the rotational position of the rotating member 2914. To illustrate, an over-center axis 3202 of the luminaire mounting system 2902 and a center axis 3204 of the spring 2912 are shown in FIGS. 32A and 32B. When the rotating member 2914 is in a rotational position where the center axis 3204 is to the right (in the orientation shown in FIGS. 32A and 32B) of the over-center axis 3202 at the pivot fastener 3002 (and correspondingly at the pivot axis 3006), the spring 2912 may bias the rotating member 2914 to rotate in the unengaged direction. For example, in FIG. 32A, because the rotating member 2914 is in a rotational position where the center axis 3204 is to the right of the over-center axis 3202 at the pivot fastener 3002, the spring 2912 may bias the rotating member 2914 to rotate in the unengaged direction, which is a generally counterclockwise direction in the orientation shown in FIGS. 32A and 32B and which is also against the spring 2912 that prevents further rotation in the unengaged direction. The unengaged direction may correspond to the rotational direction 706 shown, for example, in FIGS. 7A-7D with respect to the luminaire mounting system 102. In FIG. 32A, the spring 2912 may bias the rotating member 2914 to remain in the insertion position shown in FIGS. 29A and 29B unless an adequate force is applied, for example, by a person to rotate the rotating member 2914 in the mounting direction. In general, the spring 2912 may bias the rotating member 2914 to rotate in the unengaged rotational direction to different rotational positions including those corresponding to the rotational positions shown in FIGS. 7B, 8A, 8B, 29A, and 29B.

Referring to FIGS. 32A, 32B, 37, and 28, in some example embodiments, when the rotating member 2914 is in a rotational position where the center axis 3204 is to the left (in the orientation shown in FIGS. 32A and 32B) of the over-center axis 3202 at the pivot fastener 3002, the spring 2912 may bias the rotating member 2914 to rotate in the mounting direction, which is a generally clockwise direction in the orientation shown in FIGS. 32A and 32B. To illustrate, in FIG. 32B, because the rotating member 2914 is in a rotational position where the center axis 3204 is to the left of the over-center axis 3202 at the pivot fastener 3002, the spring 2912 may bias the rotating member 2914 to rotate in the mounting direction. Indeed, because of the rotational positions of the rotating member 2914 in FIGS. 37 and 38, the spring 2912 may bias the rotating member 2914 to rotate in the mounting direction. The clamped direction may correspond to the rotational direction 708 shown, for example, in FIGS. 7A-7D with respect to the luminaire mounting system 102. In general, the spring 2912 may bias the rotating member 2914 to rotate in the mounting direction to different rotational positions including those corresponding to the rotational positions of the rotating member 114 of the luminaire mounting system 102 shown in FIGS. 7C, 7D, 8C, 8D, and 9.

In the mounting positions of the rotating member 2914 and thus, luminaire mounting system 2902, shown in FIGS. 32B, 37, 38, or in another mounting position, the spring 2912 may bias the rotating member 2914 such that the retention arm 2916 exerts a clamping force against the back side of a ceiling to mount the lighting device 2900 recessed in the ceiling.

In general, the luminaire mounting systems 2902, 2904 may be identical or substantially identical to each other and may operate in the same manner. For example, the luminaire mounting system 2904 may be another instance of the luminaire mounting system 2902 and may have the same features and may operate in the same manner as described with respect to the luminaire mounting system 2902. To illustrate, the springs 2912, 2922 may have the effectively the same parameters such as spring rate, length, etc. To the extent, the springs 2912, 2922 may have different parameters (i.e., different values of parameters), the springs 2912, 2922 still operate in the same manner as described herein. As another example, the frames 2920, 2930 may be effectively the same dimensions and features. As another example, the rotating members 2914, 2924 may effectively have the same shape, size, and other relevant parameters. As another example, the components of the luminaire mounting system 2902 may be attached to each other in the same manner as the components of the luminaire mounting system 2904.

Referring to FIGS. 29A, 29B, and 30B, in some example embodiments, the luminaire mounting system 2904 operates in the manner as the luminaire mounting system 102. In general, the spring 2922 may bias the rotating member 2924 to rotate to different rotational positions depending on the rotational position of the rotating member 2924. The spring 2922 may bias the rotating member 2924 to rotate to different rotational positions including those corresponding to the rotational positions shown in FIGS. 32A, 32B, 37, and 38.

To illustrate, in some example embodiments, the spring 2922 biases the rotating member 2924 to rotate in a particular rotational direction depending on the rotational position of the rotating member 2924. When the rotating member 2924 is in some rotational positions such as shown in FIG. 29A, the spring 2922 may bias the rotating member 2924 to rotate in the unengaged direction. In FIG. 29A, the spring 2922 may bias the rotating member 2924 to in the unengaged direction resulting in the rotating member 2924 remaining in the shown insertion position unless an adequate force is applied, for example, by a person to rotate the rotating member 2924 in the mounting direction. In general, the spring 2922 may bias the rotating member 2924 to rotate in the unengaged rotational direction to different rotational positions including those corresponding to the rotational positions shown in FIGS. 7B, 8A, 8B, 29A, and 39A.

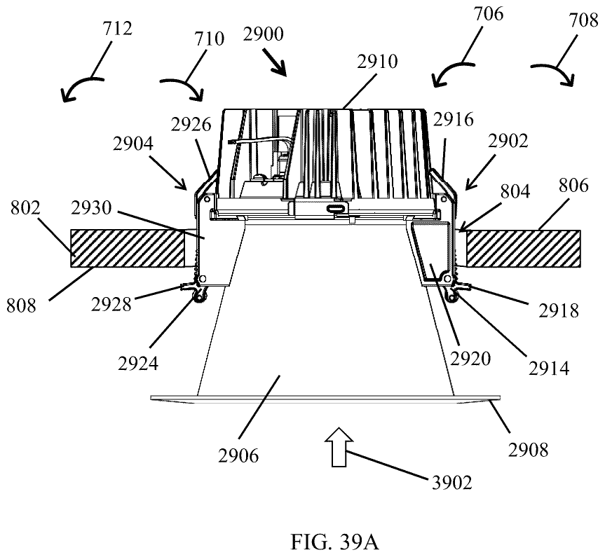

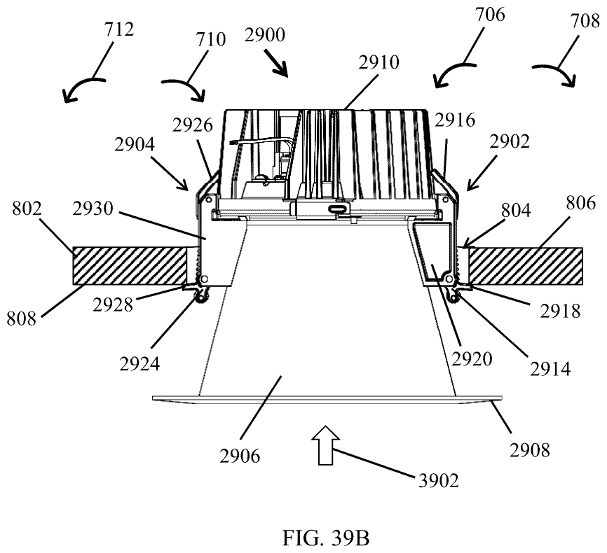

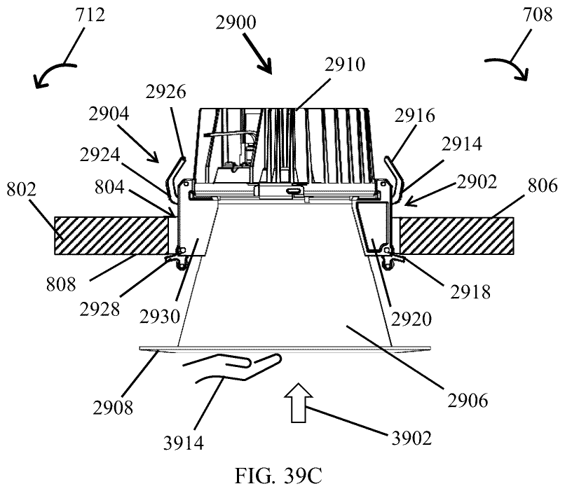

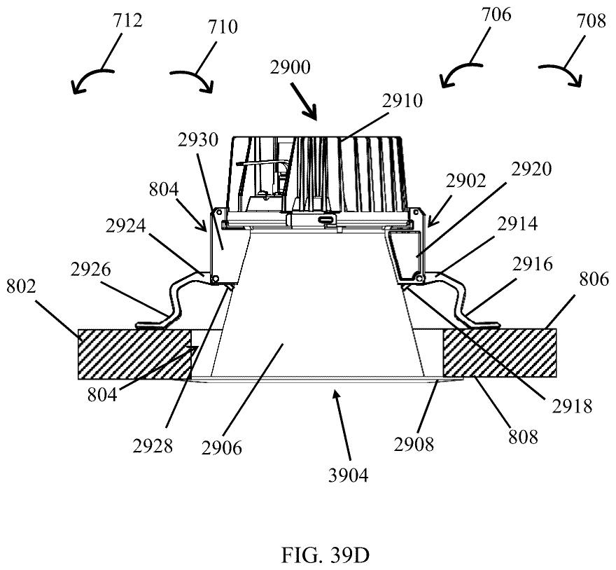

Referring to FIGS. 29A, 29B, and 30B, in some example embodiments, when the rotating member 2924 is in some rotational positions such as those corresponding to the rotational positions of the rotating member 2914 of the luminaire mounting system 2902 shown in FIGS. 32A, 32B, 37, 38, the spring 2922 may bias the rotating member 2924 to rotate in the clamped direction. In general, the spring 2922 may bias the rotating member 2924 to rotate in the clamped direction to different rotational positions including those corresponding to the rotational positions shown in FIGS. 7C, 7D, 8C, 8D, 9, 39C, and 39D. In the mounting positions of the rotating member 2924 and thus, luminaire mounting system 2902, shown in FIG. 39D, or in another mounting position, the spring 2922 may bias the rotating member 2924 such that the retention arm 2926 exerts a clamping force against the back side of a ceiling to mount the lighting device 2900 recessed in the ceiling.

Referring to FIGS. 29A-38, in general, the retention arm 2916 and the trigger arm 2918 of the rotating member 2914 may be oriented relative to each other such that, during the installation of the lighting device 2900, the trigger arm 2918 encounters (i.e., comes in contact with) a ceiling from below the ceiling after the retention arm 2916 enters the device opening of the ceiling in the manner described below with respect to FIGS. 39A-39D and, to the extent applicable, FIGS. 8A-9. The retention arm 2916 and the trigger arm 2918 of the rotating member 2914 may be oriented relative to each other such that, during the uninstallation of the lighting device 2900 from a ceiling, the retention arm 2916 passes through the device opening of the ceiling after the trigger arm 2918 in the manner described with respect to FIGS. 39A-39D, and, to the extent applicable, FIGS. 10A and 10B.

Referring to FIGS. 29A-38, in general, the retention arm 2926 and the trigger arm 2928 of the rotating member 2924 may be oriented relative to each other such that, during the installation of the lighting device 2900, the trigger arm 2928 encounters (i.e., comes in contact with) a ceiling from below the ceiling after the retention arm 2926 enters the device opening of the ceiling in the manner described below with respect to FIGS. 39A-39D and, to the extent applicable, FIGS. 8A-9. The retention arm 2926 and the trigger arm 2928 of the rotating member 2924 may be oriented relative to each other such that, during the uninstallation of the lighting device 2900 from a ceiling, the retention arm 2926 passes through the device opening of the ceiling after the trigger arm 2928 in the manner described with respect to FIGS. 39A-39D, and, to the extent applicable, FIGS. 10A and 10B.

FIGS. 39A-39D illustrate the lighting device 2900 of FIG. 29A at different stages of installation in a ceiling 802 according to an example embodiment. In general, the mounting of the lighting device 2900 recessed in the ceiling 802 is performed in the manner described with respect to the lighting device 100 and FIGS. 8A-8D. To illustrate, the lighting device 2900 is mountable recessed in the ceiling 802 by first positioning, by a person, the rotating member 2914, 2924 in insertion positions (e.g., shown in FIG. 39A), then releasing the rotating member 2914, 2924 (i.e., not manually applying a force to maintain the rotating member 2914, 2924 in the insertion positions), followed by moving/inserting the lighting device 2900 into the device opening 804 of the ceiling 802 such that the rotating member 2914, 2924 enter/are inserted into the device opening 804.

Referring to FIGS. 29A-30B and 39A-39D, in some example embodiments, the lighting device 2900 may be installed recessed in the ceiling 802. The ceiling 802 may include the device opening 804. The ceiling 802 may have the back side surface 806 and the room side surface 808. The ceiling 802 may have a thickness of, for example, ⅜ inch, 1.5 inch, or therebetween. Alternatively, the ceiling 802 may be thinner than ⅜ inch or thicker than 1.5 inch.

In some example embodiments, the frame 2920 of the luminaire mounting system 2902 and the frame 2930 of the luminaire mounting system 2902 may be positioned against the housing 2906 on opposite lateral sides of the housing 2906. To mount the lighting device 2900 in the ceiling 802 using the luminaire mounting systems 2902, 2904, the lighting device 2900 may be moved below the device opening 804 and inserted into the device opening 804 by moving the lighting device 2900 in a direction 3902. In FIG. 39A, the lighting device 2900 is shown inserted into the device opening 804, where the rotating members 2914, 2924 extend through the device opening 804. For example, the retention arms 2916, 2926 may extend through the device opening 804, and the trigger arms 2918, 2928 may be below the ceiling 802 as shown in FIG. 39A.

In FIG. 39A, the luminaire mounting systems 2902, 2904 are in an insertion position. The rotating members 2914, 2924 as shown in FIG. 39A may be in the same rotational positions shown in FIG. 29A, where the retention arm 2916 is biased by the spring 2912 to rotate in the rotational direction 706 (i.e., an unengaged direction) and where the retention arm 2926 is biased by the spring 2922 to rotate in the rotational direction 710 (i.e., an unengaged direction). For example, the rotating member 2914 may be positioned against the spring 2912 that serves as a stoppage structure preventing further rotation in the rotational direction 706, and the rotating member 2924 may be positioned against the spring 2922 that serves as a stoppage structure preventing further rotation in the rotational direction 710. Alternatively or in addition, the heat sink 2910 of the lighting device 2900 may prevent further rotations of the rotating member 2914 and the rotating member 2924 in the respective unengaged direction.

In some example embodiments, the rotating members 2914, 2924 may be rotated to the positions (i.e., insertion positions) shown in FIG. 39A by a person (e.g., an installer or a consumer) prior to the lighting device 2900 being inserted into the device opening 804. That is, the retention arm 2916 may be positioned against the spring 2912 and/or the heat sink 2910 and the retention arm 2926 may be positioned against the spring 2922 and/or the heat sink 2910 before starting to insert the rotating members 2914, 2924 into the ceiling opening 804. Because of the biasing forces of the springs 2912, 2922 on the rotating members 2914, 2924, respectively, a person does not need to apply an additional force on the rotating members 2914, 2924 to maintain the rotating members 2914, 2924 and, thus the retention arms 2916, 2926, in the insertion positions shown in FIG. 39A while inserting the lighting device 2900 into the device opening 804. In general, the rotating member 2914 may be positioned such that the retention arm 2916 can enter the device opening 804 while the trigger arm 2918 remains below the ceiling 802, and the rotating member 2924 may be positioned such that the retention arm 2926 can enter the device opening 804 while the trigger arm 2928 remains below the ceiling 802.

In some example embodiments, the lighting device 2900 may be moved more to the back side of the ceiling 802 through the device opening 804 by a person such that the trigger arms 2918, 2928 encounter (i.e., come in contact with) the ceiling 802, for example, as shown in FIG. 39B. To illustrate, starting from the position of the lighting device 2900 shown in FIG. 39A, as the lighting device 2900 is moved (e.g., pushed) further into the device opening 804 by an installer, the trigger arms 2918, 2928 may come in contact with the room side surface 808 of the ceiling 802. At the initial contact of the trigger arms 2918, 2928 with the room side surface 808 of the ceiling 802, the rotating members 2914, 2924 may be in the same positions as in FIG. 39A where the rotating members 2914, 2924 are biased by the springs 2912, 2922, respectively, to remain in the insertion positions shown in FIG. 39A.

In general, the retention arm 2916 and the trigger arm 2918 may be oriented relative to each other such that the trigger arm 2918 encounters (i.e., comes in contact with) the ceiling 802 from below the ceiling 802 after the retention arm 116 enters the device opening 804, and the retention arm 2926 and the trigger arm 2928 may be oriented relative to each other such that the trigger arm 2928 encounters (i.e., comes in contact with) the ceiling 802 from below the ceiling 802 after the retention arm 2926 enters the device opening 804. In FIGS. 39A and 39B, the rotating members 3914, 2924 and correspondingly the luminaire mounting systems 2902, 2904 are in an insertion position ready to be inserted into the device opening 804.

In some example embodiments, the lighting device 2900 may be moved by an installer further into the device opening 804 in the direction 3902 resulting in the rotating members 2914, 2924 being rotated to the positions shown in FIG. 39C. To illustrate, as the lighting device 2900 is being moved (e.g., pushed) further into the device opening 804 after the trigger arms 2918, 2928 come in contact with the room side surface 808 of the ceiling 802, the rotating members 2914, 2924 rotate in the rotational directions 708, 712 (i.e., mounting directions), respectively, to the positions shown in FIG. 39C. For example, in FIG. 39C, the rotating members 2914, 2924 may be in such rotational positions where the springs 2912, 2922 are each applying a biasing force to rotate the rotating members 2914, 2924 further in the rotational directions 708, 712, respectively. That is, in FIG. 39C where the orientation of the luminaire mounting system 2902 generally matches the orientation of the luminaire mounting system 2902 in FIGS. 32A and 32B, the center axis 3204 of the spring 2912 (shown in FIGS. 32A and 32B) may be to the left of the over-center axis 3202, for example, at the pivot axis 3006 shown in FIG. 30A. In FIG. 39C where the orientation of the luminaire mounting system 2904 generally opposite to the orientation of the luminaire mounting system 2902 in FIGS. 32A and 32B, the center axis of the spring 2922 may be positioned to the right of the over-center axis of the luminaire mounting system 2904, for example, at the pivot axis 3026 shown in FIG. 30B.

In some example embodiments, as the lighting device 2900 is pushed further into the device opening 804 from the rotational positions shown in FIG. 39C, the springs 2912, 2922 continue to bias the rotating members 2914, 2924 such that the rotating members 2914, 2924 rotate in the rotational directions 708, 712 (i.e., the respective mounting directions), respectively, to the rotational positions shown in FIG. 39D, where the retention arms 2916, 2926 are clamped down on the back side surface 806 of the ceiling 802. That is, in FIG. 39D, the rotating members 2914, 2924 and correspondingly the luminaire mounting systems 2902, 2904 are in a mounting position. For example, the positions of the rotating members 2914, 2924 in FIG. 39D may correspond to the position of the rotating member 2914 shown in FIGS. 32B and 37. In FIG. 39D, the lighting device 2900 may be fully mounted recessed in the ceiling 802 and positioned to provide a light toward the area below the ceiling 802 through a housing opening 804.

In some example embodiments, in the positions of the rotating members 2914, 2924 shown in FIG. 39D, the springs 2912, 2922 each continue to bias the rotating members 2914, 2924, respectively, such that the lighting device 2900 is mounted recessed in the ceiling 802 by the luminaire mounting systems 2902, 2904. To illustrate, the retention arms 2916, 2926 may each apply a downward force on the ceiling 802 that together may be at least, for example, four times the weight of the lighting device 2900. Alternatively, the combined downward force may be more or less than four times the weight of the lighting device 2900. As shown in FIG. 39D, the housing 2906 may be positioned in the device opening 804, and the trim 2908 may be positioned abutted against the room side surface 808 of the ceiling 802 when the lighting device 2900 is fully mounted by the luminaire mounting systems 2902, 2904.

In general, the lighting device 2900, after being installed in the ceiling 802 as shown in FIG. 39D, may be removed/uninstalled in the manner described with respect to the lighting device 100 and FIGS. 10A and 10B. To illustrate, a person may apply a downward force to remove the lighting device 2900 from the ceiling 802. For example, a person may pull down on the trim 2908 of the lighting device 2900. The downward force on the lighting device 2900 may result in the rotating members 2914, 2924 rotating in the rotational directions 706, 710 (i.e., respective unengaged directions), respectively. That is, a person may apply adequate force to overcome the biasing forces of the springs 2912, 2922 on the rotating members 2914, 2924 such that the lighting device 2900 starts moving down through the device opening 804 and the rotating members 2914, 2924 start rotating in the directions 706, 710, respectively. For example, the weight of the lighting device 2900 and a downward force applied by a person on the lighting device 2900 need to be adequate to overcome the clamping forces of the rotating members need to adequate to overcome on the ceiling 802. For example, the downward force a person needs to apply on the lighting device 2900 may be as little as a few pounds (e.g., 2 pounds, 4 pounds, 10 pounds, 20 pounds, or another value more or less than 20 pounds).

In some example embodiments, as the lighting device 2900 is pulled down, the rotating members 2914, 2924 may rotate in the directions 706, 710, respectively, back to the positions shown in FIG. 39C and may continue to rotate to the positions shown in FIG. 39B. For example, after the rotating members 2914, 2924 are rotated from the positions in FIG. 39D in the directions 706, 710, respectively, as result of the downward force by a person and the contacts between the ceiling 802 (e.g., the upper perimeter edge) and the retention arms 2916, 2926, the rotations of the rotating members 2914, 2924 may continue until the rotations are stopped by springs 2912, 2922 and/or the heat sink 2910. After the rotating members 2914, 2924 are back in the positions shown in FIG. 39A, a person may pull the lighting device 100 down to completely move the lighting device 100 out of the device opening 804 of the ceiling 802.

In general, the retention arm 2916 and the trigger arm 2918 of the luminaire mounting system 2902 may be oriented relative to each other such that, during the uninstallation/removal of the lighting device 2900 from the ceiling 802, the retention arm 2916 passes through the device opening 804 of the ceiling 802 after the trigger arm 2918 has already passed through. The retention arm 2926 and the trigger arm 2928 of the luminaire mounting system 2904 may be oriented relative to each other such that, during the uninstallation/removal of the lighting device 2900 from the ceiling 802, the retention arm 2926 passes through the device opening 804 of the ceiling 802 after the trigger arm 2928 has already passed through.

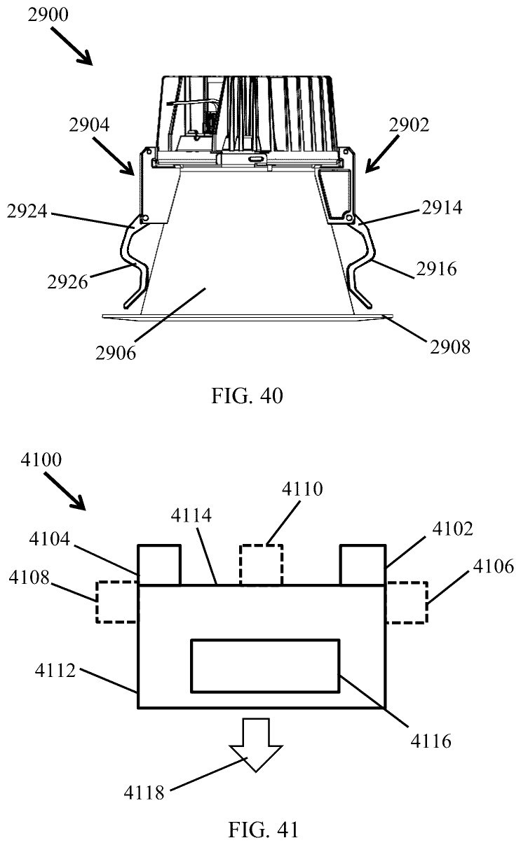

FIG. 40 illustrates the lighting device of FIG. 29A with the luminaire mounting systems 2902, 2904 in another mounting position according to an example embodiment. In FIG. 40, the lighting device 2900 is shown in a mounting position with a ceiling for clarity of illustration. In some example embodiments, the mounting positions of the rotating member 2914, 2924 may correspond to the rotational position of the luminaire mounting system 2902 shown in FIG. 38. For example, in contrast to the mounting positions of the luminaire mounting systems 2902, 2904 in FIG. 39D, the luminaire mounting systems 2902, 2904 in FIG. 40 enables the mounting of the lighting device 2900 in relative thin ceilings including ceilings than are thinner than ⅜ inch. In general, the rotating member 2914, 2924 may be rotated to different mounting positions. As shown in FIG. 40, the housing 2906 may prevent the rotation of the rotating member 2914, 2924 in the respective mounting directions.

In general, the luminaire mounting systems 2902, 2904 may be used to mount different lighting devices including different types of recessed luminaires, troffers, linear luminaires, etc. The luminaire mounting systems 2902, 2904 may be used to mount the lighting device 2900 or other lighting devices in ceilings of various thickness including ⅜-inch ceilings, 1.5-inch ceilings, and other ceilings that may be thinner than ⅜ inch or thicker than 1.5 inch. In general, the luminaire mounting systems 2902, 2904 can provide the same advantages described above with respect to the luminaire mounting systems 102, 104 of FIGS. 1A-10B.

In general, the luminaire mounting systems 2902, 2904 may be used to mount different lighting devices including different types of recessed luminaires, troffers, linear luminaires, etc. The luminaire mounting systems 2902, 2904 may be used to mount the lighting device 2900 or other lighting devices in ceilings of various thickness including ⅜-inch ceilings, 1.5-inch ceilings, and other ceilings that may be thinner than ⅜ inch or thicker than 1.5 inch. In general, the luminaire mounting systems 2902, 2904 can provide the same advantages described above with respect to the luminaire mounting systems 102, 104 of FIGS. 1A-10B.

Referring to FIGS. 29A-40, In some alternative embodiments, the lighting device 2900 may include one or more luminaire mounting systems than shown without departing from the scope of this disclosure. In some alternative embodiments, the housing 2906 may have a different shape than shown without departing from the scope of this disclosure. In some alternative embodiments, some of the components of the luminaire mounting system 2902 may be different from the corresponding components of the luminaire mounting system 2904 without departing from the scope of this disclosure. For example, the springs 2912, 2922 may have one or more parameters that are different from each other without departing from the scope of this disclosure. In some alternative embodiments, one or more components of the luminaire mounting systems 2902, 2904 may have a different shape than shown without departing from the scope of this disclosure. For example, the frames 2920, 2930 may have a different shape than shown. As yet another example, the rotating members 2914, 2924 may each have a different shape than shown. In some alternative embodiments, one or more components of the luminaire mounting systems 2902, 2904 may be omitted or replaced without departing from the scope of this disclosure.

In some alternative embodiments, the pivot fasteners may be replaced with one or more other structures without departing from the scope of this disclosure. Although the springs 2912, 2922 are shown and described as extension springs, in some alternative embodiments, compression springs, leaf springs, or other types of springs may instead be used in luminaire mounting systems 2902, 2904 without departing from the scope of this disclosure. In some alternative embodiments, the luminaire mounting systems 2902, 2904 each may include two or more springs that together operate in the manner described with respect to the springs 2912, 2922 without departing from the scope of this disclosure. In some example embodiments, the lengths of the springs 2912, 2922 may be varied to accommodate different size (e.g., diameter) luminaires and corresponding sizes of device openings of a ceiling without departing from the scope of this disclosure. In some alternative embodiments, the springs 2912, 2922 may be attached to the rotating members 2914, 2924, respectively, at different locations than shown without departing from the scope of this disclosure. In some alternative embodiments, the springs 2912, 2922 may be attached to the rotating members 2914, 2924 in a different manner than shown without departing from the scope of this disclosure. In some alternative embodiments, the springs 2912, 2922 may be attached to other elements of the rotating members 2914, 2924, respectively, instead of or in addition to those shown without departing from the scope of this disclosure. In some alternative embodiments, the luminaire mounting systems 2902, 2904 may each be a recessed device mounting system that is used to mount a non-lighting device. In some alternative embodiments, the luminaire mounting systems 2902, 2904 may be used to mount non-lighting devices, such as speakers and fans (e.g., bathroom fans), recessed in a ceiling or another structure without departing from the scope of this disclosure. For example, the lighting device 2900 may be a non-lighting recessed device. In some alternative embodiments, the luminaire mounting systems 2902, 2904 may be used to mount lighting devices that include other components, such as speakers and fans, without departing from the scope of this disclosure.

FIG. 41 illustrates a block diagram of a generic recessed device 4100 according to an example embodiment. For example, the recessed device 4100 may correspond to the lighting device 100 of FIG. 1A, the lighting device 1400 of FIG. 14A, the lighting device 1500 of FIG. 15A, the lighting device 2300 of FIG. 23A, and the lighting device 2900 of FIG. 29A. For example, in some example embodiments, the recessed device 4100 may include a housing 4112 that may include a housing cover 4114. The housing cover 4114 may be integrally formed with the rest of the housing 4112 or may be attached to the housing 4112, for example, using fasteners. Alternatively, the recessed device 4100 may be a non-lighting device such as a ceiling mount speaker without departing from the scope of this disclosure. In some alternative embodiments, the recessed device 4100 may be a lighting device that includes other components such as a speaker or a fan.

In some example embodiments, the lighting device 4100 may include luminaire mounting systems 4102, 4104 (also referred to as recessed device mounting systems) that may be positioned on the housing cover 4114. For example, at least some of the components (e.g., posts and other attachment structures) may be integrally formed with the housing cover 41124 or with the housing 4112. In some example embodiments, the lighting device 4100 may also include one or more luminaire mounting systems, such as a luminaire mounting system 4110 that is positioned on the housing cover 4114. The luminaire mounting systems 4102, 4104, and 4110 (when present) may correspond to the luminaire mounting systems described herein with respect to the lighting device 100 of FIG. 1A, the lighting device 1400 of FIG. 14A, the lighting device 1500 of FIG. 15A, and the lighting device 2300 of FIG. 23A. In general, the luminaire mounting systems 4102, 4104, and 4110 may implement over-center spring mechanism as described above to mount the lighting device 4100 recessed in a ceiling.

In some example embodiments, the lighting device 4100 may include the luminaire mounting systems 4106, 4108 instead of the luminaire mounting systems 4102, 4104, 4110. For example, the luminaire mounting systems 4106, 4108 may be attached to the housing 4112 and may be positioned on lateral sides of the housing 4112 across the housing 4112 from each other. For example, the luminaire mounting systems 4106, 4108 may correspond to the luminaire mounting systems described herein with respect to the lighting device the lighting device 2900 of FIG. 29A. In general, the luminaire mounting systems 4102, 4104, and 4110 may implement over-center spring mechanism as described above to mount the lighting device 4100 recessed in a ceiling. In some alternative embodiments, the lighting device 4100 may include one or more luminaire mounting systems that are on lateral sides of on the housing cover 4114 without departing from the scope of this disclosure.

In some example embodiments, the lighting device 4100 may include a component 4116 that may be a light source that may emit a light 4118. For example, the component 4116 may be an LED light source positioned in the cavity of the housing 4112. In some example embodiments, the component 4116 may be a light source, a speaker, a fan, a smoke alarm, and/or another component that may have the housing 4112 and that may be installed recessed in a ceiling or another structure.

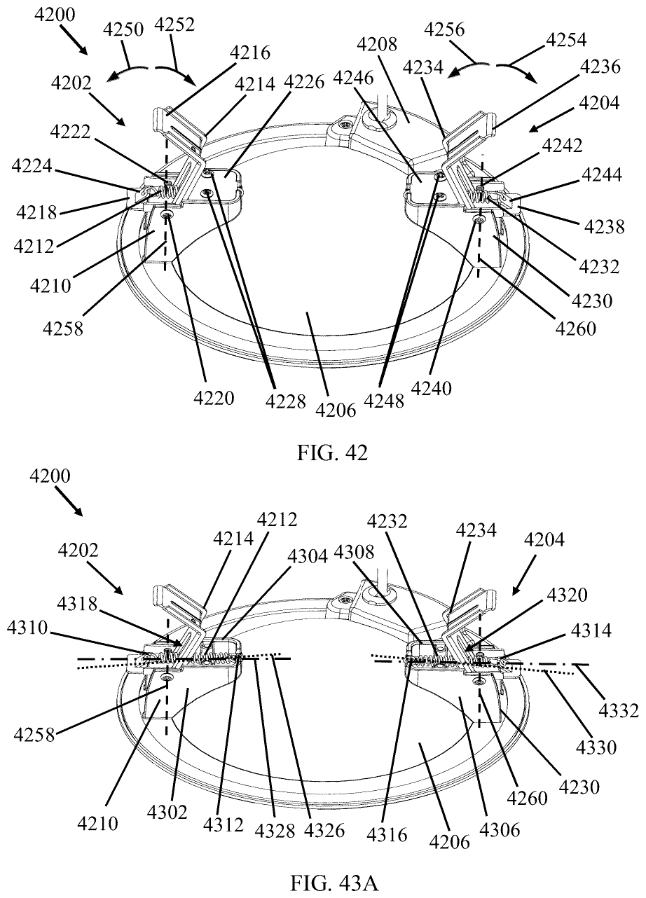

FIG. 42 illustrates a lighting device 4200 that includes luminaire mounting systems 4202, 4204 according to an example embodiment. The lighting device 4200 includes the luminaire mounting systems 4202, 4204 (also referred to as recessed device mounting systems) and a housing 4206. For example, the lighting device 4200 may be a recessed luminaire or another type of lighting device. The luminaire mounting systems 4202, 4204 may be used to mount the lighting device 4200 recessed in a ceiling. The luminaire mounting systems 4202, 4204 may be located on the housing 4206 across from each other to symmetrically mount the lighting device 4200 recessed through a device opening of a ceiling. In general, the luminaire mounting systems 4202, 4204 may be used to retain the lighting device 4200 recessed in a ceiling in the manner described above with respect to the lighting device 100 and the luminaire mounting systems 102, 104 of FIGS. 1A-1E.

In some example embodiments, the lighting device 4200 may include a junction box 4208 that may be attached to the housing 4206 by one or more fasteners. The luminaire mounting system 4202 includes a frame 4210, a spring 4212, and a rotating member 4214. For example, the spring 4212 may be an extension spring. The frame 4210 may be integrally formed with the housing 4206 as a single unit or may be attached to the housing 4206, for example, using one or more fasteners and/or other means.

In some example embodiments, the rotating member 4214 may be pivotably/rotatably attached to the frame 4210, for example, using pivot fasteners 4220, 4222. The rotating member 4214 may be attached to the frame 4210 such that the rotating member 4214 is rotatable about a pivot/rotation axis 4258 extending through the pivot fasteners 4220, 4222. The rotating member 4214 may be rotatable about the pivot axis 4258 in a rotational direction 4250 (e.g., a mounting direction), a rotational direction 4252 (e.g., an unmounting/unengaged/disengaged direction), or both directions depending on the rotational position of the rotating member 4214. In general, the rotation of the rotating member 4214 about the pivot axis 4258 may be limited in one or both rotational directions 4250, 4252 by one or more structures of the luminaire mounting system 4202.

In some example embodiments, the rotating member 4214 includes a retention arm 4216 and a trigger arm 4218. The retention arm 4216 and the trigger arm 4218 may extend out in different directions with respect to each other. For example, the rotating member 4214 may be in a rotational position (e.g., an insertion position) shown in FIG. 42 where the trigger arm 4218 is oriented to come in contact with a ceiling from below and where the retention arm 4216 is positioned to be extended through a device opening of the ceiling. From the rotation position shown in FIG. 42, the rotating member 4214 may be rotatable in the mounting direction (e.g., the rotational direction 4250) to a mounting position such that the retention arm 4216 is positioned on a ceiling on the back side of the ceiling. In general, the retention arm 4216 and the trigger arm 4218 may be angularly fixed relative to each other regardless of the rotational position of the rotating member 4214.

In some example embodiments, the rotating member 4214 includes a spring attachment tab 4224. The spring 4212 may be attached to the spring attachment tab 4224 and to a spring attachment structure that may be, for example, a section of the frame 4210. The spring 4212 may be attached to the spring attachment tab 4224 and to a section of the frame 4210 such that the extension spring 4212 biases the rotating member 4214 to rotate in an unmounting direction (e.g., the rotational direction 4252) or in a mounting direction (e.g., the rotational direction 4250) depending on the rotational position of the rotating member 4214. To illustrate, an end portion of the spring 4212 may be attached to the spring attachment tab 4224 and another end portion of the spring 4212 may be attached to the frame 4210. The spring 4212 may be attached to the spring attachment tab 4224 and to the frame 4210 such that the spring 4212 biases the rotating member 4214 to rotate in the rotational direction 4250 when the rotating member 4214 is in some rotational positions and such that the spring 4212 biases the rotating member 4214 to rotate in the rotational direction 4252 when the rotating member 4214 is in other rotational positions.

In some example embodiments, the luminaire mounting system 4202 may include a spring cover 4226 that may be retained in place by one or more fasteners 4228. The spring cover 4226 may be positioned to limit the rotation of the rotating member 4214 in the rotational direction 4252. To illustrate, in FIG. 42, the rotating member 4214 may be rotationally positioned such that the spring 4212 biases the rotating member 4214 in the rotational direction 4252, and the spring cover 4226 may prevent further rotation of the rotating member 4214 in the rotational direction 4252. The spring cover 4226 may also serve to prevent foreign material from reaching the spring 4212 and potentially interfering with the operation of the spring 4212. The spring cover 4226 may also prevent dust and other material from accumulating on the spring 4212 and potentially reducing the integrity of the spring 4212. The spring cover 4226 may also reduce the risk of injury by the spring 4212, for example, to a finger of a person.

In some example embodiments, the luminaire mounting system 4204 includes a frame 4230, a spring 4232, and a rotating member 4234. For example, the spring 4232 may be an extension spring. The frame 4230 may be integrally formed with the housing 4206 as a single unit or may be attached to the housing 4206, for example, using one or more fasteners and/or other means.

In some example embodiments, the rotating member 4214 may be pivotably/rotatably attached to the frame 4210, for example, using pivot fasteners 4240, 4242. The rotating member 4234 may be attached to the frame 4230 such that the rotating member 4234 is rotatable about a pivot/rotation axis 4260 extending through the pivot fasteners 4240, 4242. The rotating member 4234 may be rotatable about the pivot axis 4260 in a rotational direction 4254 (e.g., a mounting direction), a rotational direction 4256 (e.g., an unmounting direction), or both directions depending on the rotational position of the rotating member 4234. In general, the rotation of the rotating member 4234 about the pivot axis 4260 may be limited in one or both rotational directions 4254, 4256 by one or more structures of the luminaire mounting system 4204.

In some example embodiments, the rotating member 4234 includes a retention arm 4236 and a trigger arm 4238. The retention arm 4216 and the trigger arm 4218 may extend out in different directions with respect to each other. For example, the rotating member 4234 may be in a rotational position (e.g., an insertion position) shown in FIG. 42 where the trigger arm 4238 is oriented to come in contact with a ceiling from below and where the retention arm 4236 is positioned to be extended through a device opening of the ceiling. From the rotational position shown in FIG. 42, the rotating member 4234 may be rotatable in the mounting direction (e.g., the rotational direction 4254) to a mounting position such that the mounting arm 4236 is positioned on a ceiling on the back side of the ceiling. In general, the retention arm 4236 and the trigger arm 4238 may be angularly fixed relative to each other regardless of the rotational position of the rotating member 4234.

In some example embodiments, the rotating member 4234 includes a spring attachment tab 4244. The spring 4232 may be attached to the spring attachment tab 4244 and to a spring attachment structure that may be, for example, a section of the frame 4230. The spring 4232 may be attached to the spring attachment tab 4244 and to a section of the frame 4230 such that the extension spring 4212 biases the rotating member 4234 to rotate in an unmounting direction (e.g., the rotational direction 4256) or in a mounting direction (e.g., the rotational direction 4254) depending on the rotational position of the rotating member 4234. To illustrate, an end portion of the spring 4232 may be attached to the spring attachment tab 4244 and another end portion of the spring 4232 may be attached to the frame 4230. The spring 4232 may be attached to the spring attachment tab 4244 and to the frame 4230 such that the spring 4232 biases the rotating member 4234 to rotate in the rotational direction 4254 when the rotating member 4234 is in some rotational positions and such that the spring 4232 biases the rotating member 4234 to rotate in the rotational direction 4256 when the rotating member 4214 is in other rotational positions.

In some example embodiments, the attachment of the spring 4212 to the spring attachment tab 4224 instead of to the retention arm 4216 or to a tab extending from the retention arm 4216 may reduce risk of damage to a ceiling by the spring 4212 as the rotating member 4214 moves from an insertion position to a mounting position. The attachment of the spring 4232 to the spring attachment tab 4244 instead of to the retention arm 4236 or to a tab extending from the retention arm 4236 may reduce risk of damage to a ceiling by the spring 4232 as the rotating member 4234 moves from an insertion position to a mounting position. In some example embodiments, the degree of slanting of the spring attachment tabs 4224, 4244 may be adjustable, for example, by an installer during the installation of the lighting device 4200 in a ceiling.

In some example embodiments, the luminaire mounting system 4204 may include a spring cover 4246 that may be retained in place by one or more fasteners 4248. The spring cover 4226 may be positioned to limit the rotation of the rotating member 4234 in the rotational direction 4256. To illustrate, in FIG. 42, the rotating member 4234 may be rotationally positioned such that the spring 4232 biases the rotating member 4234 in the rotational direction 4256, and the spring cover 4246 may prevent further rotation of the rotating member 4234 in the rotational direction 4256. The spring cover 4246 may also serve to prevent foreign material from reaching the spring 4232 and potentially interfering with the operation of the spring 4232. The spring cover 4226 may also prevent dust and other material from accumulating on the spring 4232 and potentially reducing the integrity of the spring 4232. The spring cover 4246 may also reduce the risk of injury by the spring 4232, for example, to a finger of a person.

In some alternative embodiments, the lighting device 4200 may be a non-lighting device without departing from the scope of this disclosure. In some alternative embodiments, the junction box 4208 may be omitted without departing from the scope of this disclosure. In some alternative embodiments, the rotating members 4214, 4234 may each have a different shape than shown without departing from the scope of this disclosure. In some alternative embodiments, the housing 4206 may have a different shape than shown without departing from the scope of this disclosure. In some alternative embodiments, the lighting device 4200 may include one or more other ones of the luminaire mounting systems 4202, 4204 in addition to the luminaire mounting systems 4202, 4204 without departing from the scope of this disclosure. In some alternative embodiments, one or more components (e.g., the spring covers 4226, 4246) may be omitted without departing from the scope of this disclosure. In some alternative embodiments, the spring attachment tabs 4224, 4244 may be at different locations than shown without departing from the scope of this disclosure.

In some example embodiments, the housing 4206, the rotating members 4214, 4234, the spring covers 4226, 4246 may be made from aluminum or steel sheet metal using one or more methods such as stamping, cutting, etc. Alternatively, the rotating members 4214, 4234 and the spring covers 4226, 4246 may be made from plastic using one or more methods such as injection molding. The springs 4212, 4232 may be made from steel and/or another material.

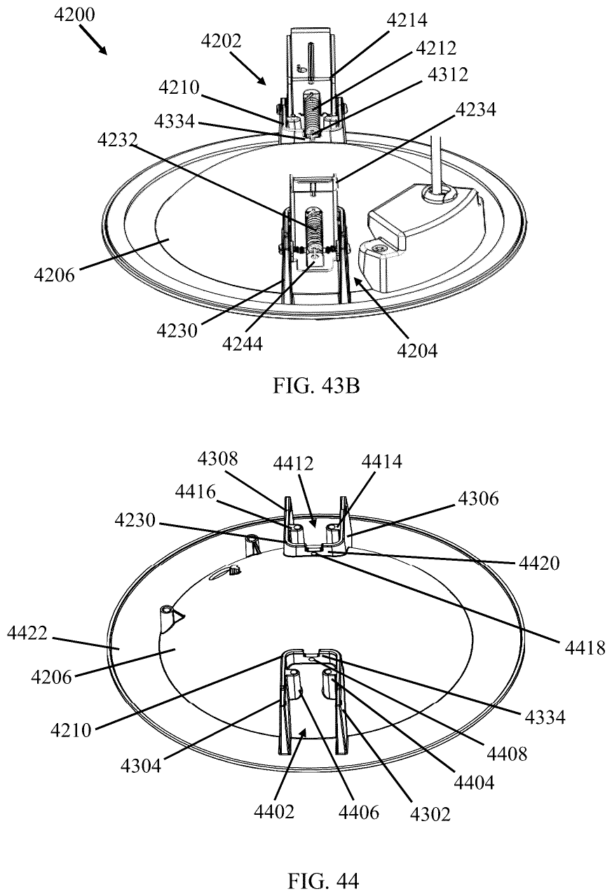

FIGS. 43A and 43B illustrate the lighting device 4200 of FIG. 42 without the spring covers 4226, 4246 according to an example embodiment. Referring to FIGS. 42-43B, in some example embodiments, the frame 4210 of the luminaire mounting system 4202 includes sidewalls 4302, 4304 that are across from each other. The spring 4212 may extend through a space between the sidewalls 4302, 4304. The rotating member 4214 may be rotatably attached to the sidewalls 4302, 4304 such that the rotating member 4214 is rotatable about the pivot axis 4258 extending through the pivot fasteners 4220, 4224. For example, the pivot fastener 4220 may be used to rotatably attach the rotating member 4214 to the sidewall 4302 of the frame 4210, and the pivot fastener 4222 may be used to rotatably attach the rotating member 4214 to the sidewall 4304 of the frame 4210.

In some example embodiments, an end portion 4310 of the spring 4212 may be attached to the spring attachment tab 4224 and another end portion 4312 of the spring 4212 may be attached to the frame 4210. For example, the end portion 4312 of the spring 4212 may be attached to a spring attachment structure 4334 that may be a section of the frame 4210. The spring 4212 may extend between the spring attachment tab 4224 and the spring attachment structure 4334 such that the spring 4212 can bias the rotating member 4214 to rotate in a particular rotational direction depending on the rotational position of the rotating member 4214.

To illustrate, an illustrative over-center axis 4326 extends through the pivot axis 4258 and the spring attachment structure 4334 at the attachment location of the end portion 4312 of the spring 4212 to the spring attachment structure 4334. An illustrative center axis 4328 of the spring 4212 extends through the center of the spring 4212 extending between the spring attachment tab 4224 and the spring attachment structure 4334. The vertical positions of the over-center axis 4326 and the center axis 4328 of the spring 4212 with respect to each other depend on the rotational position of the rotating member 4214. As described above, whether the spring 4212 biases the rotating member 4214 to rotate in the rotational direction 4250 or in the rotational direction 4252 depends on the rotational position of the rotating member 4214.

In some example embodiments, when the rotating member 4214 is in the rotational position shown in FIGS. 42-43B such that the over-center axis 4326 is below the center axis 4328 of the spring 4212 along a vertical plane extending through the pivot axis 4258, the spring 4212 biases the rotating member 4214 to rotate in the rotational direction 4252 (e.g., an unmounting direction). When the rotating member 4214 is in a rotational position such that the over-center axis 4326 is above the center axis 4328 of the spring 4212 along a vertical plane extending through the pivot axis 4258, the spring 4212 biases the rotating member 4214 to rotate in the rotational direction 4250 (e.g., a mounting direction). When the rotating member 4214 is rotationally positioned such that the over-center axis 4326 and the center axis 4328 fully overlap each other, the rotating member 4214 may be in a neutral position where the spring 4212 does not apply a biasing force on the rotating member 4214.

In some example embodiments, the rotating member 4214 may have a gap 4318 in the retention arm 4216 and the trigger arm 4218. The gap 4318 may provide an opening for the spring 4212 to extend therethrough. That is, the spring 4212 may extend between the spring attachment tab 4224 and the spring attachment structure 4334 through the gap 4318. To illustrate, the spring 4212 may extend through the gap 4318 when the rotating member 4214 is in the insertion position shown in FIGS. 42-43B. For example, the spring 4212 may extend through the portion of the gap 4318 in the retention arm 4216 when the rotating member 4214 is in the insertion position. The spring 4212 may also extend through the gap 4318 when the rotating member 4214 is in the mounting position. For example, the spring 4212 may extend through the portion of the gap 4318 in the trigger arm 4218 when the rotating member 4214 is in the mounting position. (The rotating member 4214 is shown in a mounting position in FIG. 50.)

In some example embodiments, the frame 4230 of the luminaire mounting system 4204 includes sidewalls 4306, 4308 that are across from each other. The spring 4232 may extend through a space between the sidewalls 4306, 4308. The rotating member 4234 may be rotatably attached to the sidewalls 4306, 4308 such that the rotating member 4234 is rotatable about the pivot axis 4260 extending through the pivot fasteners 4240, 4242. For example, the pivot fastener 4240 may be used to rotatably attach the rotating member 4234 to the sidewall 4306 of the frame 4230, and the pivot fastener 4242 may be used to rotatably attach the rotating member 4234 to the sidewall 4308 of the frame 4230.

In some example embodiments, an end portion 4314 of the spring 4232 may be attached to the spring attachment tab 4244 and another end portion 4316 of the spring 4232 may be attached to the frame 4230. For example, the end portion 4316 of the spring 4232 may be attached to a spring attachment structure that may be a section of the frame 4230 corresponding to the spring attachment structure 4334 of the luminaire mounting system 4202. The spring 4232 may extend between the spring attachment tab 4244 and the spring attachment structure such that the spring 4232 can bias the rotating member 4214 to rotate in the manner described with respect to the luminaire mounting system 4202.

To illustrate, an illustrative over-center axis 4330 extends through the pivot axis 4260 and a section of the frame 4230 at the attachment location of the end portion 4316 of the spring 4232 to the frame 4230. An illustrative center axis 4332 of the spring 4232 extends through the center of the spring 4232 extending between the spring attachment tab 4244 and a section of the frame 4230 that may serve as a spring attachment structure corresponding the spring attachment structure 4334 of the luminaire mounting system 4202. The vertical positions of the over-center axis 4330 and the center axis 4332 of the spring 4232 with respect to each other depend on the rotational position of the rotating member 4234. As described above, whether the spring 4232 biases the rotating member 4234 to rotate in the rotational direction 4254 or in the rotational direction 4256 depends on the rotational position of the rotating member 4234.

In some example embodiments, when the rotating member 4234 is in the rotational position shown in FIGS. 42-43B, the over-center axis 4330 is below the center axis 4332 of the spring 4232 along a vertical plane extending through the pivot axis 4260, the spring 4232 biases the rotating member 4234 to rotate in the rotational direction 4256 (e.g., an unmounting/unengaged direction). When the rotating member 4234 is in a rotational position such that the over-center axis 4330 is above the center axis 4332 of the spring 4232 along a vertical plane extending through the pivot axis 4260, the spring 4232 biases the rotating member 4234 to rotate in the rotational direction 4254 (e.g., a mounting direction). When the rotating member 4234 is rotationally positioned such that the over-center axis 4330 and the center axis 4332 fully overlap each other, the rotating member 4234 may be in a neutral position where the spring 4232 does not apply a biasing force on the rotating member 4234.

In some example embodiments, the rotating member 4234 may have a gap 4320 in the retention arm 4236 and the trigger arm 4238. The gap 4320 may provide an opening for the spring 4232 to extend therethrough. That is, the spring 4232 may extend between the spring attachment tab 4244 and the spring attachment structure 4420 through the gap 4320. To illustrate, the spring 4232 may extend through the gap 4320 when the rotating member 4234 is in the insertion position shown in FIGS. 42-43B. For example, the spring 4232 may extend through the portion of the gap 4320 in the retention arm 4236 when the rotating member 4234 is in the insertion position. The spring 4232 may also extend through the gap 4320 when the rotating member 4234 is in a mounting position. For example, the spring 4232 may extend through the portion of the gap 4320 in the trigger arm 4238 when the rotating member 4234 is in a mounting position. (The rotating member 4234 is shown in a mounting position in FIG. 50.)

FIG. 44 illustrates the frames 4210, 4230 of the luminaire mounting systems 4202, 4204 and the housing 4206 of the lighting device 4200 of FIG. 42 according to an example embodiment. Referring to FIGS. 42-44, in some example embodiments, the frames 4210, 4230 may be integrally formed with the housing 4206 as a single unit. For example, the frames 4210, 4230 and the housing 4206 may be made from aluminum using one or more methods such as die casting. As another example, the frames 4210, 4230 and the housing 4206 may be made from plastic using one or more methods such as injection molding.

In some example embodiments, the frame 4230 includes sidewalls 4306, 4308 having a space 4412 therebetween. The space 4412 may be enclosed from below by the housing 4206. For example, the cavity of the housing 4206 on an opposite side of the housing 4206 from the frame 4210 may be inaccessible through the space 4402. The spring 4212 may extend between the spring attachment tab 4224 and the spring attachment structure 4334 through the space 4402.

In some example embodiments, the frame 4210 may include the spring attachment structure 4334. The spring attachment structure 4334 may include a hole 4408 where the spring 4212 is attached to the spring attachment structure 4334, for example, by extending a tip of the spring 4212 through the hole 4408. Alternatively, the spring attachment structure 4334 may include a bar or a rod where the end portion of the spring 4212 is hooked onto the bar or rod. In some alternative embodiments, the spring attachment structure 4334 may be a separate structure from the rest of the frame 4210.

In some example embodiments, the frame 4210 may include posts 4404, 4406 (also referred to herein as stoppage structures), and the spring cover 4226 may be attached to the posts 4404, 4406. For example, the posts 4404, 4406 may each include a fastener hole, and the fasteners 4228 may be used to attach the spring cover 4226 to the posts 4404, 4406 by extending the fasteners 4228 into the fastener holes through respective holes in the spring cover 4226. The posts 4404, 4406 may also serve to limit the rotation of the rotating member 4214 in the rotational direction 4250. For example, the rotating member 4214 may be rotated to a rotational position such that the trigger arm 4218 of the rotating member 4214 comes in contact with the posts 4404, 4406 that serve as stoppage structures that prevent further rotation of the rotating member 4214 in the rotational direction 4250. The posts 4404, 4406 may be positioned such that the rotation of the rotating member 4214 in the rotational direction 4250 is stopped by the posts 4404, 4406 before the mounting arm 4216 touches the edge of a flange 4422 of the housing 4206. By preventing the mounting arm 4216 from touching the edge of the flange 4422 that may serve as a trim of the lighting device 4200, a damage to the flange 4422 by the retention arm 4216 may be avoided.

In some example embodiments, the frame 4230 includes sidewalls 4306, 4308 having a space 4412 therebetween. The space 4412 may be enclosed from below by the housing 4206. For example, the cavity of the housing 4206 on an opposite side of the housing 4206 from the frame 4230 may be inaccessible through the space 4412. The spring 4232 may extend through the space 4412 between the spring attachment tab 4244 and a spring attachment structure 4420.

In some example embodiments, the frame 4230 may include the spring attachment structure 4420. The spring attachment structure 4420 may include a hole 4418 where the spring 4232 is attached to the spring attachment structure 4420, for example, by extending a tip of the spring 4232 through the hole 4418. Alternatively, the spring attachment structure 4420 may include a bar or a rod where the end portion of the spring 4232 is hooked onto the bar or rod. In some alternative embodiments, the spring attachment structure 4420 may be a separate structure from the rest of the frame 4230.

In some example embodiments, the frame 4230 may include posts 4414, 4416 (also referred to herein as stoppage structures), and the spring cover 4246 may be attached to the posts 4414, 4416. For example, the posts 4414, 4416 may each include a fastener hole, and the fasteners 4248 may be used to attach the spring cover 4246 to the posts 4414, 4416 by extending the fasteners 4248 into the fastener holes through respective holes in the spring cover 4246. The posts 4414, 4416 may also serve to limit the rotation of the rotating member 4234 in the rotational direction 4254. For example, the rotating member 4234 may be rotated to a rotational position such that the trigger arm 4238 of the rotating member 4234 comes in contact with the posts 4414, 4416 that serve as stoppage structures that prevent further rotation of the rotating member 4234 in the rotational direction 4254. The posts 4414, 4416 may be positioned such that the rotation of the rotating member 4234 in the rotational direction 4254 is stopped by the posts 4414, 4416 before the mounting arm 4236 touches the edge of the flange 4422 of the housing 4206.

In some alternative embodiments, the housing 4206 may be a section of an enclosure or a larger housing of a lighting device. In some alternative embodiments, the housing 4206 may have a different shape than shown without departing from the scope of this disclosure. For example, the housing 4206 may have a rectangular cross-section. As another example, the flange 4422 may be omitted without departing from the scope of this disclosure. In some alternative embodiments, the posts 4404, 4406 may be at different locations than shown without departing from the scope of this disclosure. In some alternative embodiments, the posts 4404, 4406 may have different shapes than shown without departing from the scope of this disclosure. In some alternative embodiments, the frames 4210, 4230 may have a different shape than shown without departing from the scope of this disclosure.

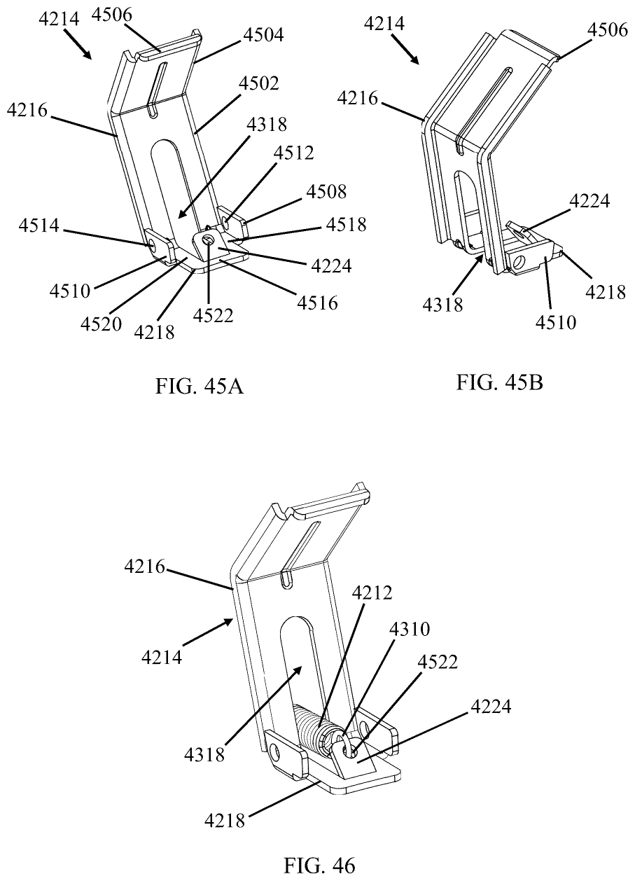

FIGS. 45A and 45B illustrate the mounting member 4214 of the luminaire mounting system 4202 according to an example embodiment, and FIG. 46 illustrates the spring 4212 attached to the spring attachment tab 4224 according to an example embodiment. Referring to FIGS. 45A-46, in some example embodiments, the rotating member 4214 includes the retention arm 4216 and the trigger arm 4218. The rotating member 4214 may have a gap 4318 in the retention arm 4216 and the trigger arm 4218. The gap 4318 may provide an opening for the spring 4212 to extend therethrough.

In some example embodiments, the retention arm 4216 may include retention arm sections 4502, 4504 and a clamping section 4506. The retention arm section 4502 may be attached to the trigger arm 4218 at one end of the retention arm section 4502 and to the retention arm section 4504 at the other end of the retention arm section 4502. The clamping section 4506 may be at an end portion of the retention arm 4216 and may extend from the retention arm section 4504. The retention arm sections 4502, 4504 and the clamping section 4506 may be oriented with respect to each other such that the clamping section 4506 can be positioned on a ceiling at the back of the ceiling when rotating member 4214 is in a mounting position.

Referring to FIGS. 42-46, in some example embodiments, the rotating member 4214 may include rotating member attachment tabs 4508, 4510 that extend from the trigger arm 4218. For example, the rotating member attachment tabs 4508, 4510 may be used to attach the rotating member 4214 to the rotating member 4214 to the frame 4210 (more clearly shown in FIG. 42). The rotating member attachment tabs 4508, 4510 may be across from each other. The rotating member attachment tab 4508 may include a fastener hole 4512, and the rotating member attachment tab 4510 may include a fastener hole 4514. The fasteners 4220, 4222 may extend through the fastener holes 4512, 4514 and corresponding holes in the sidewalls 4302, 4304 of the frame 4210 to rotatably attach the rotating member 4214 to the frame 4210. That is, the rotating member attachment tabs 4508, 4510 are attached to the frame 4210 by the fasteners 4220, 4222 such that the rotating member 4214 is rotatable. In some alternative embodiments, the rotating member attachment tabs 4508, 4510 may extend out from the retention arm 4216 instead of or in addition to extending from the trigger arm 4218 without departing from the scope of this disclosure.

In some example embodiments, the trigger arm 4218 may include a trigger section 4516 and trigger arm sections 4518, 4520. The trigger section 4516 may extend between the trigger arm sections 4518, 4520 distal from the retention arm 4216. The spring attachment tab 4224 may extend out from the trigger section 4516 of the trigger arm 4218. For example, the spring attachment tab 4224 may extend slantedly upward (e.g., at 45 degrees) toward the retention arm 4216 from the trigger section 4516 of the trigger arm 4218. In some alternative embodiments, the spring attachment tab 4224 may extend out from another section of the trigger arm 4218 without departing from the scope of this disclosure.

In some example embodiments, the spring attachment tab 4224 may include a spring attachment hole 4522. The end portion 4310 of the spring 4212 is attached to the spring attachment tab 4224 by hooking the end portion 4310 to the spring attachment tab 4224 through the spring attachment hole 4522. The spring attachment tab 4224 may be angled relative to the trigger section 4516 such that the spring 4212 can bias the rotating member 4214 based on the relative relationship of the over-center axis 4326 and the center-axis 4328 as described above, for example, with respect to FIG. 43A. For example, the spring attachment tab 4224 may be angled 45 degrees relative to the trigger section 4516. Alternatively, the spring attachment tab 4224 may be angled more or less than angled 45 degrees relative to the trigger section 4516 as needed such that the relative positioning between the over-center axis 4326 and the center-axis 4328 results in a desired over-center spring mechanism for the luminaire mounting system 4202 to operate as described herein.

In general, the description of the rotating member 4214 herein applies to the rotating member 4234 as well. For example, the rotating member 4234 may be an instance of the rotating member 4214, where the rotating member 4234 is rotatably attached to the frame 4230 in the manner described with respect to the rotating member 4214 and the frame 4210.

In some alternative embodiments, the rotating member 4214 may have a different shape than shown without departing from the scope of this disclosure. For example, the trigger arm 4218 may be oriented, with respect to the retention arm 4216, differently than shown without departing from the scope of this disclosure. As another example, the retention arm 4216 may have sections that are shaped differently than shown. As another example, the clamping section 4506 of the rotating member 4214 may be omitted or may be angled differently than shown. As yet another example, the retention arm 4216 of the rotating member 4214 may include another section. In some alternative embodiments, the spring attachment tab 4224 may have a different shape than shown without departing from the scope of this disclosure. In general, alternative embodiments described herein with respect to the luminaire mounting system 4202 and components of the luminaire mounting system 4202 are applicable to the luminaire mounting system 4204 without departing from the scope of this disclosure.

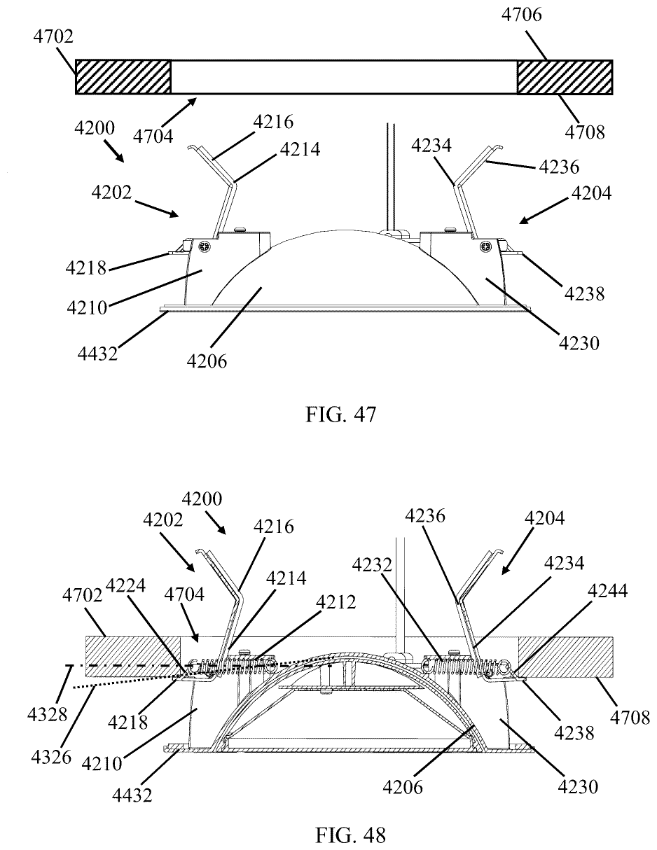

FIG. 47 illustrates the lighting device 4200 of FIG. 42 at an initial stage of installation in a ceiling 4702 according to an example embodiment. Referring To illustrate, FIGS. 42-47, the ceiling 4702 may have a device opening 4704. The ceiling 4702 may have a back side surface 4706 and a room side surface 4708. The ceiling 4702 may be, for example, 1.5 inch or ⅜ inch thick. Alternatively, the ceiling 4702 may have another thickness without departing from the scope of this disclosure. In general, the lighting device 4200 is mountable recessed in the ceiling 4702 by first positioning, by a person, the rotating members 4214, 4234 in an insertion position (i.e., an insertion position) shown in FIG. 47 followed by moving up the lighting device 4200 toward the ceiling 4702 such that the rotating member 4214, 4234 are inserted into the device opening 4704. For example, the rotating members 4214, 4234 may be positioned against the spring covers 4226, 4246, respectively, when the rotating members 4214, 4234 are in the insertion position shown in FIG. 47.

To illustrate, when the rotating member 4214 is in the insertion position shown in FIG. 47, the spring 4212 may apply a biasing force to retain the rotating member 4214 positioned against the spring cover 4226 in the absence of another force that can overcome the biasing force of the spring 4212. When the rotating member 4234 is in the insertion position shown in FIG. 47, the spring 4232 may apply a biasing force to retain the rotating member 4234 positioned against the spring cover 4246 in the absence of another force that can overcome the biasing force of the spring 4232.

FIG. 48 illustrates the lighting device 4200 of FIG. 47 partially inserted into the device opening 4704 of the ceiling 4702 during the installation of the lighting device 4200 in the ceiling 4702 according to an example embodiment. Referring to FIGS. 42-48, in some example embodiments, the lighting device 4200 may be inserted into the device opening 4704 from below the ceiling 4702. The lighting device 4200 may be moved into the device opening 4704 such that the trigger arms 4218, 4238 encounter (i.e., come in contact with) the ceiling 4702 as shown in FIG. 48. For example, the trigger section 4516 of the trigger arm 4218 and the corresponding trigger section of the trigger arm 4238 may come in contact with the room side surface 4708 of the ceiling 4702. In some cases, instead of the trigger sections, portions of the spring attachment tabs 4224, 4244 may come in contact with the room side surface 4708 of the ceiling 4702.

To illustrate, starting from the position of the lighting device 4200 shown in FIG. 47, as the lighting device 4200 is moved (e.g., pushed) into the device opening 4704 by an installer, the trigger arms 4218, 4238 may come in contact with the room side surface 4708 of the ceiling 4702. At the initial contact of the trigger arms 4218, 4238 with the room side surface 4708 of the ceiling 4702 shown in FIG. 48, the rotating members 4214, 4234 may be in the same insertion positions as in FIG. 47. In general, the retention arm 4216 and the trigger arm 4218 may be oriented relative to each other such that the trigger arm 4218 encounters the ceiling 4702 from below the ceiling 4702 after the retention arm 4216 enters the device opening 4704, and the retention arm 4236 and the trigger arm 4238 may be oriented relative to each other such that the trigger arm 4238 encounters the ceiling 4702 from below the ceiling 4702 after the retention arm 4236 enters the device opening 4704.

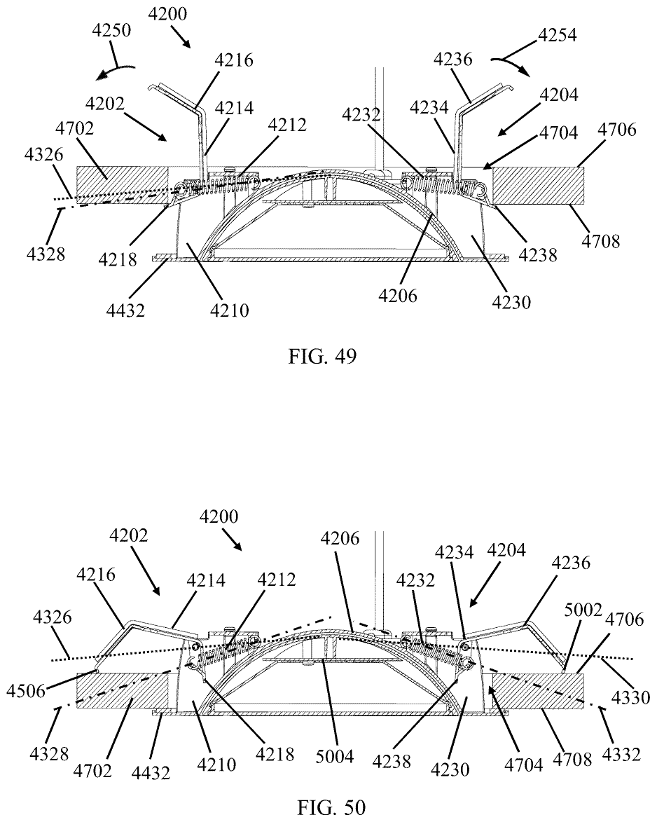

FIG. 49 illustrates the lighting device 4200 of FIG. 47 further inserted into the device opening 4704 of the ceiling 4702 during the installation of the lighting device 4200 in the ceiling 4702 according to an example embodiment. Referring to FIGS. 42-49, in some example embodiments, the lighting device 4200 may be moved by an installer further into the device opening 4704 resulting in the rotating members 4214, 4234 being rotated to the positions shown in FIG. 49. To illustrate, with the trigger arms 4218, 4238 in contact with the room side surface 4708 of the ceiling 4702 as shown in FIG. 48, as the lighting device 4200 is moved (e.g., pushed) further into the device opening 4704 by an installer, the rotating members 4214, 4234 may rotate in the rotational directions 4250, 4254 (i.e., mounting directions), respectively, to the positions shown in FIG. 49. For example, in FIG. 49, the rotating members 4214, 4234 may be in rotational positions where the springs 4212, 4232 are each applying a respective biasing force to rotate the rotating members 4214, 4234, respectively, further in the rotational directions 4250, 4254. That is, in FIG. 49, the center axis 4328 of the spring 4212 may be below the over-center axis 4326, for example, in reference to the pivot axis 4258 shown, for example, in FIG. 42, and the center axis 4332 (not shown in FIG. 49) of the spring 4232 may be below the over-center axis 4330 (not shown in FIG. 49), for example, in reference to the pivot axis 4260 shown, for example, in FIG. 42.

FIG. 50 illustrates the lighting device 4200 of FIG. 47 mounted recessed in the ceiling 4702 by the luminaire mounting systems 4202, 4204 according to an example embodiment. In FIG. 50, the rotating members 4214, 4234 are each positioned in a mounting position where the retention arms 4216, 4236 are positioned on the ceiling 4702 and retain the lighting device 4200 recessed in the ceiling 4702. Referring to FIGS. 42-50, in some example embodiments, starting from the positions of the rotating members 4214, 4234 shown in FIG. 49, in FIG. 50, the rotating members 4214, 4234 have been rotated further in the rotational directions 4250, 4254 until the clamping section 4506 of the retention arm 4216 and a clamping section 5002 of the retention arm 4236 are positioned on the back side surface 4706 of the ceiling 4702. For example, the rotating members 4214, 4234 may have been rotated to the mounting positions shown in FIG. 50 when, starting from the positions shown in FIG. 49, an installer pushes the lighting device 4200 further upward through the device opening 4704 of the ceiling 4702. To be clear, the installer does not need to manually rotate the rotating members 5114, 5124 in the mounting directions 4250, 4254. Alternatively or in addition, the springs 4212, 4232 may bias the rotating members 4214, 4234, respectively, such that the rotating members 4214, 4234 are rotated in the mounting directions 4250, 4254, respectively, and thereby pulling the lighting device 4200 further upward through the device opening 4704.

In some example embodiments, the spring 4212 may bias the rotating member 4214 and the spring 4232 may bias the rotating member 4234 to retain the rotating members 4214, 4234 in the mounting positions of FIG. 50 and thereby mounting the lighting device 4200 mounted in the ceiling 4702. That is, in FIG. 50, the center axis 4328 of the spring 4212 is below the over-center axis 4326, for example, in reference to the pivot axis 4258 shown in FIG. 42, and the center axis 4332 of the spring 4232 is below the over-center axis 4330, for example, in reference to the pivot axis 4260 shown in FIG. 42. The center axis 4332 of the spring 4232 and the over-center axis 4330 of the luminaire mounting system 4204, which are shown, for example, in FIG. 43A, are not shown in FIG. 50 for clarity of illustration. In some embodiments, when the rotating members 4214, 4314 are in mounting positions such as shown in FIG. 50, the springs 4212, 4232 may be relatively compressed as compared to when the rotating members 4214, 4234 are in the insertion positions shown, for example, in FIG. 48.

In some example embodiments, the flange 4432 of the housing 4206 may abut against the room side surface 4708 of the ceiling 4702 when the lighting device 4200 is mounted in the ceiling 4702 by the luminaire mounting systems 4202, 4204 as shown in FIG. 50. The lighting device 4200 may include a light module 5004 that may emit a light toward the area below the ceiling 4702. For example, the light module 5004 may be positioned in the cavity of the housing 4206. The springs 4212, 4232 may be entirely outside of the cavity of the housing 4206 and inaccessible through the cavity of the housing 4206.

In some example embodiments, to remove the lighting device 4200 from the ceiling 4702, a person may pull down on the lighting device 4200 with adequate downward force to overcome the bias forces on the rotating members 4214, 4234 applied by the springs 4212, 4232. For example, a person may pull down on the lighting device 4200 such that the rotating members 4214, 4234 rotate in the unmounting directions 4252, 4256, respectively, until the rotating members 4214, 4234 are in the insertion positions shown in FIG. 48, where the person may continue to pull down on the lighting device 4200 until the lighting device 4200 is completely below the ceiling 4702. In general, the lighting device 4200 may be mounted recessed in the ceiling 4702 and removed or uninstalled from the ceiling 4702, for example, in the manners described above with respect to the lighting device 100 of FIGS. 1A-1E.

By implementing over-center spring mechanism, the luminaire mounting systems 4202, 4204 can be used to mount a lighting device 4200 recessed in a ceiling with minimal effort by an installer. For example, the luminaire mounting systems 4202, 4204 eliminate the need to access luminaire mounting structures behind the ceiling as may be required when using some other luminaire mounting systems. Because the luminaire mounting systems 4202, 4204 do not require accessing luminaire mounting components that are blocked from view, the installation of luminaires recessed in a ceiling is significantly simplified. In general, to install a luminaire that uses the luminaire mounting systems 4202, 4204 recessed in a ceiling, after an installer positions the rotating members 4214, 4234, for example, as shown in FIG. 47, just pushing the lighting device 4200 into a device opening (e.g., the device opening 4704) can result in the complete mounting of the lighting device recessed in the ceiling.

The uninstallation/removal of a luminaire that is mounted recessed by the luminaire mounting systems 4202, 4204 is also simplified because accessing luminaire mounting components that are behind the mounted luminaire or behind a ceiling is not required. In general, to uninstall a recessed luminaire that is mounted using the luminaire mounting systems 4202, 4204, a person can simply pull down on the recessed luminaire without the need to manually detach luminaire mounting components. Because the spring 4212 is attached to the spring attachment tab 4224 that extends out from the trigger section 4516 of the trigger arm 4218 and extends to the spring attachment structure 4334 through the gap 4318, the risk of damage to the ceiling 4702 by the spring 4212 during the mounting of the lighting device 4200 is minimized. Because the spring 4232 is attached to the spring attachment tab 4244 that extends out from the trigger section of the trigger arm 4238 and extends to the spring attachment structure 4420 through the gap 4320, the risk of damage to the ceiling 4702 by the spring 4232 during the mounting of the lighting device 4200 is minimized.

In some alternative embodiments, one or more components of the lighting device 4200 may have a different shape than shown without departing from the scope of this disclosure. In some alternative embodiments, the luminaire mounting systems 4202, 4204 may be at different locations than shown without departing from the scope of this disclosure. In some alternative embodiments, the lighting device 4200 may include more than two luminaire mounting systems without departing from the scope of this disclosure. In some example embodiments, the luminaire mounting systems 4202, 4204 may be used to mount other types of lighting devices than shown without departing from the scope of this disclosure. In some alternative embodiments, the luminaire mounting systems 4202, 4204 may each be a recessed device mounting system that is used to mount a non-lighting device. In some alternative embodiments, the luminaire mounting systems 4202, 4204 may be used to mount non-lighting devices, such as speakers and fans (e.g., bathroom fans), recessed in a ceiling or another structure without departing from the scope of this disclosure.

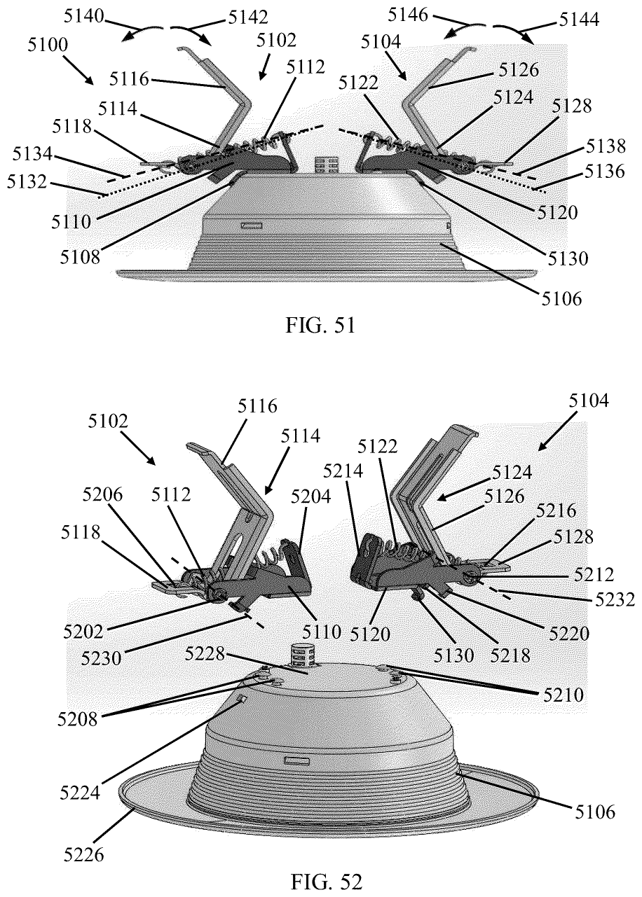

FIG. 51 illustrates a lighting device 5100 that includes luminaire mounting systems 5102, 5104 according to an example embodiment, and FIG. 52 illustrates the lighting device 5100 of FIG. 51 with the luminaire mounting systems 5102, 5104 separated from a housing 5106 of the lighting device 5100 according to an example embodiment. Referring to FIGS. 51 and 52, in some example embodiments, the lighting device 5100 includes the luminaire mounting systems 5102, 5104 (also referred to as recessed device mounting systems) and the housing 5106. The lighting device 5100 may be a recessed luminaire or another type of lighting device. The luminaire mounting systems 5102, 5104 may be used to mount the lighting device 5100 recessed in a ceiling. The luminaire mounting systems 5102, 5104 may be located across from each other to symmetrically mount the lighting device 5100 recessed through a device opening of a ceiling. In general, the luminaire mounting systems 5102, 5104 may be used to retain the lighting device 5100 recessed in a ceiling in the manner described above with respect to the lighting device 100 and the luminaire mounting systems 102, 104 of FIGS. 1A-1E.

In some example embodiments, the luminaire mounting system 5102 may be securely attached to the housing 5106 using one or more fasteners 5208, and the luminaire mounting system 5104 may be securely attached to the housing 5106 using one or more fasteners 5210. In FIG. 52, the fasteners 5208, 5210 are shown attached to a top cover 5228 of the housing 5106 for illustrative purposes, and in FIG. 51, the fasteners 5208, 5210 are extended through respective fastener holes in the luminaire mounting systems 5102, 5104 and in the top cover 5228 to retain the luminaire mounting systems 5102, 5104 attached to the housing 5106.

In some example embodiments, the luminaire mounting system 5102 includes a bracket 5110 (may also be referred to as a frame), a spring 5112, and a rotating member 5114. For example, the spring 5112 may be an extension spring. The bracket 5110 may be securely attached to the housing 5106, for example, using the fasteners 5208 and/or other means. The bracket 5110 may include a retention tab 5108 that extends into a retention hole 5224 in the housing 5106 below the top cover 5228. Positioning the retention tab 5108 in the retention hole 5224 may facilitate the correct positioning of the bracket 5110 and may also help in the retention of the bracket 5110 attached to the housing 5106.

In some example embodiments, the rotating member 5114 may be pivotably/rotatably attached to the bracket 5110, for example, using pivot fasteners including a pivot fastener 5202. The rotating member 5114 may be attached to the bracket 5110 such that the rotating member 5114 is rotatable about a pivot/rotation axis 5230 extending through the pivot fasteners including the pivot fastener 5202 that rotatably attach the rotating member 5114 to the bracket 5110. The rotating member 5114 may be rotatable about the pivot axis 5230 in a mounting direction 5140 (i.e., a mounting rotational direction), an unmounting direction 5142 (also referred to herein as an unengaged or disengaged direction), or both directions depending on the rotational position of the rotating member 5114. In general, the rotation of the rotating member 5114 about the pivot axis 5230 may be limited in one or both of the mounting direction 5140 and the unmounting direction 5142 by one or more stoppage structures of the luminaire mounting system 5102.

In some example embodiments, the rotating member 5114 includes a retention arm 5116 and a trigger arm 5118. The retention arm 5116 and the trigger arm 5118 may extend out in different directions with respect to each other. For example, the rotating member 5114 may be in a rotational position (e.g., an insertion position) shown in FIG. 51 where the trigger arm 5118 is oriented to come in contact with a ceiling from below and where the retention arm 5116 is positioned to be extended through a device opening of the ceiling. From the rotational position shown in FIG. 51, the rotating member 5114 may be rotatable in the mounting direction 5140 to a mounting position such that the retention arm 5116 is positioned on a ceiling on the back side of the ceiling. In general, the retention arm 5116 and the trigger arm 5118 may be angularly fixed relative to each other regardless of the rotational position of the rotating member 5114.

In some example embodiments, the bracket 5110 includes a spring attachment structure 5204, and the rotating member 5114 may include a spring attachment tab 5206. For example, the trigger arm 5118 may include the spring attachment tab 5206, that may, for example, extend from a section of the trigger arm 5118. The spring 5112 may be attached to the spring attachment structure 5204 and to the spring attachment tab 5206. To illustrate, an end portion of the spring 5112 may be attached to the spring attachment tab 5206 and another end portion of the spring 5112 may be attached to the spring attachment structure 5204. The spring 5112 may extend between the spring attachment structure 5204 and the spring attachment tab 5206 through a gap in the rotating member 5114. The spring 5112 may be attached to the spring attachment structure 5204 and to the spring attachment tab 5206 such that the spring 5112 biases the rotating member 5114 to rotate in the unmounting direction 5142 or in the mounting direction 5140 depending on the rotational position of the rotating member 5114.

To illustrate, an illustrative over-center axis 5132 extends through the pivot axis 5230 and the spring attachment structure 5204 at the attachment location of the spring 5112 to the spring attachment structure 5204. An illustrative center axis 5134 of the spring 5112 extends through the center of the spring 5112 extending between the spring attachment tab 5206 and the spring attachment structure 5204. The vertical positions of the over-center axis 5132 and the center axis 5134 of the spring 5112 with respect to each other depend on the rotational position of the rotating member 5114. As described above, whether the spring 5112 biases the rotating member 5114 to rotate in the mounting direction 5140 or in the unmounting direction 5142 depends on the rotational position of the rotating member 5114.

In some example embodiments, when the rotating member 5114 is in the rotational position shown in FIG. 51 such that the over-center axis 5132 is below the center axis 5134 of the spring 5112 along a vertical plane extending through the pivot axis 5230, the spring 5112 biases the rotating member 5114 to rotate in the unmounting direction 5142. When the rotating member 5114 is in a rotational position such that the over-center axis 5132 is above the center axis 5134 of the spring 5112 along a vertical plane extending through the pivot axis 5230, the spring 5112 biases the rotating member 5114 to rotate in the mounting direction 5140. When the rotating member 5114 is rotationally positioned such that the over-center axis 5132 and the center axis 5134 fully overlap each other, the rotating member 5114 may be in a neutral position where the spring 5112 does not apply a biasing force on the rotating member 5114.

In some example embodiments, the luminaire mounting system 5104 includes a bracket 5120, a spring 5122, and a rotating member 5124. For example, the spring 5122 may be an extension spring. The bracket 5120 may be securely attached to the housing 5106, for example, using the fasteners 5210 and/or other means. The bracket 5120 may include a retention tab 5130 that extends into a retention hole (corresponding to the retention hole 5224) in the housing 5106 below the top cover 5228. Positioning the retention tab 5130 in the retention hole may facilitate the correct positioning of the bracket 5120 and may also help in the retention of the bracket 5120 attached to the housing 5106.

In some example embodiments, the rotating member 5124 may be pivotably/rotatably attached to the bracket 5120, for example, using pivot fasteners including a pivot fastener 5212. The rotating member 5124 may be attached to the bracket 5120 such that the rotating member 5124 is rotatable about a pivot/rotation axis 5232 extending through the pivot fasteners including the pivot fastener 5212 that rotatably attach the rotating member 5124 to the bracket 5120. The rotating member 5124 may be rotatable about the pivot axis 5232 in a mounting direction 5144 (i.e., a mounting rotational direction), an unmounting direction 5146 (also referred to herein as an unengaged or disengaged direction), or both directions depending on the rotational position of the rotating member 5124.

In some example embodiments, the rotation of the rotating member 5124 about the pivot axis 5232 may be limited in one or both of the mounting direction 5140 and the unmounting direction 5142 by one or more stoppage structures of the luminaire mounting system 5102. For example, the bracket 5120 may include stoppage structures 5218, 5220 that are positioned to limit or otherwise prevent further rotation of the rotating member 5124 in the mounting direction 5144 after the rotating member 5124 comes in contact with the stoppage structures 5218, 5220. By limiting the rotation of the rotating member 5124 in the mounting direction 5144, the stoppage structures 5218, 5220 may prevent the rotating member 5124 from coming in contact with a flange 5226 of the housing 5106 and potentially damaging the flange 5226.

In some example embodiments, the rotating member 5124 includes a retention arm 5126 and a trigger arm 5128. The retention arm 5126 and the trigger arm 5128 may extend out in different directions with respect to each other. For example, the rotating member 5124 may be in a rotational position (e.g., an insertion position) shown in FIG. 51 where the trigger arm 5128 is oriented to come in contact with a ceiling from below and where the retention arm 5126 is positioned to be extended through a device opening of the ceiling. From the rotational position shown in FIG. 51, the rotating member 5124 may be rotatable in the mounting direction 5144 to a mounting position such that the retention arm 5126 is positioned on a ceiling on the back side of the ceiling. In general, the retention arm 5126 and the trigger arm 5128 may be angularly fixed relative to each other regardless of the rotational position of the rotating member 5124.

In some example embodiments, the bracket 5120 includes a spring attachment structure 5214, and the rotating member 5124 may include a spring attachment tab 5216. For example, the trigger arm 5128 may include the spring attachment tab 5216, that may, for example, extend from a section of the trigger arm 5128. The spring 5122 may be attached to the spring attachment structure 5214 and to the spring attachment tab 5216. To illustrate, an end portion of the spring 5122 may be attached to the spring attachment tab 5216 and another end portion of the spring 5122 may be attached to the spring attachment structure 5214. The spring 5122 may extend between the spring attachment structure 5214 and the spring attachment tab 5216 through a gap in the rotating member 5124. The spring 5122 may be attached to the spring attachment structure 5214 and to the spring attachment tab 5216 such that the spring 5122 biases the rotating member 5124 to rotate in the unmounting direction 5146 or in the mounting direction 5144 depending on the rotational position of the rotating member 5124.

To illustrate, an illustrative over-center axis 5136 extends through the pivot axis 5232 and the spring attachment structure 5214 at the attachment location of the spring 5122 to the spring attachment structure 5214. An illustrative center axis 5138 of the spring 5122 extends through the center of the spring 5122 extending between the spring attachment tab 5216 and the spring attachment structure 5214. The vertical positions of the over-center axis 5136 and the center axis 5138 of the spring 5122 with respect to each other depend on the rotational position of the rotating member 5124. As described above, whether the spring 5122 biases the rotating member 5124 to rotate in the mounting direction 5144 or in the unmounting direction 5146 depends on the rotational position of the rotating member 5124.

In some example embodiments, when the rotating member 5124 is in the rotational position shown in FIG. 51 such that the over-center axis 5136 is below the center axis 5138 of the spring 5122 along a vertical plane extending through the pivot axis 5232, the spring 5122 biases the rotating member 5124 to rotate in the unmounting direction 5146. When the rotating member 5124 is in a rotational position such that the over-center axis 5136 is above the center axis 5138 of the spring 5122 along a vertical plane extending through the pivot axis 5232, the spring 5122 biases the rotating member 5124 to rotate in the mounting direction 5144. When the rotating member 5124 is rotationally positioned such that the over-center axis 5136 and the center axis 5138 fully overlap each other, the rotating member 5124 may be in a neutral position where the spring 5122 does not apply a biasing force on the rotating member 5124.

In some example embodiments, the attachment of the spring 5112 to the spring attachment tab 5206 instead of to the retention arm 5116 or to a tab extending from the retention arm 5116 may reduce risk of damage to a ceiling by the spring 5112 as the rotating member 5114 moves from an insertion position to a mounting position. The attachment of the spring 5122 to the spring attachment tab 5216 instead of to the retention arm 5126 or to a tab extending from the retention arm 5126 may reduce risk of damage to a ceiling by the spring 5122 as the rotating member 5124 moves from an insertion position to a mounting position.

In some example embodiments, the housing 5106, the rotating members 5114, 5124, and the brackets 5110, 5120 may be made from aluminum or steel sheet metal using one or more methods such as stamping, cutting, etc. Alternatively, the rotating members 5114, 5124 and the brackets 5110, 5120 may be made from plastic using one or more methods such as injection molding. The springs 5112, 5122 may be made from steel and/or another material.

In some alternative embodiments, the lighting device 5100 may be a non-lighting device without departing from the scope of this disclosure. In some alternative embodiments, the rotating members 5114, 5124 may each have a different shape than shown without departing from the scope of this disclosure. In some alternative embodiments, the housing 5106 may have a different shape than shown without departing from the scope of this disclosure. In some alternative embodiments, the lighting device 5100 may include one or more other ones of the luminaire mounting systems 5102, 5104 in addition to the luminaire mounting systems 5102, 5104 without departing from the scope of this disclosure. In some alternative embodiments, one or more components may be omitted without departing from the scope of this disclosure. In some alternative embodiments, the spring attachment tabs 5206, 5216 may be at different locations than shown without departing from the scope of this disclosure.

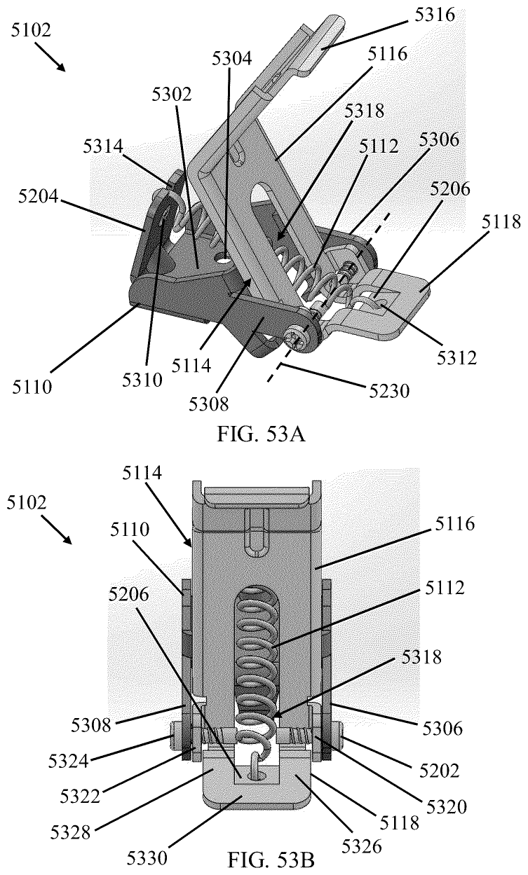

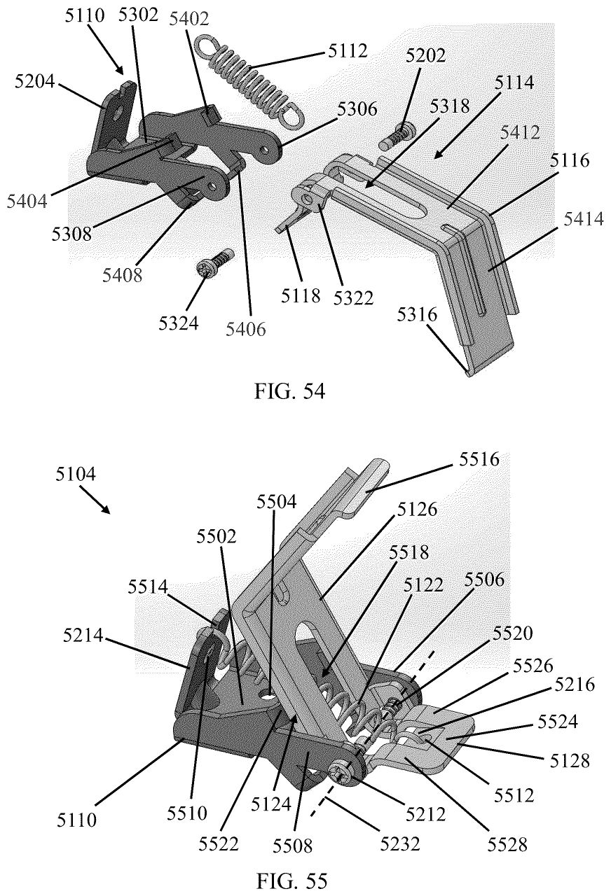

FIGS. 53A and 53B illustrate the luminaire mounting system 5102 shown in FIG. 51 according to an example embodiment, and FIG. 54 illustrates unassembled components of the luminaire mounting system shown in FIGS. 53A and 53B according to an example embodiment. Referring to FIGS. 53A-54, in some example embodiments, the luminaire mounting system 5102 includes the bracket 5110, the spring 5112 (e.g., an extension spring), and the rotating member 5114. The bracket 5110 may include the spring attachment structure 5204, a base 5302, and sidewalls 5306, 5308. The spring attachment structure 5204 may extend generally upwardly from the base 5302. For example, the spring attachment structure 5204 may extend up vertically or slantedly from the base 5302. The sidewalls 5306, 5308 may be located across from each other and may extend up from the base 5302 on opposite lateral sides of the base 5302. The base 5302 may include one or more fastener holes including a fastener hole 5304 for extending fasteners such as the fasteners 5208 (shown in FIG. 52) therethrough to securely attach the bracket 5110 to the housing 5106 of FIG. 52.

In some example embodiments, the bracket 5110 includes stoppage structures 5402, 5404 that extend up from the sidewalls 5306, 5308, respectively. For example, the stoppage structures 5402, 5404 may extend up from the sidewalls 5306, 5308 at a slanted angle. The stoppage structures 5402, 5404 may limit the rotation of the rotating member 5114 in the unmounting direction 5142 shown in FIG. 51. To illustrate, the stoppage structures 5402, 5404 may enable the rotating member 5114 to be in the rotational position (i.e., an insertion position) shown FIG. 51 without being manually held by a person. In some alternative embodiments, the stoppage structures 5402, 5404 may extend in different directions than shown without departing from the scope of this disclosure. In some alternative embodiments, the stoppage structures 5402, 5404 may have different shapes than shown without departing from the scope of this disclosure.

In some example embodiments, the bracket 5110 may include stoppage structures 5406, 5408 that extend down from the sidewalls 5306, 5308, respectively. For example, the stoppage structures 5406, 5408 may extend down from the sidewalls 5306, 5308 at a slanted angle. The stoppage structures 5406, 5408 may limit the rotation of the rotating member 5114 in the mounting direction 5140 shown in FIG. 51. To illustrate, the stoppage structures 5406, 5408 may prevent the rotating member 5114 from contacting the flange 5226 and reduce the risk of the rotating member 5114 damaging the flange 5226. In some alternative embodiments, the stoppage structures 5406, 5408 may extend in different directions than shown without departing from the scope of this disclosure. In some alternative embodiments, the stoppage structures 5406, 5408 may have different shapes than shown without departing from the scope of this disclosure. In general, in some alternative embodiments, the bracket 5110 may have a different shape than shown without departing from the scope of this disclosure.

In some example embodiments, the spring attachment structure 5204 may include a spring attachment hole 5310. For example, an end portion of the spring 5112 may be hooked through the spring attachment hole 5310 to attach the spring 5112 to the spring attachment structure 5204. In some cases, the spring attachment structure 5204 may include a notch 5314, and an end portion of the spring 5112 that is attached to the spring attachment structure 5204 is positioned in the notch 5314. For example, the notch 5314 may minimize lateral movements of the spring 5112.

In some example embodiments, the rotating member 5114 includes the retention arm 5116 and the trigger arm 5118. The rotating member 5114 is rotatably attached to the sidewalls 5306, 5308 of the bracket 5110 by the pivot fastener 5202 and a pivot fastener 5324. For example, the rotating member 5114 may include attachment tabs 5320, 5322, where the pivot fasteners 5202, 5324 extend through respective holes in the attachment tabs 5320, 5322 and the sidewalls 5306, 5308 to rotatably attach the rotating member 5114 to the bracket 5110. The pivot/rotation axis 5230 extends through the pivot fasteners 5202, 5324.

In some example embodiments, the retention arm 5116 may include retention arm sections 5412, 5414 and a clamping section 5316. The retention arm section 5412 may be attached to the trigger arm 5118 at one end of the retention arm section 5412 and to the retention arm section 5414 at the other end of the retention arm section 5412. The clamping section 5316 may be at an end portion of the retention arm 5116 and may extend from the retention arm section 5414. The retention arm sections 5412, 5414 and the clamping section 5316 may be oriented with respect to each other such that the clamping section 5316 can be positioned on a ceiling at the back of the ceiling when rotating member 5114 is in a mounting position. In some alternative embodiments, the rotating member 5114 may have a different shape and/or different sections than shown without departing from the scope of this disclosure.

In some example embodiments, the attachment tabs 5320, 5322 may extend out from the retention arm 5116, for example, proximal to the trigger arm 5118. For example, the attachment tabs 5320, 5322 may be located across from each other. Alternatively, the attachment tabs 5320, 5322 may extend out from the trigger arm 5118. The trigger arm 5118 may include the spring attachment tab 5206 that extends from a trigger section 5330 of the trigger arm 5118. The trigger section 5330 may extend between trigger arm sections 5326, 5328 of the trigger arm 5118 that are connected to the retention arm 5116 of the rotating member 5114. The spring attachment tab 5206 may extend out slightly downwardly from the trigger section 5330. Alternatively, the spring attachment tab 5206 may extend out at a different angle from the trigger section 5330. In some alternative embodiments, the spring attachment tab 5206 may extend out from another section of the trigger arm 5118 without departing from the scope of this disclosure. In some cases, the degree of slanting of the spring attachment tab 5206 may be adjustable, for example, by an installer during the installation of the lighting device 5100 in a ceiling.

In some example embodiments, the spring attachment tab 5206 may include a spring attachment hole 5312. The spring 5112 may be attached to the spring attachment tab 5206 at one end of the spring 5112, where an end portion of the spring 5112 is hooked in the spring attachment hole 5312. The spring 5112 may extend between the spring attachment structure 5204 and the spring attachment tab 5206 through a gap 5318 in the rotating member 5114. The gap 5318 in the rotating member 5114 may be formed in both the retention arm 5116 and the trigger arm 5118. For example, when the rotating member 5114 is in the insertion position shown in FIG. 53A, the spring 5112 may extend through a portion of the gap 5318 in the retention arm 5116. When the rotating member 5114 is in a mounting position (e.g., the position of the rotating member 5114 shown in FIG. 57), the spring 5112 may extend through a portion of the gap 5318 in the trigger arm 5118.

In some alternative embodiments, the luminaire mounting system 5102 may include more or fewer components than shown without departing from the scope of this disclosure. In some alternative embodiments, some components of the luminaire mounting system 5102 may have a different shape than shown without departing from the scope of this disclosure.

FIG. 55 illustrates the luminaire mounting system 5104 shown in FIG. 51 according to an example embodiment. In some example embodiments, the luminaire mounting system 5104 includes the bracket 5120, the spring 5122 (e.g., an extension spring), and the rotating member 5124. The bracket 5120 may include the spring attachment structure 5214, a base 5502, and sidewalls 5506, 5508. The spring attachment structure 5214 may extend generally upwardly from the base 5502. For example, the spring attachment structure 5214 may extend up vertically or slantedly from the base 5502. The sidewalls 5506, 5508 may be located across from each other and may extend up from the base 5502 on opposite lateral sides of the base 5502. The base 5502 may include one or more fastener holes including a fastener hole 5504 for extending fasteners such as the fasteners 5210 (shown in FIG. 52) therethrough to securely attach the bracket 5120 to the housing 5106 of FIG. 52.

In some example embodiments, the bracket 5120 includes stoppage structures, including a stoppage structure 5522, that extend up from the sidewalls 5506, 5508 and that correspond to the stoppage structures 5402, 5404 of the bracket 5120. The stoppage structures of the bracket 5120 are positioned to limit the rotation of the rotating member 5124 in the unmounting direction 5146 shown in FIG. 51. To illustrate, the stoppage structures of the bracket 5120 may enable the rotating member 5124 to be in the rotational position (i.e., an insertion position) shown FIG. 51 without being manually held by a person. In some alternative embodiments, the stoppage structures of the bracket 5120 may extend in different directions than shown without departing from the scope of this disclosure. In some alternative embodiments, the stoppage structures of the bracket 5120 may have different shapes than shown without departing from the scope of this disclosure.

Referring to FIGS. 51, 52, and 55, in some example embodiments, the bracket 5120 may include stoppage structures 5218, 5220 that extend down from the sidewalls 5506, 5508, respectively. For example, the stoppage structures 5218, 5220 may extend down from the sidewalls 5506, 5508 at a slanted angle. The stoppage structures 5218, 5220 may limit the rotation of the rotating member 5124 in the mounting direction 5144 shown in FIG. 51. To illustrate, the stoppage structures 5218, 5220 may prevent the rotating member 5124 from contacting the flange 5226 and reduce the risk of the rotating member 5124 damaging the flange 5226. In some alternative embodiments, the stoppage structures 5218, 5220 may extend in different directions than shown without departing from the scope of this disclosure. In some alternative embodiments, the stoppage structures 5218, 5220 may have different shapes than shown without departing from the scope of this disclosure. In general, in some alternative embodiments, the bracket 5120 may have a different shape than shown without departing from the scope of this disclosure.

In some example embodiments, the spring attachment structure 5214 may include a spring attachment hole 5510. For example, an end portion of the spring 5122 may be hooked through the spring attachment hole 5510 to attach the spring 5122 to the spring attachment structure 5214. In some cases, the spring attachment structure 5214 may include a notch 5514, and an end portion of the spring 5122 that is attached to the spring attachment structure 5214 is positioned in the notch 5514. For example, the notch 5514 may minimize lateral movements of the spring 5122.

In some example embodiments, the rotating member 5124 includes the retention arm 5126 and the trigger arm 5128. The rotating member 5124 is rotatably attached to the sidewalls 5506, 5508 of the bracket 5120 by the pivot fastener 5212 and a pivot fastener 5520. For example, the rotating member 5124 may include attachment tabs corresponding to the attachment tabs 5320, 5322 of the rotating member 5114 of the luminaire mounting system 5102, where the pivot fasteners 5212, 5520 extend through respective holes in the attachment tabs and the sidewalls 5506, 5508 to rotatably attach the rotating member 5124 to the bracket 5120. The pivot/rotation axis 5232 extends through the pivot fasteners 5212, 5520.

In some example embodiments, the retention arm 5126 may include a clamping section 5516 as an end portion of the rotating member 5124. The retention arm 5126 may be shaped such that the clamping section 5516 can be positioned on a ceiling at the back of the ceiling when rotating member 5124 is in a mounting position. In some alternative embodiments, the rotating member 5124 may have a different shape and/or different sections than shown without departing from the scope of this disclosure.

In some example embodiments, the trigger arm 5128 may include the spring attachment tab 5216 that extends from a trigger section 5528 of the trigger arm 5128. The trigger section 5528 may extend between trigger arm sections 5526, 5528 of the trigger arm 5128 that are connected to the retention arm 5126 of the rotating member 5124. The spring attachment tab 5216 may extend out slightly downwardly from the trigger section 5524. Alternatively, the spring attachment tab 5216 may extend out at a different angle from the trigger section 5524. In some alternative embodiments, the spring attachment tab 5216 may extend out from another section of the trigger arm 5128 without departing from the scope of this disclosure. In some cases, the degree of slanting of the spring attachment tab 5216 may be adjustable, for example, by an installer during the installation of the lighting device 5100 in a ceiling.

In some example embodiments, the spring attachment tab 5216 may include a spring attachment hole 5512. The spring 5122 may be attached to the spring attachment tab 5216 at one end of the spring 5122, where an end portion of the spring 5122 is hooked in the spring attachment hole 5512. The spring 5122 may extend between the spring attachment structure 5214 and the spring attachment tab 5216 through a gap 5518 in the rotating member 5124. The gap 5518 in the rotating member 5124 may be formed in both the retention arm 5126 and the trigger arm 5128. For example, when the rotating member 5124 is in the insertion position shown in FIG. 55, the spring 5122 may extend through a portion of the gap 5518 in the retention arm 5126. When the rotating member 5124 is in a mounting position (e.g., the position of the rotating member 5124 shown in FIG. 57), the spring 5122 may extend through a portion of the gap 5118 in the trigger arm 5128.

In some alternative embodiments, the luminaire mounting system 5104 may include more or fewer components than shown without departing from the scope of this disclosure. In some alternative embodiments, some components of the luminaire mounting system 5104 may have a different shape than shown without departing from the scope of this disclosure. In general, the luminaire mounting system 5104 may be used in the same manner as the luminaire mounting system 5104 to mount the lighting device 5100 recessed in a ceiling.

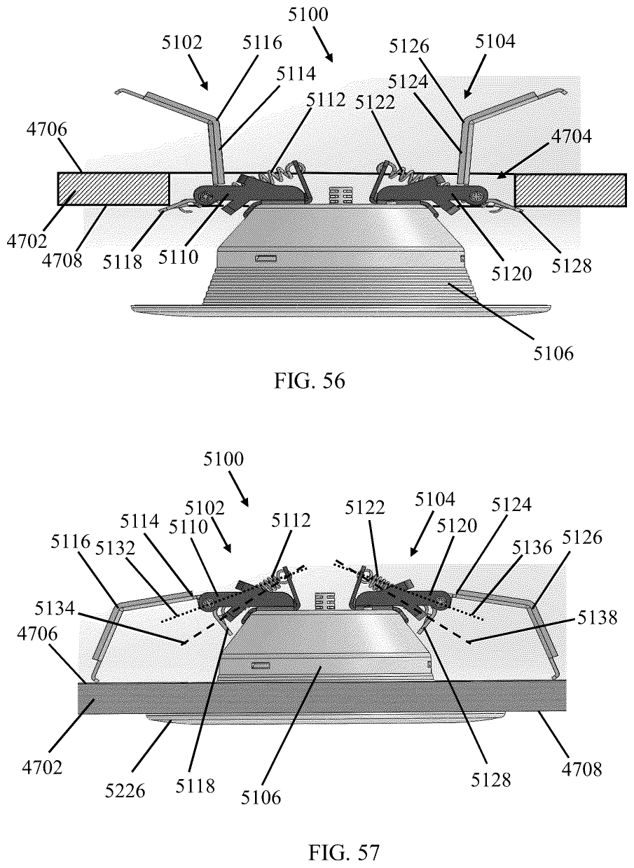

FIG. 56 illustrates the lighting device of FIG. 51 partially inserted into the device opening 4704 of the ceiling 4702 during the installation of the lighting device 5100 in the ceiling 4702 according to an example embodiment. Referring to FIGS. 51-56, in some example embodiments, during the installation of the lighting device 5100 in the ceiling 4702, the lighting device 51 may be moved by an installer into the device opening 4704 resulting in the rotating members 5114, 5124 being rotated to the positions shown in FIG. 56. To illustrate, with the trigger arms 5118, 5128 in contact with the room side surface 4708 of the ceiling 4702, as the lighting device 5100 is moved (e.g., pushed) further into the device opening 4704 by an installer, the rotating members 5114, 5124 may rotate in the mounting directions 5140, 5144, respectively, to the positions shown in FIG. 56. For example, in FIG. 56, the rotating members 5114, 5124 may be in rotational positions where the springs 5112, 5122 are each applying a respective biasing force to rotate the rotating members 5114, 5124, respectively, further in the mounting directions 5140, 5144. That is, in FIG. 56, the center axis 5134 of the spring 5112 may be below the over-center axis 5132, for example, in reference to the pivot axis 5230, and the center axis 5138 of the spring 5122 may be below the over-center axis 5136, for example, in reference to the pivot axis 5232.

FIG. 57 illustrates the lighting device 5100 of FIG. 51 mounted recessed in the ceiling 4702 by the luminaire mounting systems 5102, 5104 according to an example embodiment. In FIG. 57, the rotating members 5114, 5124 are each positioned in a mounting position where the retention arms 5116, 5126 are positioned on the ceiling 4702 and retain the lighting device 5100 recessed in the ceiling 4702. Referring to FIGS. 51-57, in some example embodiments, starting from the positions of the rotating members 5114, 5124 shown in FIG. 56, in FIG. 50, the rotating members 5114, 5124 have been rotated further in the mounting directions 5140, 5144 until the clamping section 5316 of the retention arm 5116 and the clamping section 5516 of the retention arm 5126 are positioned on the back side surface 4706 of the ceiling 4702. For example, the rotating members 5114, 5124 may have been rotated to the mounting positions shown in FIG. 57 when, starting from the positions shown in FIG. 56, an installer pushes the lighting device 5100 further upward through the device opening 4704 of the ceiling 4702. To be clear, the installer does not need to manually rotate the rotating members 5114, 5124 in the mounting directions 5140, 5144. Alternatively or in addition, the springs 5112, 5122 may bias the rotating members 5114, 5124, respectively, such that the rotating members 5114, 5124 are rotated in the mounting directions 5140, 5144, respectively, and thereby pulling the lighting device 5100 further upward through the device opening 4704 starting from the position of the lighting device 5100 shown in FIG. 56.

In some example embodiments, the spring 5112 may bias the rotating member 5114 and the spring 5122 may bias the rotating member 5124 to retain the rotating members 5114, 5124 in the mounting positions of FIG. 57 and thereby mounting the lighting device 5100 mounted in the ceiling 4702. That is, in FIG. 57, the center axis 5134 of the spring 5112 is below the over-center axis 5132, for example, in reference to the pivot axis 5230, and the center axis 5138 of the spring 5122 is below the over-center axis 5136, for example, in reference to the pivot axis 5232. In some embodiments, when the rotating members 5114, 5124 are in mounting positions such as shown in FIG. 57, the springs 5112, 5122 may be relatively compressed as compared to when the rotating members 5114, 5124 are in the insertion positions shown, for example, in FIG. 51.

In some example embodiments, the flange 5226 of the housing 5106 may abut against the room side surface 4708 of the ceiling 4702 when the lighting device 5100 is mounted in the ceiling 4702 by the luminaire mounting systems 5102, 5104 as shown in FIG. 50. The lighting device 5100 may include a light module that may emit a light toward the area below the ceiling 4702. For example, the light module may be positioned in the cavity of the housing 5106. The springs 5112, 5122 may be entirely outside of the cavity of the housing 5106 and inaccessible through the cavity of the housing 5106.

In some example embodiments, to remove the lighting device 5100 from the ceiling 4702, a person may pull down on the lighting device 5100 with adequate downward force to overcome the bias forces on the rotating members 5114, 5124 applied by the springs 5112, 5122. For example, a person may pull down on the lighting device 5100 such that the rotating members 5114, 5124 rotate in the unmounting directions 5142, 5146, respectively, until the rotating members 5114, 5124 are in the insertion positions shown in FIG. 51, where the person may continue to pull down on the lighting device 5100 until the lighting device 5100 is completely below the ceiling 4702. In general, the lighting device 5100 may be mounted recessed in the ceiling 4702 and removed or uninstalled from the ceiling 4702, for example, in the manners described above with respect to the lighting device 100 of FIGS. 1A-1E.

By implementing over-center spring mechanism, the luminaire mounting systems 5102, 5104 can be used to mount a lighting device 5100 recessed in a ceiling with minimal effort by an installer. For example, the luminaire mounting systems 5102, 5104 eliminate the need to access luminaire mounting structures behind the ceiling as may be required when using some other luminaire mounting systems. Because the luminaire mounting systems 5102, 5104 do not require accessing luminaire mounting components that are blocked from view, the installation of luminaires recessed in a ceiling is significantly simplified. In general, to install a luminaire that uses the luminaire mounting systems 5102, 5104 recessed in a ceiling, after an installer positions the rotating members 5114, 5124, for example, as shown in FIG. 51, just pushing the lighting device 5100 into a device opening (e.g., the device opening 4704) can result in the complete mounting of the lighting device recessed in the ceiling.

The uninstallation/removal of a luminaire that is mounted recessed by the luminaire mounting systems 5102, 5104 is also simplified because accessing luminaire mounting components that are behind the mounted luminaire or behind a ceiling is not required. In general, to uninstall a recessed luminaire that is mounted using the luminaire mounting systems 5102, 5104, a person can simply pull down on the recessed luminaire without the need to manually detach luminaire mounting components. Because the spring 5112 is attached to the spring attachment tab 5206 that extends out from the trigger section 5330 of the trigger arm 5118 and extends to the spring attachment structure 5204 through the gap 5318, the risk of damage to the ceiling 4702 by the spring 5112 during the mounting of the lighting device 5100 is minimized. Because the spring 5122 is attached to the spring attachment tab 5216 that extends out from the trigger section 5524 of the trigger arm 5128 and extends to the spring attachment structure 5214 through the gap 5518, the risk of damage to the ceiling 4702 by the spring 5122 during the mounting of the lighting device 5100 is minimized.

In some alternative embodiments, one or more components of the lighting device 5100 may have a different shape than shown without departing from the scope of this disclosure. In some alternative embodiments, the luminaire mounting systems 5102, 5104 may be at different locations than shown without departing from the scope of this disclosure. In some alternative embodiments, the lighting device 5100 may include more than two luminaire mounting systems without departing from the scope of this disclosure. In some example embodiments, the luminaire mounting systems 5102, 5104 may be used to mount other types of lighting devices than shown without departing from the scope of this disclosure. In some alternative embodiments, the luminaire mounting systems 5102, 5104 may each be a recessed device mounting system that is used to mount a non-lighting device. In some alternative embodiments, the luminaire mounting systems 5102, 5104 may be used to mount non-lighting devices, such as speakers and fans (e.g., bathroom fans), recessed in a ceiling or another structure without departing from the scope of this disclosure.

Although particular embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the scope of the following claims, the scope of which are to be accorded the broadest interpretation so as to encompass modifications and equivalent structures.

What is claimed is:

1. A recessed lighting device mounting system, comprising:
a frame;
a rotating member comprising a retention arm and a trigger arm, wherein the rotating member is rotatably attached to the frame, wherein the retention arm and the trigger arm extend out in different directions with respect to each other, and wherein the trigger arm comprises a spring attachment tab; and
an extension spring attached to the spring attachment tab and to a spring attachment structure such that the extension spring biases the rotating member to rotate in an unmounting direction or in a mounting direction depending on a rotational position of the rotating member, wherein the rotating member is rotatable in the mounting direction to a mounting position such that the mounting arm is positioned on a ceiling.

2. The recessed device mounting system of claim 1, wherein the frame comprises sidewalls that are across from each other, wherein the rotating member is rotatably attached to the sidewalls, and wherein the extension spring extends through a space between the sidewalls.

3. The recessed device mounting system of claim 2, wherein the frame comprises the spring attachment structure.

4. The recessed device mounting system of claim 1, wherein the frame is integrally formed with a housing of a lighting device and wherein the extension spring is entirely outside of the housing of the lighting device.

5. The recessed device mounting system of claim 4, further comprising a spring cover positioned to cover the extension spring such that the extension spring is between the spring cover and the housing of the lighting device.

6. The recessed device mounting system of claim 1, further comprising one or more stoppage structures that are positioned to limit a rotation of the rotating member in the mounting direction.

7. The recessed device mounting system of claim 1, wherein the rotating member further comprises attachment tabs and wherein the attachment tabs are attached to the frame by fasteners such that the rotating member is rotatable.

8. The recessed device mounting system of claim 1, wherein the retention arm and the trigger arm are oriented such that the trigger arm encounters the ceiling on a room side of the ceiling after at least a portion of the retention arm passes through a device opening of the ceiling as the recessed device mounting system is moved through the device opening of the ceiling.

9. The recessed device mounting system of claim 1, wherein the extension spring is configured to bias the rotating member to remain in the mounting position.

10. The recessed device mounting system of claim 1, wherein the trigger arm comprises arm sections and a trigger section, wherein the trigger section extends between the arm sections, and wherein the spring attachment tab extends from the trigger section.

11. A lighting device, comprising:
a housing;
a first recessed device mounting system; and
a second recessed device mounting system, wherein the first recessed device mounting system and the second recessed device mounting system each comprise:
a frame extending from the housing;
a rotating member comprising a retention arm and a trigger arm, wherein the rotating member is rotatably attached to the frame, wherein the retention arm and the trigger arm extend out in different directions with respect to each other, and wherein the trigger arm comprises a spring attachment tab; and
an extension spring attached to the spring attachment tab and to a spring attachment structure such that the extension spring biases the rotating member to rotate in an unmounting direction or in a mounting direction depending on a rotational position of the rotating member, wherein the rotating member is rotatable in the mounting direction to a mounting position such that the mounting arm is positioned on a ceiling.

12. The lighting device of claim 11, wherein the frame of the first recessed device mounting system and the frame of the second recessed device mounting system each comprise sidewalls that are across from each other and integrally formed with the housing, wherein the rotating member of the first recessed device mounting system is rotatably attached to the sidewalls of the first recessed device mounting system, wherein the rotating member of the second recessed device mounting system is rotatably attached to the sidewalls of the second recessed device mounting system, and wherein the extension spring of each of the first recessed device mounting system and the second recessed device mounting system is entirely outside of the housing.

13. The lighting device of claim 12, wherein the frame of the first recessed device mounting system comprises the spring attachment structure of the first recessed device mounting system, wherein the frame of the second recessed device mounting system comprises the spring attachment structure of the second recessed device mounting system, wherein the extension spring of the first recessed device mounting system extends through a space between the sidewalls of the first recessed device mounting system, and wherein the extension spring of the second recessed device mounting system extends through a space between the sidewalls of the second recessed device mounting system.

14. The lighting device of claim 11, wherein the first recessed device mounting system comprises first one or more stoppage structures that are positioned to limit a rotation of the rotating member of the first recessed device mounting system in the mounting direction of the first recessed device mounting system and wherein the second recessed device mounting system comprises second one or more stoppage structures that are positioned to limit a rotation of the rotating member of the second recessed device mounting system in the mounting direction of the second recessed device mounting system.

15. The lighting device of claim 11, wherein the retention arm and the trigger am of each of the first recessed device mounting system and the second recessed device mounting system are oriented such that the trigger arm encounters the ceiling on a room side of the ceiling after at least a portion of the retention arm passes through a device opening of the ceiling as the lighting device is moved through the device opening of the ceiling, wherein the extension spring of the first recessed device mounting system is configured to bias the rotating member of the first recessed device mounting system to remain in the mounting position of the rotating member of the first recessed device mounting system, and wherein the extension spring of the second recessed device mounting system is configured to bias the rotating member of the second recessed device mounting system to remain in the mounting position of the rotating member of the second recessed device mounting system.
